(19) United States
(12) Patent Application Publication
(10) Pub. No.: US 2009/0315867 A1
(43) Pub. Date: Dec. 24, 2009

(54) INFORMATION PROCESSING UNIT

(75) Inventors: Naoko SAKAMOTO, Osaka (JP); Kazuya OHASHI, Shizuoka (JP); Katsuyoshi UCHIYAMA, Osaka (JP); Haruka MIYAGATA, Kanagawa (JP); Ryuichirou HIROSE, Osaka (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/487,260

(22) Filed: Jun. 18, 2009

(30) Foreign Application Priority Data
Jun. 19, 2008 (JP) 2008-160499
May 27, 2009 (JP) 2009-127963
Jun. 10, 2009 (JP) 2009-139234
Jun. 10, 2009 (JP) 2009-139235

(51) Int. Cl. G06F 3/033

(52) U.S. Cl. 345/184

(57) ABSTRACT

An information processing unit of the present invention includes a display control unit that causes an icon display area, in which a plurality of icons related to each other are grouped, to be displayed and an operation unit that receives various operations by a user. When the operation unit inputs a command for expanding or contracting the icon display area in a one-dimensional direction which is the same as an arrangement direction of the plurality of the icons in the icon display area, the display control unit causes the icon display area to be expanded or contracted in the one-dimensional direction. With such a configuration, the operability can be enhanced by shortening a time for searching for a desired icon.

### BACKGROUND OF THE INVENTION

1. Field of the Invention

The present invention relates to an information processing unit such as a notebook computer (hereinafter, referred to as a “notebook PC”).

2. Description of Related Art

Recently, the versatility of notebook PCs is increasing, and various ideas for enhancing the operability have been proposed so as to prevent the operability from being impaired by the versatility. For example, Windows (Trademark of Microsoft Corporation) that is an operating system (OS) of Microsoft Corporation has a task bar function. The task bar is a bar-shaped region displayed at the corner of a display screen of a notebook PC, which displays icons for activating predetermined functions by a one-touch operation or activating predetermined application software by a one-touch operation in that region. A user can activate desired application software by selecting an icon in the task bar. The user can register icons arbitrarily in the task bar, and when the task bar region cannot contain icons that the user desire to register, the task bar is displayed in a plurality of stages, whereby a number of icons can be registered.

However, in a user interface (UI) of the task bar system as described above, when a task bar is displayed in a plurality of stages, a display area other than the task bar on the display screen of the notebook PC is squeezed.

JP 2002-259009 A discloses a configuration in which the display area of a task bar is retained in one stage, and the contents in a plurality of task bars are rotated to be displayed.

However, in the configuration disclosed by JP 2002-259009 A, when the number of task bars increases as a result of the increase in number of registered icons, the number of rotations of the task bars for searching for a desired icon increases, which takes a long time to search for the desired icon, resulting in the decrease in operability.

### SUMMARY OF THE INVENTION

It is an object of the present invention to provide an information processing unit in which the operability can be enhanced by shortening a time for searching for a desired icon.

An information processing unit of the present invention that displays icons selected when predetermined processing is designated on a screen of a display unit, includes: a display control unit that causes an icon display area, in which a plurality of the icons related to each other are grouped, to be displayed; and an operation unit that receives various operations by a user. When the operation unit inputs a command for expanding or contracting the icon display area in a one-dimensional direction which is the same as an arrangement direction of the plurality of the icons in the icon display area, the display control unit causes the icon display area to be expanded or contracted in the one-dimensional direction.

According to the present invention, the operability can be enhanced by shortening a time for searching for a desired icon.

### BRIEF DESCRIPTION OF THE DRAWINGS

FIG. 1 is a perspective view of an information processing unit according to an embodiment.

FIG. 2 is a block diagram showing a hardware configuration of the information processing unit.

FIG. 3 is a plan view of a first housing and the vicinity thereof

FIG. 4 is a schematic view showing the shift of a display of a task bar.

FIG. 5A is a schematic view illustrating an expansion/contraction operation of a window displayed in the task bar.

FIG. 5B is a schematic view illustrating an expansion/contraction operation of a window displayed in the task bar.

FIG. 5C is a schematic view illustrating an expansion/contraction operation of a window displayed in the task bar.

FIG. 6 is a schematic view showing a state in which a plurality of windows are displayed in the task bar.

FIG. 7 is a schematic view showing a state in which a plurality of windows are displayed in the task bar.

FIG. 8A is a schematic view illustrating an expansion/contraction operation of a window displayed in the task bar.

FIG. 8B is a schematic view illustrating an expansion/contraction operation of a window displayed in the task bar.

FIG. 8C is a schematic view illustrating an expansion/contraction operation of a window displayed in the task bar.

FIG. 9A is a schematic view showing a hierarchy display of icons displayed in the task bar.

FIG. 9B is a schematic view showing the hierarchy display of the icons displayed in the task bar.

FIG. 9C is a schematic view showing the hierarchy display of the icons displayed in the task bar.

FIG. 10A is a schematic view showing a scroll display of icons displayed in the task bar.

FIG. 10B is a schematic view showing a scroll display of icons displayed in the task bar.

FIG. 10C is a schematic view showing a scroll display of icons displayed in the task bar.

FIG. 10D is a schematic view showing a scroll display of icons displayed in the task bar.

FIG. 11A is a schematic view showing a display form when a state display is performed in the task bar.

FIG. 11B is a schematic view showing a display form when a state display is performed in the task bar.

FIG. 11C is a schematic view showing a display form when a state display is performed in the task bar.

FIG. 11D is a schematic view showing a display form when a state display is performed in the task bar.

FIG. 11E is a schematic view showing a display form when a state display is performed in the task bar.

FIG. 12 is a schematic view showing an interlocked display state of a main display and a sub-display.

FIG. 13 is a schematic view showing an interlocked display state of the main display and the sub-display.

FIG. 14A is a schematic view showing a display form of the task bar interlocked with application software.

FIG. 14B is a schematic view showing a display form of the task bar interlocked with application software.

FIG. 15A is a schematic view showing a display form of the task bar interlocked with a videoconference system.

FIG. 15B is a schematic view showing a display form of the task bar interlocked with the videoconference system.

FIG. 15C is a schematic view showing a display form of the task bar interlocked with the videoconference system.

FIG. 16 is a schematic view showing a display form of the task bar interlocked with the videoconference system.

FIG. 17 is a plan view of a first housing and the vicinity thereof.

FIG. 18 is a schematic view showing the shift of a display of a menu bar.

FIG. 19 is a schematic view showing the hierarchy of a display of the menu bar.

FIG. 20A is a schematic view showing the shift of a display of the menu bar.

FIG. 20B is a schematic view showing the shift of a display of the menu bar.

FIG. 20C is a schematic view showing the shift of a display of the menu bar.

FIG. 20D is a schematic view showing the shift of a display of the menu bar.

FIG. 20E is a schematic view showing the shift of a display of the menu bar.

FIG. 21 is a plan view of a first housing and the vicinity thereof.

FIG. 22A is plan view showing a state in which the menu bar basic menu) is displayed in a display panel.

FIG. 22B is plan view showing a state in which the menu bar (application menu) is displayed on the display panel.

FIG. 22C is a plan view showing a state in which the menu bar (customized menu) is displayed on the display panel.

FIG. 23 is a plan view showing a state in which a place species menu is displayed on the display panel.

FIG. 24 is a flowchart showing a control flow involved in a selection operation of a place species.

FIG. 25A is a plan view showing a state in which a setting information window is displayed.

FIG. 25B is a plan view showing a state in which a setting information window is displayed.

FIG. 25C is a plan view showing a state in which a setting information window is displayed.

FIG. 25D is a plan view showing a state in which a setting information window is displayed.

FIG. 25E is a plan view showing a state in which a setting information window is displayed.

FIG. 26 is a plan view showing a state in which a detailed setting window is displayed.

FIG. 27 is a perspective view showing an outer appearance of a notebook PC that is an example of the information processing unit in the embodiment.

FIG. 28 is a plan view of the notebook PC.

FIG. 29 is a block diagram showing an internal structure of the notebook PC.

FIG. 30 is a schematic view showing the shift of a display of a tool bar.

FIG. 31A is a schematic view illustrating an expansion/contraction operation of a window displayed in the tool bar.

FIG. 31B is a schematic view illustrating an expansion/contraction operation of a window displayed in the tool bar.

FIG. 31C is a schematic view illustrating an expansion/contraction operation of a window displayed in the tool bar.

FIG. 32 is a schematic view showing a state in which a plurality of windows are displayed in the tool bar.

FIG. 33 is a schematic view showing a state in which a plurality of windows are displayed in the tool bar.

FIG. 34A is a schematic view illustrating an expansion/contraction operation of a window displayed in the tool bar.

FIG. 34B is a schematic view illustrating an expansion/contraction operation of a window displayed in the tool bar.

FIG. 34C is a schematic view illustrating an expansion/contraction operation of a window displayed in the tool bar.

FIG. 35A is a schematic view showing a hierarchy display of icons displayed in the tool bar.

FIG. 35B is a schematic view showing a hierarchy display of icons displayed in the tool bar.

FIG. 35C is a schematic view showing a hierarchy display of icons displayed in the tool bar.

FIG. 36A is a schematic view showing a scroll display of icons displayed in the tool bar.

FIG. 36B is a schematic view showing a scroll display of icons displayed in the tool bar.

FIG. 36C is a schematic view showing a scroll display of icons displayed in the tool bar.

FIG. 36D is a schematic view showing a scroll display of icons displayed in the tool bar.

FIG. 37A is a schematic view showing a display form when a state display is performed in the tool bar.

FIG. 37B is a schematic view showing a display form when a state display is performed in the tool bar.

FIG. 37C is a schematic view showing a display form when a state display is performed in the tool bar.

FIG. 38 is a schematic view showing an interlocked display state of a main display and a sub-display.

FIG. 39 is a schematic view showing an interlocked display state of the main display and the sub-display.

FIG. 40A is a schematic view showing a display form of a tool bar interlocked with application software.

FIG. 40B is a schematic view showing a display form of the tool bar interlocked with application software.

FIG. 41A is a schematic view showing a display form of the tool bar interlocked with a videoconference system.

FIG. 41B is a schematic view showing a display form of the tool bar interlocked with a videoconference system.

FIG. 41C is a schematic view showing a display form of the tool bar interlocked with a videoconference system.

FIG. 42 is a schematic view showing a display form of the tool bat interlocked with a videoconference system.

FIG. 43 is a schematic view showing the shift of a display form of the menu bar.

FIG. 44A is a schematic view showing the shift of a display form of the menu bar.

FIG. 44B is a schematic view showing the shift of a display form of the menu bar.

FIG. 44C is a schematic view showing the shift of a display form of the menu bar.

FIG. 45A is a schematic view showing the shift of a display form of the menu bar.

FIG. 45B is a schematic view showing the shift of a display form of the menu bar.

FIG. 45C is a schematic view showing the shift of a display form of the menu bar.

FIG. 45D is a schematic view showing the shift of a display form of the menu bar.

### DETAILED DESCRIPTION OF THE INVENTION

An information processing unit of the present invention that displays icons selected when predetermined processing is designated on a screen of a display unit, includes: a display control unit that causes an icon display area, in which a plurality of the icons related to each other are grouped, to be displayed; and an operation unit that receives various operations by a user. When the operation unit inputs a command for expanding or contracting the icon display area in a one-dimensional direction which is the same as an arrangement direction of the plurality of the icons in the icon display area, the display control unit causes the icon display area to be expanded or contracted in the one-dimensional direction.

The information processing unit of the present invention can take the following aspects based on the above configuration.

The information processing unit of the present invention includes a second housing provided with the display unit and a first housing via a rotation shaft that opens or doses the second housing rotatably, wherein the operation unit is placed in a vicinity of the rotation shaft in the first housing.

In the information processing unit of the present invention, the operation unit receives respective operations at positions corresponding to the plurality of the icons displayed in the icon display area.

In the information processing unit of the present invention, the operation unit includes a designation portion, which designates a display or a non-display of the icon display area on the screen, in at least one end portion of the arrangement direction of the plurality of the icons.

In the information processing unit of the present invention, when one of the grouped plurality of the icons is selected, the display control unit causes the plurality of the icons related to the one icon to be expanded and displayed adjacent to the one icon in the icon display area.

The information processing unit of the present invention includes the grouped plurality of the icons in plural kinds, wherein the display control unit selects and displays a group to be displayed in the icon display area.

In the information processing unit of the present invention, the plurality of the icons are a profile switching unit that specifies an operation environment in which the user operates the operation unit and displays a profile in accordance with the operation environment on the display unit.

The information processing unit of the present invention further includes a second housing provided with a display device that displays a visual signal, a first housing provided with a signal input portion for inputting a signal to be displayed on the display device, and a rotation shaft that axially supports the second housing with respect to the first housing so as to open or dose the second housing freely. The profile switching unit is a plurality of icons corresponding to a plurality of the profiles, and in a vicinity of the rotation shaft in the display device, the information processing unit includes an icon display area that displays the plurality of the icons in a row, and a contact operation portion that corresponds to positions of the plurality of the icons displayed in the icon display area and is placed between the single input portion in the second housing and the rotation shaft.

In the information processing unit of the present invention, the plurality of the icons can have a hierarchical structure.

In the information processing unit of the present invention, when the plurality of the icons have a hierarchical structure, the display control unit causes a predetermined mark to be displayed on an icon in an upper layer.

In the information processing unit of the present invention, when only a part of the plurality of the icons is capable of being displayed, the display control unit enables the icon display area to be displayed by scrolling.

In the information processing unit of the present invention, when the icon display area is contracted, the display control unit causes sizes of the icons displayed in the icon display area to be reduced.

In the information processing unit of the present invention, the display control unit causes variable setting information to be displayed on the icons.

In the information processing unit of the present invention, the display control unit can cause icons capable of changing setting contents of the setting information to be displayed.

In the information processing unit of the present invention, when the operation unit operates an arbitrary icon, the display control unit causes another icon related to the operated icon to be displayed.

In the information processing unit of the present invention, when arbitrary application software is operated so as to be activated by the operation unit, the display control unit causes an icon related to the application software to be displayed.

In the information processing unit of the present invention, the icons displayed in the icon display area are capable of being changed arbitrarily.

In the information processing unit of the present invention, when the operation unit operates an arbitrary icon continuously for a predetermined period of time, the display control unit causes the arbitrary icon to be capable of being dragged onto another icon.

In the information processing unit of the present invention, the icon display area is displayed on a second display unit independent from the display unit, and the second display unit is placed so as to overlap the operation unit.

### Embodiment 1

### 1. Configuration of an Information Processing Unit

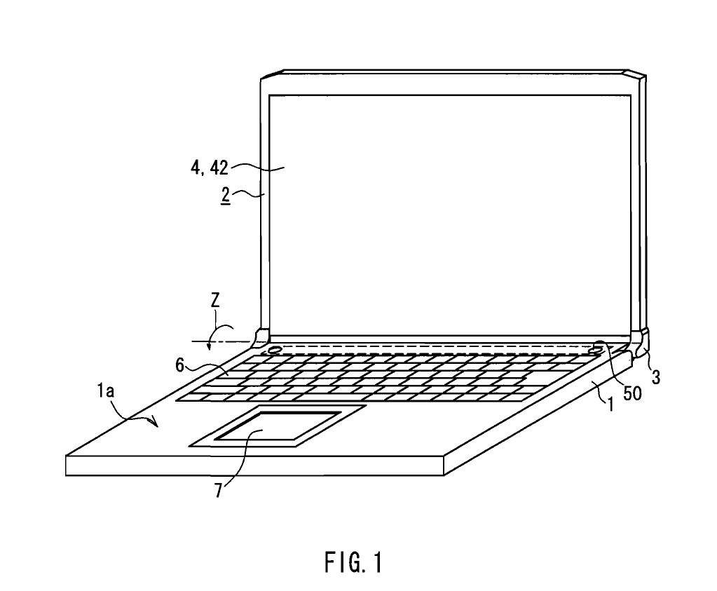

FIG. 1 is a perspective view showing the outer appearance of a notebook PC that is an example of an information processing unit in the present embodiment.

In FIG. 1, the notebook PC includes a first housing 1 containing a central processing unit, a hard disk drive, and the like, and a second housing 2 having a display 4. The first housing 1 and the second housing 2 are supported by a hinge portion 3 so as to rotate in a direction indicated by an arrow Z or an opposite direction thereto. The hinge portion 3 includes a rotation shaft supporting the first housing 1 and the second housing 2 so that they can rotate. On an upper surface 1a of the first housing 1, various operation units such as a keyboard 6 and a pointing device 7 are placed. The upper surface 1a of the first housing 1 has an operation region 50. The operation region 50 indicates a part of the upper surface 1a of the first housing 1, and a touch sensor 53 (described later) is provided in an inner portion of the first housing 1 overlapping the operation region 50. When a user touches the operation region 50 with a finger or the like, the touch sensor 53 (described later) can detect the contact state of the finger or the like. Specifically, the touch sensor 53 (described later) includes a plurality of matrix switches placed in a lattice shape, and is configured so that only a matrix switch in the portion where the user touches with the finger or the like is turned on.

The “operation region” in the present embodiment not only indicates a part of the surface of the first housing 1, but also includes the touch sensor 53 (described later) contained in the first housing 1 so as to overlap the operation region 50. Thus, “operating the operation region” includes: the portion corresponding to the operation region in the first housing 1 being pressed by the user; and the touch sensor 53 being turned on partially by the user's pressing to detect the user's pressing.

Furthermore, the operation region 50 is not limited to a shape flush with the upper surface 1a of the first housing 1, and, for example, may protrude from the upper surface 1a in an arc shape or dented from the upper surface 1a. When the operation region 50 is formed so as to protrude from the upper surface 1a, the protruding amount of the operation region 50 is preferably set to such a degree as not to interfere with the operation region 50 and the second housing 2 or the display 4 when the second housing 2 is dosed with respect to the first housing 1.

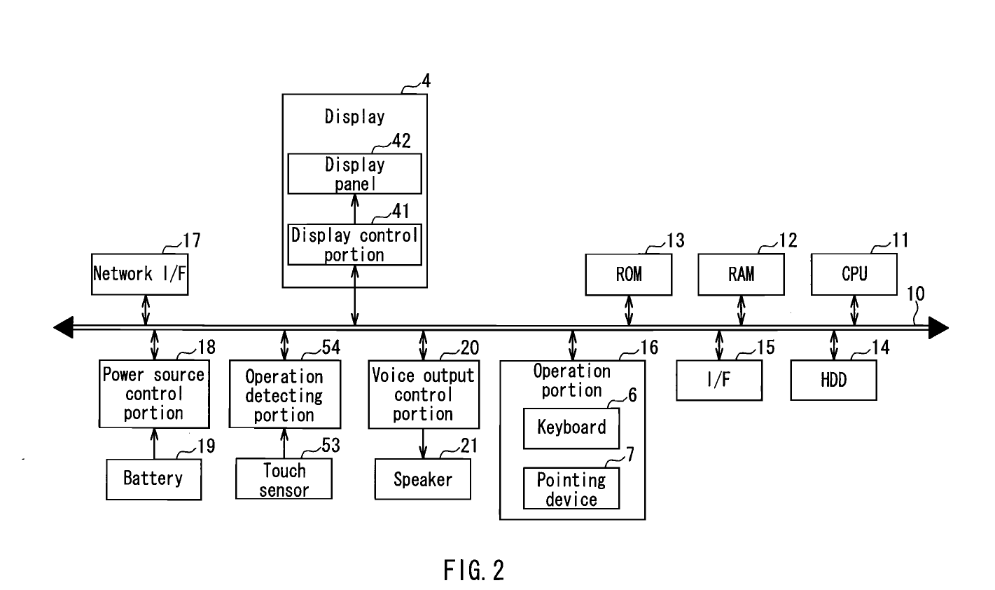

FIG. 2 is a block diagram showing a hardware configuration of the notebook PC of the present embodiment. As shown in FIG. 2, the hardware of the notebook PC of the present embodiment is configured in such a manner that the central processing unit (CPU) 11, a RAM (Random Access Memory) 12, a ROM (Read Only Memory) 13, an HDD (Hard Disk Drive) 14, an interface 15, an operation portion 16, a network interface 17, a power source control portion 18, a voice output control portion 20, a display control portion 41, and an operation detecting portion 54 can communicate with each other through a bus 10.

The CPU 11 is a device controlling each portion in the notebook PC, and specifically, a device that processes data stored in the RAM 12 temporarily. The ROM 13 stores information on a BIOS (Basic Input Output System) and the like. The CPU 11, the RAM 12, and the ROM 13 are examples of control units of the present invention.

The HDD 14 stores various data contained in an operating system (OS) and data generated by the user, for example, in a file format. Although the HDD 14 is provided in the present embodiment, a recording medium in another form such as a semiconductor memory may be provided as long as it can store at least data in a file format.

The interface 15 is used for connecting the notebook PC to an external appliance, and includes a port pursuant to, for example, a USB (Universal Serial Bus) specification, a headphone terminal, and the like.

The operation portion 16 includes the keyboard 6 and the pointing device 7. The keyboard 6 is composed of a plurality of keys capable of inputting various characters. The pointing device 7 has an operation surface, for example, in a rectangular shape as shown in FIG. 1, and a sensor capable of detecting that the operation surface is contacted with a finger or the like is provided under the operation surface. The user can move a cursor displayed on a display panel 42 to an arbitrary position by pressing the operation surface with a finger or the like and moving the finger pressing the operation surface in a plane direction (arbitrary direction) of the operation surface (Hereinafter, this operation will be referred to as a slide operation).

The network interface 17 is a terminal capable of connecting the notebook PC to a network. The network interface 17 includes, for example, a LAN port capable of being connected to a LAN (Local Area Network) and a modem port capable of being connected directly to an external network. The network interface 17 is not limited to a cable connection with a LAN cable, and may be a communication device capable of being connected to the LAN wirelessly.

The power source control portion 18 supplies electric power supplied from a battery 19 to each portion in the notebook PC. The notebook PC of the present embodiment is not limited to a configuration driven with electric power supplied from the battery 19, and may include a configuration driven with electric power supplied from a utility power source.

The voice output control part 20 causes a speaker 21 to output a voice in response to, for example, a command from the CPU 11. Examples of the voice whose output can be controlled by the voice output control portion 20 include a startup sound of an application program set in the OS, a warning sound at a time of occurrence of an error, and a voice reproduced when a voice file or a moving picture file is executed. The voice output control portion 20 can adjust the volume of a voice output from the speaker 2 and stop the output of a voice from the speaker 21 by performing a predetermined operation to cause the display 4 to display a voice setting screen contained in the OS and allow the contents set in the voice setting screen to be changed.

The speaker 21 is contained in the notebook PC. The speaker 21 is not limited to a speaker contained in the notebook PC, and may be a speaker connected externally to the notebook PC.

The display 4 includes a display control portion 41 and the display panel 42.

The display control portion 41 converts image data processed and generated by the CPU 11 and the RAM 12 into an image signal capable of being displayed on the display panel 42, and causes an image based on the converted image signal to be displayed on the display panel 42. The display control portion 41 can adjust the brightness, contrast, and the like of an effective display area in the display panel 42. The brightness, contrast, and the like of the effective display area can be adjusted by activating software for adjusting a display contained in the OS and changing parameters such as a brightness. The display control portion 41 adjusts the brightness of a backlight (for example, in the case where the display panel 42 is a liquid crystal display panel) in the display panel 42, for example, when a parameter such as a brightness is changed. Thus, the user can adjust arbitrary display contents by activating display adjustment software to change a parameter.

The display panel 42 is composed of, for example, a liquid crystal display panel of about 10 to 14 inches. The display panel 42 is not limited to a liquid crystal display, and may be a display panel capable of displaying at least an image, such as an organic EL display.

The touch sensor 53 is placed in the operation region 50 (see FIG. 1) of the first housing 1. The touch sensor 53 is configured so as to perform an arbitrary operation by pressing the operation region 50 (hereinafter, referred to as an operation surface) on the upper surface 1a of the first housing 1 with a finger or the like. Specifically, the touch sensor 53 includes a plurality of matrix switches placed in a lattice shape, and is configured so that, when an arbitrary position on the operation surface is pressed with a finger or the like, the matrix switch at that position is switched from OFF to ON (the matrix switch is in an OFF state at all times when the operation surface is not being pressed). By retrieving positional information (coordinate) of the matrix switch that is switched OFF to ON, it can be detected that an arbitrary position in the touch sensor 53 has been pressed. Examples of the touch sensor 53 include a resistance film type, a capacitance type, and a surface acoustic wave type, any of which may be mounted.

The operation detecting portion 54 generates information (coordinate) on the pressed position, based on the ON/OFF state of the matrix switch in the touch sensor 53. Furthermore, the operation detecting portion 54 sends the generated positional information to the CPU 11. The touch sensor 53 and the operation detecting portion 54 are examples of a region selecting unit of the present invention.

Hereinafter, the basic operation of the information processing unit will be described.

When the user operates a power source switch (not shown), the power source control portion 18 pulls in electric power from the battery 19 and supplies the electric power to each portion in the notebook PC. Then, the CPU 11 reads BIOS information from the ROM 13 and reads a file of the OS stored in the HDD 14, thereby performing startup processing. During the startup processing, the display control portion 41 causes the display panel 42 to display a startup screen. In a state in which the startup processing of the notebook PC is completed, icons for activating various pieces of application software are displayed on the display panel 42. Furthermore, a task bar (described later) is displayed on the display panel 42.

After the activation of the notebook PC, when the keyboard 6 is operated by the user, the CPU 11 detects an operated key among a plurality of keys placed on the keyboard 6 and sends a command to the display control portion 41 so as to cause a character corresponding to the operated key to be displayed on the display panel 42. The display control portion 41 causes the display panel 42 to display the character based on the command from the CPU 11. Furthermore, when the user operates the pointing device 7, the pointing device 7 outputs information on the position of the operation surface pressed by the user. The CPU 11 sends a command for moving a cursor displayed on the display panel 42 to the display control portion 41, based on the positional information output from the pointing device 7. The display control portion 41 causes the cursor displayed on the display panel 42 to move to an arbitrary position based on the command from the CPU 11.

On the other hand, the touch sensor 53 receives the user's pressing with a finger or the like. The operation detecting portion 54 can detect a click operation, a double click operation, a drag operation, and a drop operation depending upon the operation contents of the touch sensor 53. The click operation refers to an operation in which an arbitrary operation region in the touch sensor 53 is pressed for a short period of time (for example, one second or less). The double click operation refers to an operation in which a click operation is performed twice intermittently. The drag operation refers to an operation in which an arbitrary operation region in the touch sensor 53 is pressed, and a finger pressing the operation region is slid in an operation surface direction of the touch sensor 53. The drop operation refers to an operation in which the finger is detached from the touch sensor 53 after the drag operation.

### 2. Operation of a Notebook PC with a Touch Sensor

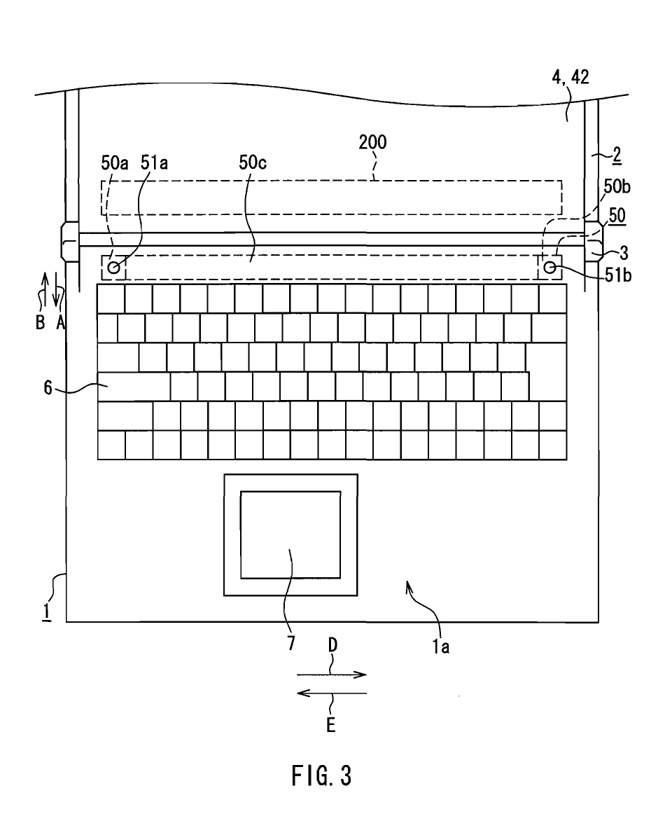

FIG. 3 is a plan view of the notebook PC in the present embodiment, and mainly shows a configuration of the upper surface 1a of the first housing 1.

As shown in FIG. 3, the operation region 50 has a substantially rectangular shape. The operation region 50 has a shape with a long side being much larger than a short side. The operation region 50 is placed so that a longitudinal direction thereof is substantially parallel to a long side in the first housing 1. The operation region 50 indicates a part of the upper surface 1a of the first housing 1, corresponding to a region in which the touch sensor 53 (see FIG. 2) is placed inside the first housing 1. That is, when the user presses at least a part of the operation region 50, the matrix switch included in the touch sensor 53 (see FIG. 2) is switched from OFF to ON.

The operation region 50 indicates a region in which the touch sensor 53 (see FIG. 2) is capable of detecting the user's pressing. In the present embodiment, circular marks 51a and 51b are provided at both ends in the longitudinal direction of the operation region 50, whereby the user can be informed of that regions in the vicinity of the circular marks 51a and 51b and a region sandwiched between the circular marks 51a and 51b correspond to the operation region 50.

Although the operation region 50 does not appear in the external appearance of the first housing 1 in the present embodiment, a broken line shown in FIG. 3 is described actually in the first housing 1 with a solid line, or a region corresponding to the operation region 50 on the upper surface 1a of the first housing 1 can be colored. With such a configuration, the user can grasp the position of the operation region 50 easily, which can enhance the operability.

The operation region 50 includes a first region 50a, a second region 50b, and a third region 50c. In portions of the operation surface corresponding to the first region 50a and the second region 50b, the circular marks 51a and 51b are described, respectively. The circular marks 51a and 51b are used for notifying the user of the position of the first region 50a or the second region 50b when the user performs an operation of displaying a menu bar (described later). Although a portion of the operation surface corresponding to the third region 50c is not provided with a mark or the like in the present embodiment, it is preferred to provide a mark or the like for notifying the user that the portion is the operation region.

The matrix switches in the first region 50a and the second region 50b are assigned the same function, respectively. Specifically, the matrix switches in the first region 50a and the second region 50b are assigned a function of displaying a menu bar (described later) on the display 4 and a function of switching the display of the menu bar. The matrix switches in the first region 50a and the second region 50b are assigned the same function, whereby the operability for the user to perform an operation of displaying a menu bar and an operation of switching the display of the menu bar can be enhanced. For example, while the user is holding the left end of the first housing 1 (the left end of the first housing 1 shown in FIG. 3 in a direction facing the drawing surface) with the left hand, the user can press the second region 50b with a finger of the right hand. Furthermore, while the user is holding the right end of the first housing 1 with the right hand, the user can press the first region 50a with a finger of the left hand. Thus, the movement amount of a finger and a hand can be reduced during the operation of displaying a menu bar, so that the operability can be enhanced Furthermore, the movement amount of a finger and a hand can be reduced during the operation of displaying a menu bar irrespective of the dominant hand of the user, so that the operability can be enhanced.

The matrix switch in the first region 50a or the second region 50b may be assigned different functions instead of the same function. For example, the execution of the commands in various application programs may be designated by pressing the first region 50a, and the cancellation of the execution in various application programs or the display a sub-menu may be designated by pressing the second region 50b.

Furthermore, the operation region for displaying a menu bar (described later) may be at least one of the first region 50a and the second region 50b. Furthermore, at least one of the marks 51a and 51b may be indicated depending upon whether the first region 50a or the second region 50b is provided.

The third region 50c refers to a region in which various operations in a menu bar can be performed while a menu bar (described later) is being displayed on the display 4. A specific operation method will be described later.

### 3. Display Operation of a Menu Bar

As shown in FIGS. 1 and 2, the operation region 50 includes a touch sensor in a band shape having a longitudinal direction in a one-dimensional direction in the first housing 1 of the notebook PC.

In the present embodiment, the operation region 50 is placed at a position dose to the second housing 2 on the first housing 1. By placing the operation region 50 at this position, the operation region 50 can be placed in the vicinity of the display 4, and a direct operation corresponding to a task bar 200 displayed on the display 4 can be realized.

Furthermore, the operation region 50 is placed at a position on the second housing 2 side with respect to the keyboard 6, whereby the operation region 50 can be placed away from the position of a hand or an arm while the user is operating the keyboard 6 or the pointing device 7 in an ordinary posture. Therefore, the hand or the arm of the user is unlikely to touch the operation region 50 accidentally, which can prevent a misoperation of the operation region 50.

Furthermore, the operation region 50 is placed on the upper surface 1a on which the keyboard 6 and the like are placed in the first housing 1, whereby a small movement of a line of sight among the display 4, the operation region 50, and the keyboard 6 suffices, which enables the display contents to be visually identified easily. Furthermore, when the operation region 50 is operated, the movement amount of a finger from the keyboard 6 or the like can be reduced, so that the operability can be enhanced.

### 3-1. Display Control of a Task Bar

As shown in FIG. 3, the display 4 can display the task bar 200. The task bar 200 is displayed in the vicinity of a lower side (a side closest to the first housing 1 among four sides of the display 4 in a substantially rectangular shape) of the display 4. The task bar 200 is a region that displays icons for operating various functions in the notebook PC and for activating application software installed on the notebook PC. The icons displayed in the task bar 200 previously are associated with commands capable of activating startup files of various functions and application software. The user can activate a desired function, application software, or the like by operating the operation region 50 to select an icon displayed in the task bar 200. The task bar 200 in the present embodiment is an example of a band-shaped display area indicating a particular region in which icons and the like are displayed, and those which have the same function are included in the range of the “task bar” in the present embodiment even if they have different designations.

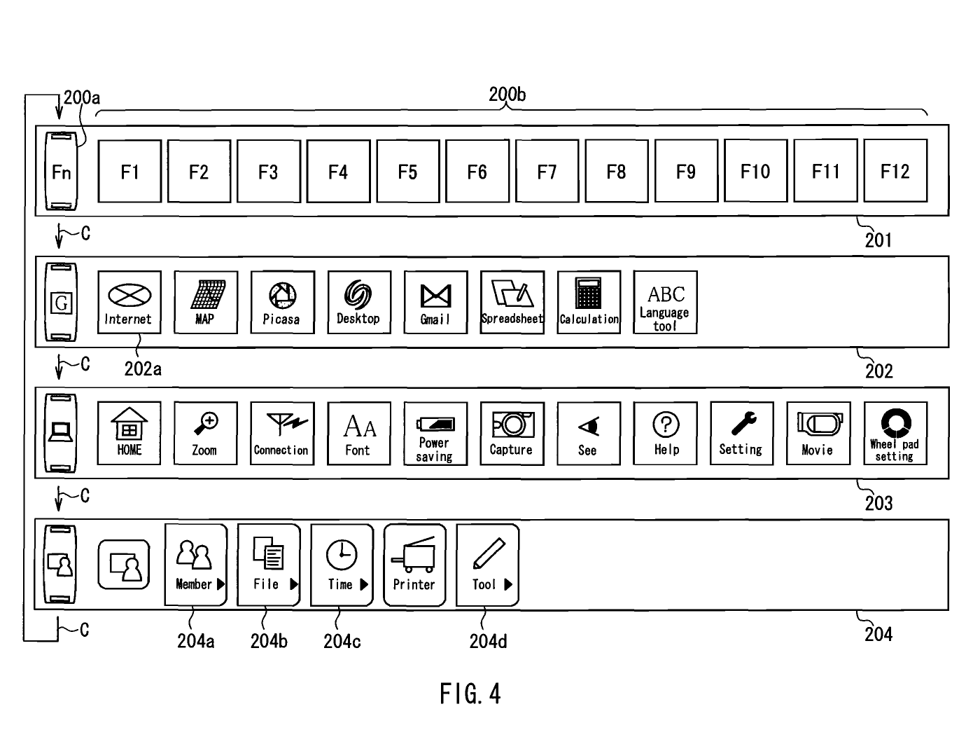

FIG. 4 is a schematic diagram showing display contents of the task bar 200 displayed on the display 4. In the present embodiment, four task bars 201, 202, 203, and 204 are switched to be displayed. The first task bar 201 is assigned functions corresponding to function keys. The second bar 202 is assigned icons capable of activating various pieces of application software such as Internet browser software. The third task bar 203 is assigned a function capable of performing various settings of the notebook PC. The fourth task bar 204 can execute a videoconference system.

In the example shown in FIG. 4, although the four task bars 201 to 204 can be switched to be displayed, the number of task bars is not limited to four. Needless to say, one task bar may be displayed, and five or more task bars may be displayed. However, when the number of task bars is too large, it takes time and labor for the user to search for a desired icon; therefore, it is preferred that about four task bars are displayed as shown in FIG. 4, since the operability is not decreased. Furthermore, the functions and application software registered in each task bar in the present embodiment are shown for illustrative purposes. Arrows C in the figure indicate the shift directions of the task bars 201 to 204. The shift of the displays may be opposite to the direction indicated by the arrows C.

The task bars 201 to 204 respectively have a task bar mark 200a and a function icon display portion 200b. The task bar mark 200a represents the kind of each of the task bars 201 to 204. The display of the task bars can be switched successively by operating the first region 50a (see FIG. 3) of the operation region 50 corresponding to the task bar mark 200a. For example, when the first task bar 201 currently is being displayed on the display 4, one click of the first region 50a by the user switches the display of the task bar 200 on the display 4 from the first task bar 201 to the second task bar 202. Thereafter, every time the first region 50a is single-clicked on, the display on the display 4 is switched from the third task bar 203, the fourth task bar 204, the first task bar 201, the second task bar 202, . . . .

The display of the task bar 200 can be switched even by sliding the first region 50a in a direction indicted by an arrow A or B shown in FIG. 3. For example, when the first region 50a is slid in the direction indicated by the arrow A while the first task bar 201 is being displayed on the display 4, the display is switched from the first task bar 201 to the second task bar 202. Furthermore, when the first region 50a is slid in the direction indicated by the arrow B while the second task bar 202 is being displayed on the display 4, the display is switched from the second task bar 202 to the first task bar 201.

Furthermore, the task bar 200 shows characters and graphics representing the contents of a currently selected task bar. For example, when the first task bar 201 is being displayed, since the first task bar 201 is assigned functions corresponding to function keys generally provided on the keyboard 6, a character “Fn” is displayed in the task bar mark 200a.

Furthermore, the task bar mark 200a may display the serial number of a currently selected task bar and the total number of registered task bars. In the case of the example shown in FIG. 4, when the first task bar 201 is being displayed, a fraction “¼” is displayed in the task bar mark 200a, and when the second task bar 202 is being displayed, a fraction “ 2/4” is displayed in the task bar mark 200a. In this display form, the numerator represents the page number of a task bar, and the denominator represents the total number of task bars. With such a configuration, the starting point of the task bar can be grasped easily. Furthermore, the page number of a task bar is not limited to the display of a numerical value, and may be represented by an icon.

Furthermore, the function icon display portion 200b is a region in which icons registered in each task bar are displayed. For example, in the case of the first task bar 201, icons such as “F1” and “F2” corresponding to function keys generally mounted on the keyboard 6 are displayed in the function icon display portion 200b. As described above, when the display of the task bar 200 is switched when the user operates the first region 50a, the icons displayed in the function icon display portion 200b also are switched.

The user clicks on a desired icon among the icons displayed in the function icon display portion 200b, thereby executing the function associated with the clicked icon and activating application software associated therewith. The function or application software executed by the operation of the icon is displayed on the display 4. For example, when an Internet icon 202a in the second task bar 202 is clicked on, the CPU 11 reads and executes a file of Internet browser software from the HDD 14. Next, the display control portion 41 of the display 4 causes the display panel 42 to display a browser screen.

### 3-2. Expansion/Contraction Display of a Window

In the previous section, the configuration is described in which, when the operation region 50 corresponding to an icon displayed in the function icon display portion 200b of the task bar 200 is clicked on, various functions and application software are activated. In the case where the icon has a hierarchical structure, a window in a lower layer is displayed in the task bar 200. A window in the present embodiment is an exemplary window-shaped display area that is displayed in the task bar 200 and indicates a particular region displaying icons and the like, and those which have the same function are included in the range of the “window” in the present embodiment even if they have different designations.

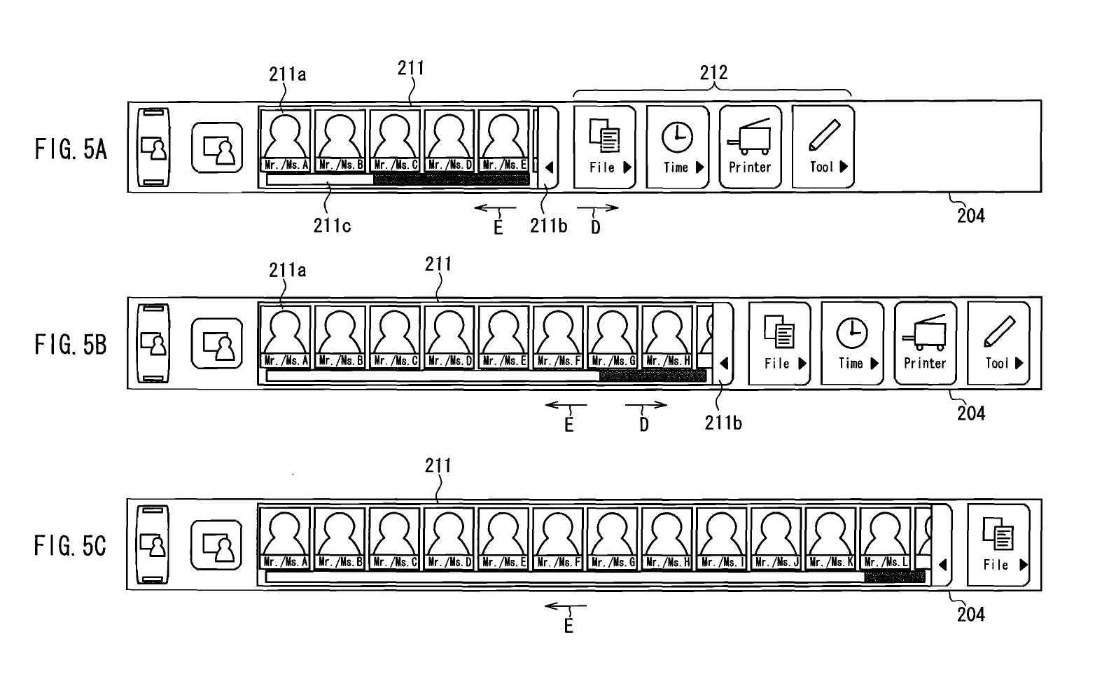

FIG. 5A shows a state in which a window is displayed in the task bar 200. FIG. 5A shows, for example, a state that is displayed when the operation region 50 corresponding to a member icon 204a (see FIG. 4) of the fourth task bar 204 (task bar of a videoconference system) is clicked on. As shown in FIG. 5A, when the operation region 50 corresponding to the member icon 204a (see FIG. 4) is clicked on, the member icon 204a displayed in the fourth task bar 204 is deleted and a window 211 is displayed. The window 211 includes icons 211a. The icons 211a are information on a lower layer of the member icon 204a In the present embodiment, the icons 211a display information on members connected to the videoconference system or members connectable thereto. The information on the members included in the icons 211a includes face images and names of the members in the present embodiment, which are merely shown for illustrative purposes.

The size of the window 211 displayed first when the member icon 204a is clicked on is arbitrary; however, when the number of icons to be displayed in the window 211 is too large for the size of the window 211 displayed as shown in FIG. 5A and all the icons cannot be displayed simultaneously, only a part of the icons may be displayed together with a scroll bar 211c.

Furthermore, the icons displayed in the window 211 are arranged based on a predetermined priority order. For example, in the case of the videoconference system as shown, the “predetermined priority order” may be the order in which the names of the members connected to the system are arranged according to Japanese 50 phonetic characters or may be the order in which the members have been connected to the system. Alternatively, the use frequency of the icons is monitored and the icons may be displayed automatically so as to be arranged at all times in the decreasing order of the use frequency, and such a display can enhance the ease of use.

Furthermore, a drag region 211b is provided at an end in the longitudinal direction of the window 211. The user presses the operation region 50 corresponding to the drag region 211b with a finger or the like, and drags the operation region 50 in a direction indicated by an arrow D shown in FIG. 3 while pressing the operation region 50, thereby expanding the window 211 in the direction indicated by the arrow D as shown in FIG. 5B.

The size of the icon 211a in the window 211 does not change before the expansion of the window 211 (FIG. 5A) and after the expansion thereof (FIG. 5B), and the number of the icons 211a displayed in the window 211 increases. Furthermore, other icons 212 displayed adjacent to the window 211 in the fourth task bar 204 move in the direction indicated by the arrow D along with the expansion of the window 211 in the direction indicated by the arrow D.

Furthermore, when the operation region 50 corresponding to the drag region 211b is dragged in the direction indicated by the arrow D from the state shown in FIG. 5B, whereby the window 211 can expand further in the direction indicated by the arrow D, as shown in FIG. 5C. At this time, the other icons 212 displayed in the fourth task bar 204 further move in the direction indicated by the arrow D. As shown in FIG. 5C, when a part of the icons 212 cannot be displayed in the fourth task bar 204 any more as a result of the expansion of the window 211, only an icon that can be displayed among the icons 212 is displayed, and a scroll bar (not shown) can be displayed in the fourth task bar 204. This enables the icons 212 that cannot be displayed any more to be displayed. The icons that cannot be displayed any more in the task bar as a result of the expansion of the window may be displayed in an end portion (for example, a right end) of the task bar, with the size in the longitudinal direction of the task bar being compressed. With such a display, it is possible to grasp the presence of the icons that cannot be displayed any more even without displaying and operating the scroll bar.

The window 211 also can be contracted by dragging the operation region 50 corresponding to the drag region 211b in a direction indicated by an arrow E. That is, the user can adjust the window 211 to an arbitrary size by dragging the operation region 50 corresponding to the drag region 211b to move the drag region 211b to an arbitrary position.

Furthermore, the window 211 can be returned to the icon display shown in FIG. 4, for example, by double-clicking on the operation region 50 corresponding to the drag region 211b.

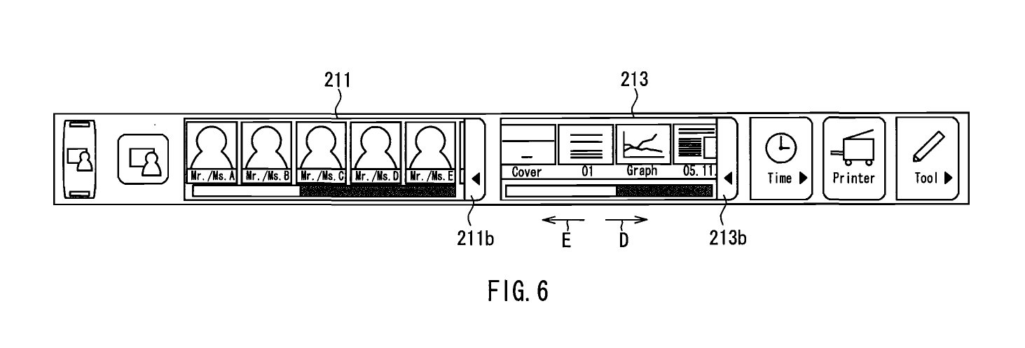

FIG. 6 shows a state in which two windows are displayed simultaneously in the task bar 200. As shown in FIG. 6, the number of windows that can be displayed in the task bar 200 is not limited to one, and a plurality of windows also can be displayed. The example shown in FIG. 6 shows a state in which the window 211 is opened by clicking on the operation region 50 corresponding to the member icon 204a in the fourth task bar 204 in FIG. 4 and a window 213 is opened by clicking on the operation region 50 corresponding to a file icon 204b. The window 213 displays, for example, icons of files such as documents and data that can be opened to the other members connected to the videoconference system.

Even in such a display, the window 211 can be adjusted to an arbitrary size by dragging the operation region 50 corresponding to the drag region 211b in the direction indicated by the arrow D or the direction indicated by the arrow E. Furthermore, the window 213 can be adjusted to an arbitrary size by dragging the operation region 50 corresponding to a drag region 213b in the direction indicated by the arrow D or the direction indicated by the arrow E.

The number of the windows that can be displayed simultaneously in the task bar 200 is not limited to one as shown in FIG. 5 or two as shown in FIG. 6, and at least three windows also can be displayed simultaneously.

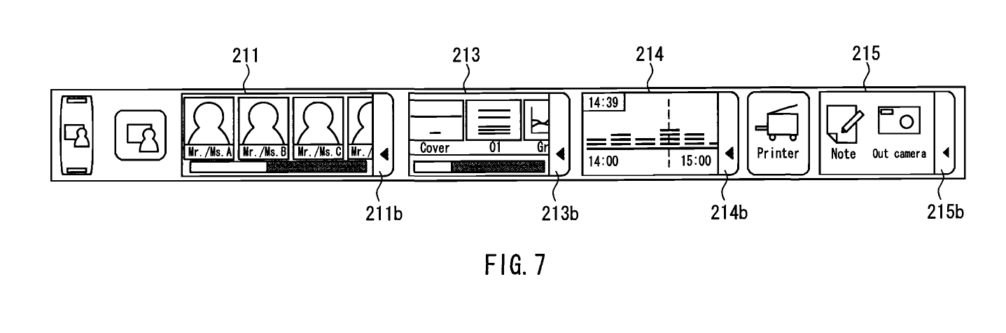

FIG. 7 shows a state in which four windows 211, 213, 214, and 215 are displayed simultaneously in the task bar 200. In FIG. 7, the window 214 is displayed by clicking on the operation region 50 corresponding to a time icon 204c shown in FIG. 4. The window 215 is displayed by clicking on the operation region 50 corresponding to a tool icon 204d shown in FIG. 4. The windows 214 and 215 have drag regions 214b and 215b capable of changing a window size similarly to the other windows (the description of the operation of changing a window size will be omitted). Furthermore, the window 214 can be returned to the time icon 204c and the window 215 can be returned to the tool icon 204d by double-clicking on the operation region 50 corresponding to the drag regions 214b and 215b.

In the above configuration, the size of the icons in the window is not changed when the operation region 50 corresponding to the drag region is dragged, and the icons that cannot be displayed in the window any more are allowed to be displayed only when the display is scrolled by dragging the operation region 50 corresponding to the scroll bar. However, the size of the icons in the window may be adjusted automatically along with the change in size of the window.

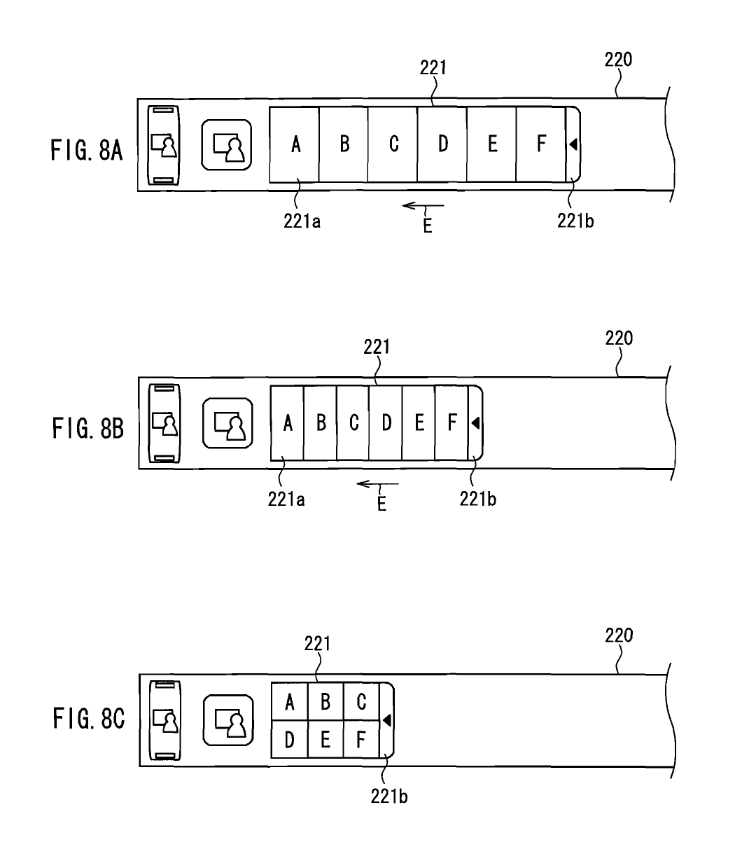

FIGS. 8A to 8C show display examples when a window is contracted.

First, as shown in FIG. 8A, when the operation region 50 (see FIG. 3) corresponding to the drag region 221b is dragged in the direction indicated by the arrow E while a plurality of icons 221a (six icons in the present example) of an ordinary size are being displayed in the window 221 displayed in the task bar 220, the window 211 is contracted in the longitudinal direction. At this time, while all the icons 221a displayed in the state shown in FIG. 8A are being displayed, the size of all the icons 221a displayed in the window 221 also is reduced in a width direction (that is the same direction as the longitudinal direction of the window). FIG. 8B shows a state in which the window 221 is contracted. In the state shown in FIG. 8B, the six icons 221a reduced in size in the width direction are displayed side by side in the longitudinal direction of the window 221.

When the operation region 50 corresponding to the drag region 221b is dragged further in the direction indicated by the arrow E from the state shown in FIG. 8B, the window 221 is contracted further in the longitudinal direction. At this time, while all the icons 221a are being displayed in the state shown in FIG. 8B, the size of all the icons 221a displayed in the window 221 also is reduced in the width direction (that is the same direction as the longitudinal direction of the window). However, if the size in the longitudinal direction of the window 221 is reduced too much, the size in the width direction of the icons 221a becomes too small, which makes it difficult to identify characters and marks of the icons 221a visually. In the present embodiment, when the size in the longitudinal direction of the window 221 or the size in the width direction of the icons becomes a predetermined size or less, the icons are displayed in a plurality of stages in the window 221. FIG. 8C shows an example in which the six icons 221a are displayed in two stages, each stage including three icons. With such a display, even if the window 221 is contracted in the longitudinal direction, all the icons included in the window 221 can be displayed. Furthermore, the aspect ratio after the contraction of the icons is the same as that before the contraction, so that the visibility of the characters and marks of the icons is higher than that in the case of the contraction only in the width direction. The display form shown in FIG. 8C is an example, and the icons can be displayed in three stages, for example, depending upon the size of the window and the number of the icons.

The operation region 50 corresponding to the drag region 221b is dragged in the direction opposite to the direction indicated by the arrow E from the state shown in FIG. 8C, whereby the display form can be shifted to that shown in FIG. 8B or FIG. 8A.

### 3-3. Hierarchy Display

The task bar display in the present embodiment is allowed to have a plurality of levels of hierarchy.

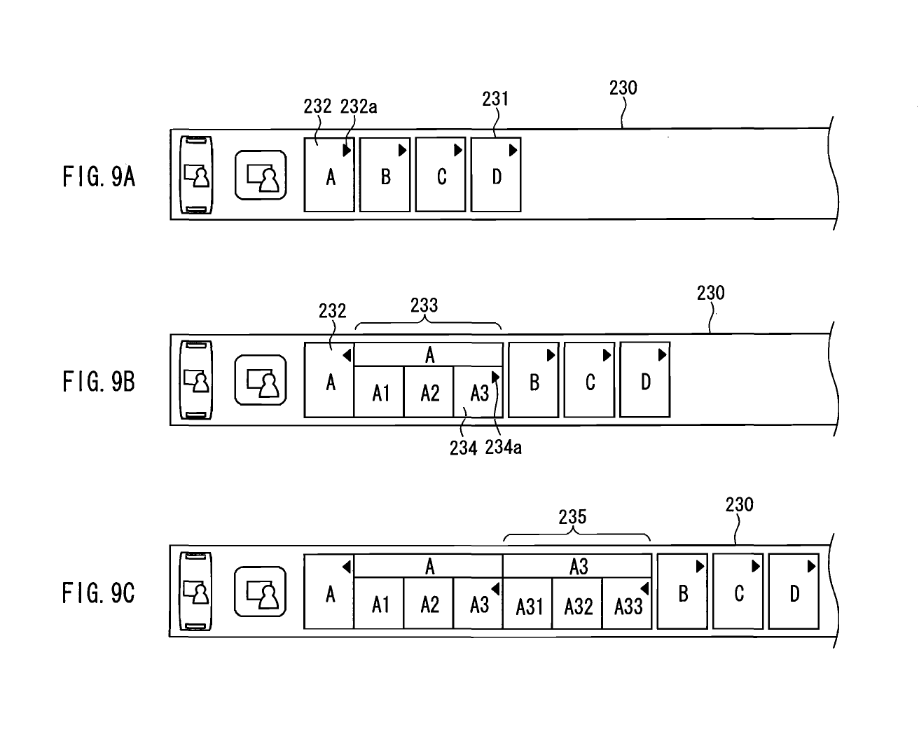

FIGS. 9A to 9C show the shift of a display of a task bar having a plurality of levels of hierarchy. First, in an ordinary display state (in which four icons 232 are displayed in a window 231) shown in FIG. 9A, icons having other icons in lower layers are displayed with hierarchy marks 232a. When the operation region 50 corresponding to the icon 232 is clicked on as an example of the icon having a lower layer, a group of icons 233 in the lower layer of the icon 232 are displayed between the icon 232 and the icon adjacent thereto, as shown in FIG. 9B. The illustrated example shows that a group of icons 233 composed of three icons is present in the lower layer of the icon 232.

Furthermore, when the group of icons 233 is displayed, the hierarchy mark 232a in the icon 232 is switched from a rightward triangular display to a leftward triangular display. The rightward triangular display means that the icon with that display has other icons in a lower layer, and thus, the icon with the rightward triangular display is displayed without the icons in the lower layer being displayed. On the other hand, the leftward triangular display means that the display of the icons in the lower layer can be deleted, so that the icon with the leftward triangular display is displayed while the icons in the lower layer are being displayed. When the operation region 50 corresponding to the icon 232 is clicked on while the hierarchy mark 232a represents the leftward triangular display, the display of the group of icons in the lower layer is deleted, returning to the display shown in FIG. 9A. Hereinafter, although the description will be omitted, the above similarly applies to the hierarchy icons displayed in the other icons.

As shown in FIG. 9B, in the case where there is an icon (icon 234) further having a lower layer in the group of icons 233, the icon 234 is displayed with a hierarchy mark 234a. When the operation region 50 corresponding to the icon 234 provided with the hierarchy mark 234a is clicked on, a group of icons 235 in the lower layer of the icon 234 is displayed adjacent to the icon 234, as shown in FIG. 9C. The illustrated example shows that the group of icons 235 composed of three icons further is present in the lower layer of the icon 234. If there is an icon further having other icons in a lower layer in the icons included in the group of icons 235, the icon is displayed with a hierarchy mark in the same way as the above.

In the state shown in FIG. 9C, the display of the group of icons 235 is deleted, for example, by double-clicking on the operation region 50 corresponding to the group of icons 235, returning to the display of the icon 234 that is an upper layer of the group of icons 235, as shown in FIG. 9B. Furthermore, in the state shown in FIG. 9B, the display of the group of icons 233 is deleted, for example, by double-clicking on the operation region 50 corresponding to the group of icons 233, returning to the display of the icon 232 that is an upper layer of the group of icons 233, as shown in FIG. 9A.

### 3-4. Scroll Display

As shown in FIGS. 9B and 9C, if the number of icons included in a group of icons is about three, all the icons included in the group of icons can be displayed as shown in these figures. However, if the number of icons included in a group of icons is large, all the icons may not be displayed simultaneously.

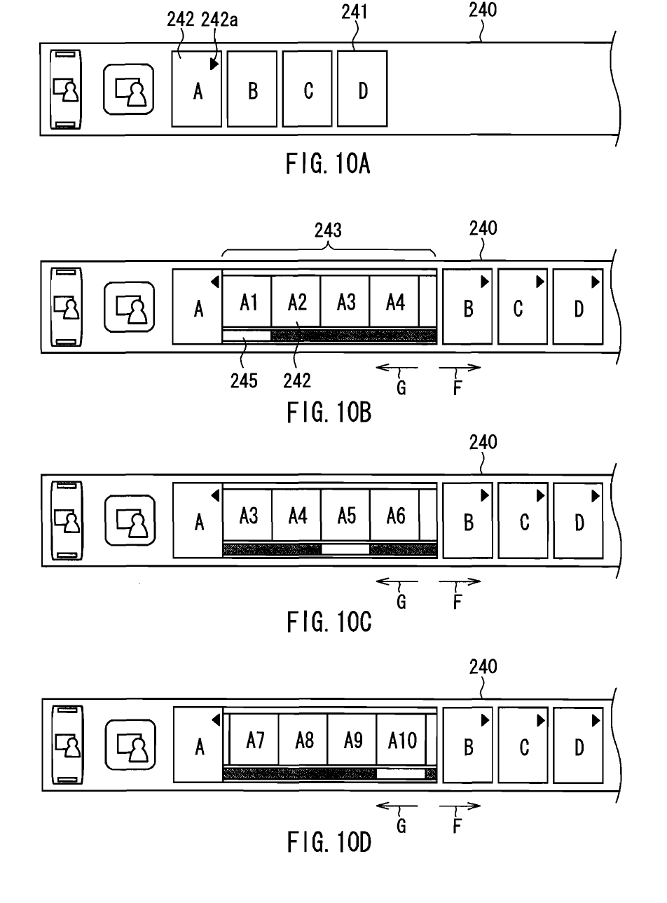

FIGS. 10A to 10D show a display form in the case where the number of icons included in a group of icons is large. First, as shown in FIG. 10A, in an ordinary display state (in which four icons 242 are displayed in a window 241), the icon having other icons in a lower layer is displayed with a hierarchy mark 242a. When the operation region 50 corresponding to the icon 242 is clicked on as an example of the icon having a lower layer, a group of icons 243 in the lower layer of the icon 242 is displayed between the icon 242 and the icon adjacent thereto, as shown in FIG. 10B. In the illustrated example, although the group of icons 243 composed of 10 icons is present in the lower layer of the icon 242, the number of icons 244 that can be displayed simultaneously in the group of icons 243 is set to be four due to the size of the display area of a task bar 240. Specifically, the first four icons are displayed when 10 icons included in the group of icons 243 are arranged in a predetermined order. Furthermore, a scroll bar 245 is displayed below the icons 244.

In order for the user selectively to display and operate all the icons 244 included in the group of icons 243, the operation region 50 corresponding to the scroll bar 245 is dragged in a direction indicated by an arrow F from a position shown in FIG. 10B. When the operation region 50 corresponding to the scroll bar 245 is dragged in the direction indicated by the arrow F, the icons 244 displayed in the display area of the group of icons 243 move in the direction indicated by a direction indicated by an arrow G. For example, when the scroll bar 245 is moved to a position shown in FIG. 10C, the third to sixth icons 244 are displayed. When the operation region 50 corresponding to the scroll bar 245 is dragged further in the direction indicated by the arrow F from a position shown in FIG. 10C, the icons 244 displayed in the display area of the group of icons 243 move in the direction indicated by the arrow G to obtain a state shown in FIG. 10D. In the state shown in FIG. 10D, the seventh to tenth icons 244 are displayed.

When the operation region 50 corresponding to the scroll bar 245 is dragged in the direction indicated by the arrow G when the scroll bar 245 is placed at a position shown in FIG. 10D, the icons 244 included in the group of icons 243 move in the direction indicated by the arrow F, and the state is shifted to the one shown in FIG. 10C, for example. Similarly, the operation region 50 corresponding to the scroll bar 245 is dragged in the direction indicated by the arrow F from the state shown in FIG. 10C, whereby the state is shifted to the one shown in FIG. 10B.

Thus, the icons 244 included in the group of icons 243 are moved in the direction indicated by the arrow G or F to be displayed by dragging the operation region 50 corresponding to the scroll bar 245 in the direction indicated by the arrow F or G. Thus, all the icons included in the group of icons 243 can be displayed selectively so as to be placed in an operable state.

### 3-5. Display of Setting Contents

In the above description, the icons displayed in the task bar are used for activating predetermined functions and application software, and provided with designations and marks indicating the functions and application software. The task bar in the present embodiment can be provided with various pieces of information, in addition to such a display.

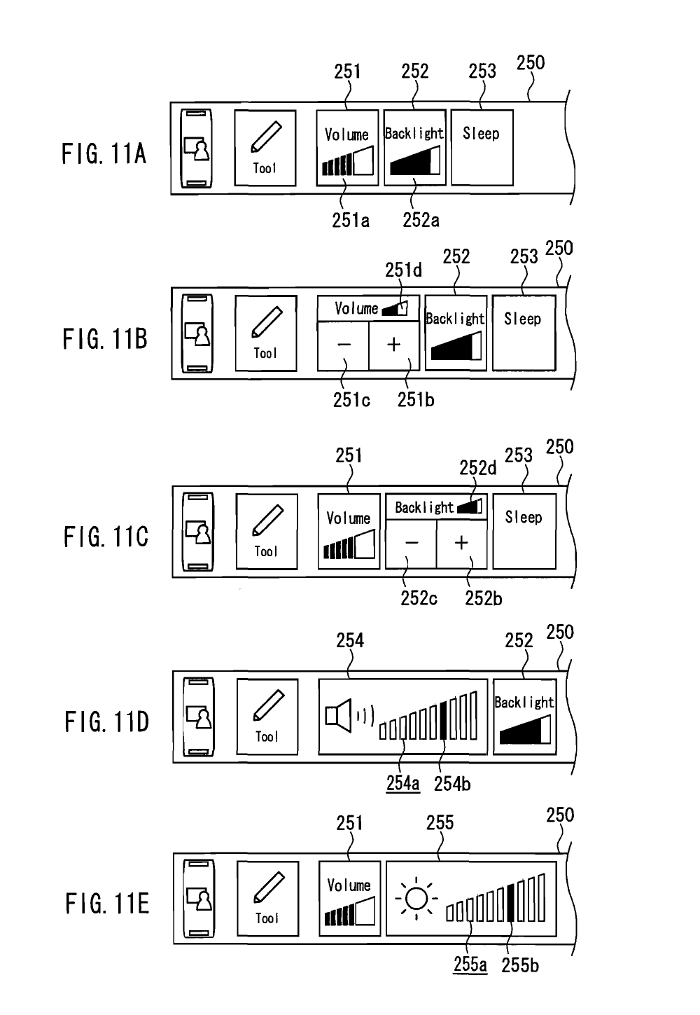

FIGS. 11A to 11C show display forms of icons in a task bar in the present embodiment. As shown in FIG. 11A, a task bar 250 displays a volume adjusting icon 251, a backlight adjusting icon 252, and a sleep icon 253. At this time, the volume adjusting icon 251 displays information 251a on a current volume level. Furthermore, the backlight adjusting icon 252 displays information 252a on a current brightness level of a backlight of the display 4 (in the case where the display 4 includes a liquid crystal display panel). Furthermore, the sleep icon 253 is capable of shifting the notebook PC to a sleep state. Thus, by allowing the icons displayed in the task bar 250 to display current various setting states, the user can grasp the current setting states immediately without opening the screen displaying the current setting states.

FIG. 11B shows a display form at a time of adjusting a volume. In the state shown in FIG. 11A, when the operation region 50 corresponding to the volume adjusting icon 251 is clicked on, the volume adjusting icon 251 is switched to a display form shown in FIG. 11B to be displayed. In the display form shown in FIG. 11B, a plus button 251b and a minus button 251c capable of adjusting a volume can be displayed. Every time the user clicks on the operation region 50 corresponding to the plus button 25b, the volume of a voice output from an internal speaker (not shown) or a headphone terminal (included in the interface 15 shown in FIG. 3) is raised, and every time the operation region 50 corresponding to the minus button 251c is clicked on, the volume is lowered. By operating the operation region 50 corresponding to the plus button 251b or the minus button 251c, the level display in a volume indicator 251d displayed in the vicinity of the plus button 251b increases or decreases. The user can adjust a volume while checking the current volume setting by watching the display of the volume indicator 251d.

Furthermore, when adjusting the brightness of a backlight, the user clicks on the operation region 50 corresponding to the backlight adjusting icon 252 in FIG. 11A When the user clicks on the operation region 50 corresponding to the backlight adjusting icon 252, the backlight adjusting icon 252 is switched to a display form shown in FIG. 11C to be displayed. In the display form shown in FIG. 11C, a plus button 252b and a minus button 252c capable of adjusting the brightness of the backlight are displayed. Every time the user clicks on the operation region 50 corresponding to the plus button 252b, the brightness of the backlight in the display 4 is raised, and every time the user clicks on the operation region 50 corresponding to the minus button 252c, the brightness of the backlight in the display 4 is lowered. By operating the operation region 50 corresponding to the plus button 252b or the minus button 252c, the level display in a brightness indicator 252d displayed in the vicinity of the plus button 252b increases or decreases. The user can adjust the brightness while checking the current brightness setting by watching the display of the brightness indicator 252d.

As a method for adjusting a volume, there is a method for adjusting a volume by dragging the operation region 50, in addition to the method for clicking on the operation region 50 corresponding to the plus button 251b or the minus button 251c shown in FIG. 11B. FIG. 11D shows another example of a volume adjustment display. The display of the volume adjusting icon 251 shown in FIG. 11A is switched to a volume adjusting region 254 shown in FIG. 11D when the operation region 50 corresponding to the volume adjusting icon 251 is clicked on. The volume adjusting region 254 shown in FIG. 11D displays a plurality of bars 254a with different heights. In the present embodiment, 10 bars 254a are displayed, and a low bar at the left end of the figure represents a smallest volume (volume=0) and a high bar at the right end of the figure represents a largest volume. One bar 254b among a plurality of bars 254a is displayed in a color different from that of the other nine bars. The bar 254b represents a currently set volume. When the operation region 50 corresponding to the bar 254a is dragged in the direction indicated by the arrow D (see FIG. 3) in a state in which the volume adjusting region 254 shown in FIG. 11D is displayed in the task bar 200, the volume of a voice output from the internal speaker (not shown) or the headphone terminal (included in the interface 15 in FIG. 3) is raised. Along with this, the color of the bar 254b displayed in a different color before the dragging is switched to an ordinary color, and the bar adjacent to the bar 254b on the right side in a direction facing the drawing surface is switched from the ordinary color to a display in the different color. Furthermore, when the operation region 50 is dragged in the direction indicated by the arrow D, the bar displayed in the different color is shifted in the right direction in the figure along with the increase in volume. On the other hand, when the operation region 50 corresponding to the bar 254a is dragged in the direction indicated by the arrow E (see FIG. 3) in a state in which the volume adjusting region 254 shown in FIG. 11D is displayed in the task bar 200, the volume of a voice output from the internal speaker (not shown) or the headphone terminal (included in the interface 15 in FIG. 3) is lowered. Along with this, the color of the bar 254b displayed in the different color before the dragging is switched to the ordinary color, and the bar adjacent to the bar 254b on the left side in a direction facing the drawing surface is switched from the ordinary color to a display in the different color. Furthermore, when the operation region 50 is dragged in the direction indicated by the arrow E, the bar displayed in the different color is shifted in the left direction in the figure along with the decrease in volume.

As a method for adjusting the brightness of a backlight, there is a method for adjusting the brightness by dragging the operation region 50, in addition to the method for clicking on the operation region 50 corresponding to the plus button 252b or the minus button 252c shown in FIG. 11C. FIG. 11E shows another example of a brightness adjustment display. The display of the backlight adjusting icon 252 shown in FIG. 11A is switched to a brightness adjusting region 255 shown in FIG. 11E when the operation region 50 corresponding to the backlight adjusting icon 252 is clicked on. The brightness adjusting region 255 shown in FIG. 11E displays a plurality of bars 255a with different heights. In the present embodiment, 10 bars 255a are displayed, and a low bar at the left end of the figure represents a lowest brightness and a high bar at the right end of the figure presents a highest brightness. One bar 255b among a plurality of bars 255a is displayed in a color different from that of the other nine bars. The bar 255b represents a currently set brightness. When the operation region 50 corresponding to the bar 255a is dragged in the direction indicated by the arrow D (see FIG. 3) in a state in which the brightness adjusting region 255 shown in FIG. 11E is displayed in the task bar 200, the brightness of a backlight of the display 4 is raised Along with this, the color of the bar 255b displayed in a different color before the dragging is switched to an ordinary color, and the bar adjacent to the bar 255b on the right side in a direction facing the drawing surface is switched from the ordinary color to a display in the different color. Furthermore, when the operation region 50 is dragged in the direction indicated by the arrow D, the bar displayed in the different color is shifted in the right direction in the figure along with the increase in brightness. On the other hand, when the operation region 50 corresponding to the bar 255a is dragged in the direction indicated by the arrow E (see FIG. 3) in a state in which the brightness adjusting region 255 shown in FIG. 11E is displayed in the task bar 200, the brightness of a backlight of the display 4 is lowered. Along with this, the color of the bar 255b displayed in the different color before the dragging is switched to the ordinary color, and the bar adjacent to the bar 255b on the left side in a direction facing the drawing surface is switched from the ordinary color to a display in the different color. Furthermore, when the operation region 50 is dragged in the direction indicated by the arrow E, the bar displayed in the different color is shifted in the left direction in the figure along with the decrease in brightness.

In the present embodiment, although the volume setting and the brightness setting of a backlight are described, they are shown merely for illustrative purposes.

### 3-6. Expansion Display of a Task Bar

Next, another display example of the display 4 when the operation region 50 corresponding to the task bar 200 is operated will be described.

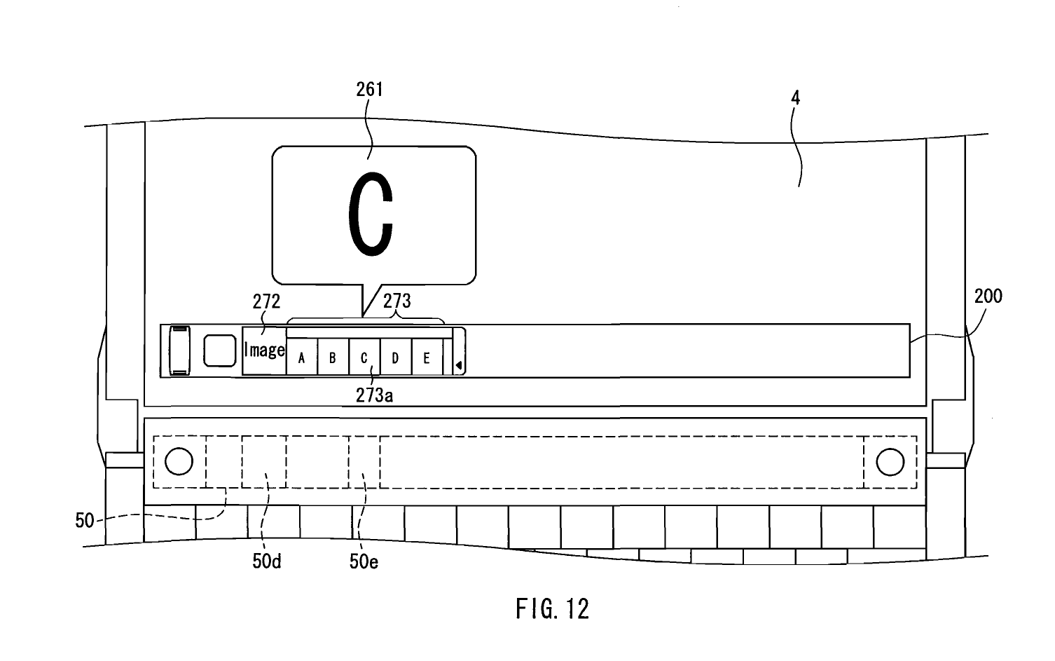

FIG. 12 shows another display example of the display 4. In the present embodiment, the display of a list of image files in the task bar 200 will be described as an example.

First, when an operation region 50d (a part of the operation region 50) corresponding to an image display icon 272 is clicked on, a group of icons 273 are displayed in a region adjacent to the image display icon 272. The group of icons 273 includes icons representing thumbnail images (scaled-down images) of image files.

Next, when the operation region 50 corresponding to an icon (for example, an icon 273a) of a desired image file among the group of icons 273 (for example, an operation region 50e corresponding to an icon 273a) is clicked on, an image based on the image file corresponding to the icon 273a is displayed on the display 4. The image may be displayed over the entire area of the display 4 or a scaled-down image 261 may be displayed as shown in FIG. 12. It is preferred that the scaled-down image 261 has a size larger than that of at least the thumbnail image displayed in the task bar 200. The scaled-down image 261 is preferred since, when the scaled-down image 261 is displayed in the vicinity of the icon 273a, the relationship with the icon 273a can be displayed clearly. The scaled-down image 261 may be displayed in a rectangular shape; however, it is preferred that the scaled-down image 261 is displayed in a balloon shape as shown in FIG. 12, since the relationship with the icon 273a can be displayed more clearly.

The operation of displaying the scaled-down image 261 on the display 4 is not limited to a method for clicking on the operation region 50 corresponding to the icon displayed in the group of icons 273. For example, there is a method for sliding the operation region 50 corresponding to an icon desired to be displayed as the scaled-down image 261 toward the display 4 in the operation region 50 (sliding operation in the direction indicated by the arrow B in FIG. 3), thereby allowing the scaled-down image 261 based on the image file corresponding to the icon to be displayed in the display 4.

By clicking on the operation region 50 corresponding to another icon in the group of icons 173 from the state shown in FIG. 12, a scaled-down image corresponding to the icon selected by the click operation can be displayed in addition to the scaled-down image 261 that is currently being displayed. That is, a plurality of scaled-down images can be displayed simultaneously on the display 4. A plurality of scaled-down images are displayed simultaneously, whereby the plurality of scaled-down images can be compared with each other on the display 4. A scaled-down image that has been displayed in the past may be deleted by displaying only the scaled-down image corresponding to the icon selected by the click operation on the display 4, instead of displaying a plurality of scaled-down images simultaneously.

Furthermore, the scaled-down image displayed on the display 4 can be switched to a scaled-up display. Specifically, the scaled-down image 261 can be scaled up so as to be displayed over the entire area of the display 4 by clicking on the operation region 50 corresponding to the icon of the scaled-down image 261 again. Furthermore, the scaled-down image 261 also can be adjusted to an arbitrary size by operating the pointing device 7 or the like to drag an edge of the scaled-down image 261 in an image scale-up direction.

Furthermore, the display of the scaled-down image 261 can be deleted by double-clicking on the operation region 50 corresponding to the icon of the scaled-down image 261. Furthermore, the scaled-down image 261 also can be deleted by operating the pointing device 7 or the like to click or double-click on the scaled-down image 261.

In the present embodiment, although a thumbnail (icon) of an image file is displayed in the task bar 200, and a scaled-down image or a scaled-up image corresponding to the thumbnail is displayed on the display 4, information that can be handled is not limited to an image file. For example, the present embodiment also can be used in a videoconference system.

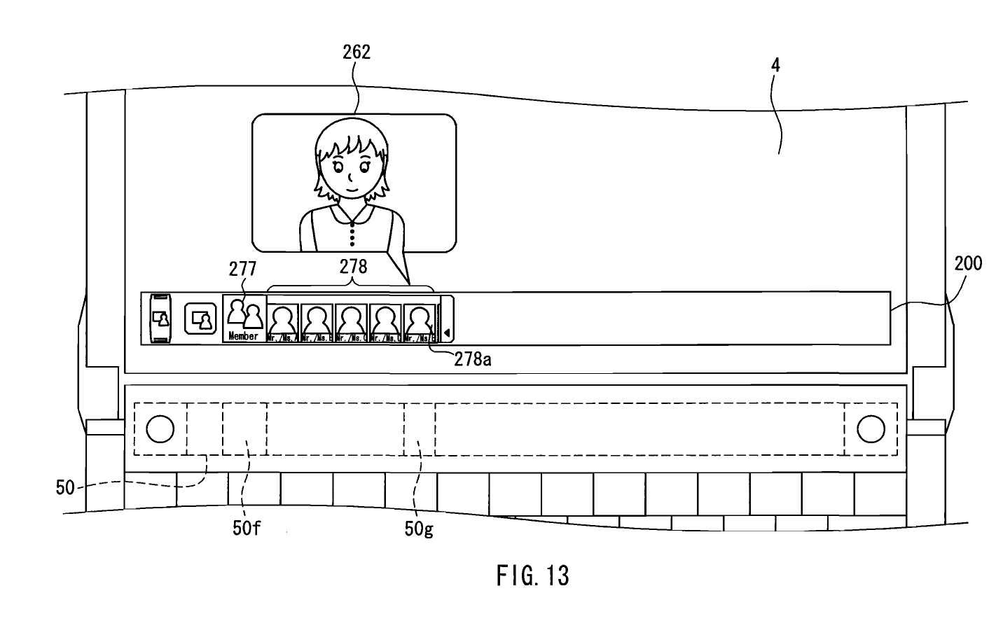

FIG. 13 shows a display form of the display 4 in a videoconference system. In the example shown in FIG. 13, when an operation region 50f (a part of the operation region 50) corresponding to a member icon 277 is clicked on, a group of icons 178 corresponding to members connected to the videoconference system or members connectable thereto is displayed.

Next, an operation region 50g (a part of the operation region 50) corresponding to an icon (for example, an arbitrary icon 278a) representing a member that the user desires to access from among the group of icons 278 is clicked on. By performing this operation, an image based on image data sent from a personal computer of the member corresponding to the icon 278a through a network is displayed on the display 4 as a scaled-down image 262. Specifically, a face image (a still image or a moving image) of the member photographed by a cameral connected to the personal computer of the member corresponding to the icon 278a is displayed as the scaled-down image 262. An operation method for changing the size of the scaled-down image 262 and a method for deleting the display of the scaled-down image 262 are as described with reference to FIG. 12, so that the description thereof will be omitted.

### 3-7. Interlocked Display with Application Software

Next, a display form of the operation region 50 while application software is being activated on the display 4 will be described.

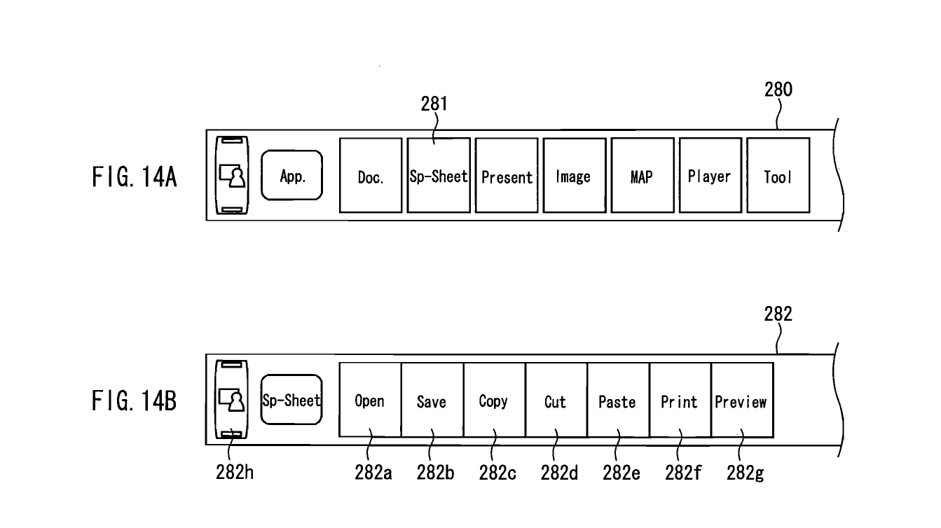

FIG. 14A shows a task bar including icons capable of executing various pieces of application software. The operation region 50 corresponding to an icon of application software, which the user desires to execute, is clicked on while a task bar 280 is being displayed as shown in FIG. 14A, whereby the application software is executed. In the present embodiment, the description will be made assuming that the operation region 50 corresponding to the icon 281 capable of activating a spreadsheet program is clicked on.

When the operation region 50 corresponding to the icon 281 is clicked on, a spreadsheet program installed on the notebook PC is executed, and a screen of the spreadsheet program is displayed in the display 4. At this time, the task bar 280 is switched from the display contents shown in FIG. 14A to the display contents of a task bar 282 shown in FIG. 14B. The task bar 282 includes icons 282a to 282g having functions executable in the spreadsheet program. Specifically, the icon 282a is capable of inputting a command for opening a file that has already been created. The icon 282b is capable of inputting a command for saving a created table in a predetermined file format. The icon 282c is capable of inputting a command for creating a copy of arbitrary data in the table. The icon 282d is capable of inputting a command for cutting arbitrary data in the table. The icon 282e is capable of inputting a command for pasting the data subjected to copying or cutting to an arbitrary position in the table. The icon 282f is capable of inputting a command for printing the created table. The icon 282g is capable of inputting a command for previewing a printed image on the display 4 before printing the created table. The operation region 50 corresponding to a desired icon among the icons displayed in the task bar 282 is clicked on, whereby the function corresponding to the icon can be executed.

Furthermore, the number of kinds of the task bar 282 shown in FIG. 14B may be one. However, if application software is multifunctional and the number of icons to be registered in the task bar is large, a plurality of kinds of task bars may be provided. In this case, when the operation region 50 corresponding to a task bar mark 282h is clicked on or dragged in the state shown in FIG. 14B, the display of the task bar can be switched in the same way as in the switching operation shown in FIG. 4.

The task bar 282 shown in FIG. 14B is a task bar displayed first when the spreadsheet program is activated, and the kinds of icons to be included in the task bar vary depending upon application software to be activated.

When the spreadsheet program is completed, the display contents of the task bar 282 return to those of the task bar 280.

### 3-8. Specific Example

Next, a specific example using a task bar in the present embodiment will be described. As the specific example, a videoconference system will be illustrated.

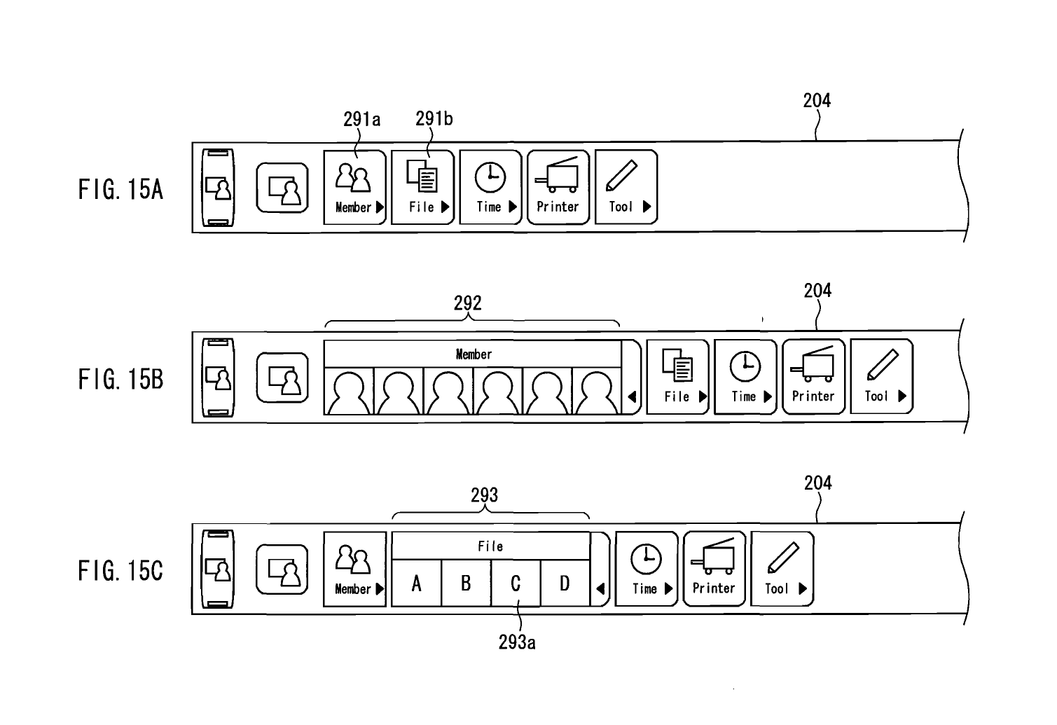

FIG. 15A shows an initial state of a task bar, which corresponds to the task bar 204 shown in FIG. 4. First, in the task bar 204 shown in FIG. 15A, when the operation region 50 corresponding to a member icon 291a is clicked on, a list of members connected to the videoconference system or a list of members connectable thereto is displayed as a group of icons 292, as shown in FIG. 15B. If the operation region 50 corresponding to an icon of a member that the user desires to be connected to is clicked on among the displayed group of icons 292, the state can be shifted to the one in which direct exchange can be performed with respect to the personal computer of the member.

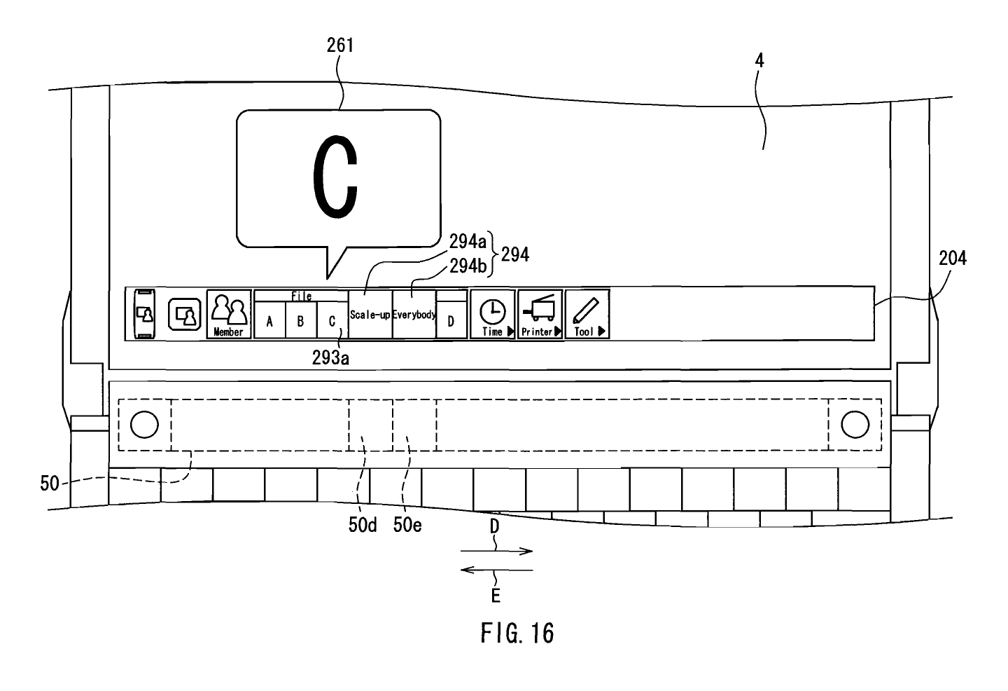

On the other hand, in the task bar 204 shown in FIG. 15A, if the operation region 50 corresponding to a file icon 291b is clicked on, a list of files can be displayed as a group of icons 293, as shown in FIG. 15C. The files listed in the group of icons 293 are image files, material files for presentation, and the like. Next, in FIG. 15C, when the operation region 50 corresponding to a desired icon (for example, an icon 293a) is clicked on among the group of icons 293, the scaled-down image 261 is displayed on the display 4 and a sub-menu 294 is displayed in the task bar 204, as shown in FIG. 16.

The sub-menu 294 includes a scale-up button 294a and an everyone button 294b. When the operation region 50h (a part of the operation region 50) corresponding to the scale-up button 294a is clicked on, a file corresponding to the icon 293a is opened and is scaled-up and displayed on the display 4. Furthermore, when the operation region 50i (a part of the operation region 50) corresponding to the everyone button 294b is clicked on, a file corresponding to the icon 293a can be opened to the members connected to the videoconference system.

Furthermore, in FIG. 16, when the operation region 50 corresponding to an arbitrary icon displayed in the operation region 50 is pressed continuously for a predetermined period of time (for example, about 2 seconds), an icon corresponding to the pressed operation region is placed in a state capable of being dragged. For example, when the operation region 50 corresponding to an arbitrary file icon is pressed with a finger continuously for a predetermined period of time, the file icon is placed in a state capable of being dragged. When an arbitrary icon is retained in a state capable of being dragged, and the finger is slid in the direction indicated by the arrow D or E, the file icon is moved, interlocked with the movement of the finger (drag operation). When the moved file icon is moved to a position overlapping the everyone button 294b, and the finger is detached from the operation region 50 (drop operation), a file corresponding to the file icon is opened to the personal computers of the other members connected to the videoconference system. Furthermore, when operations (drag and drop operations) for moving the file icon onto a printer icon are performed, data associated with the file icon is sent to a printer connected to a personal computer of the user. The printer prints data sent from the personal computer. Thus, the operation region 50 is operated to move an arbitrary icon (a file icon, etc.) onto another icon (an icon regarding various pieces of processing), whereby arbitrary processing such as printing can be executed and the operability can be enhanced.

### 4. Effects of the Present Embodiment, Etc.

According to the present embodiment, windows and icons displayed in a task bar can be expanded or contracted, whereby a number of icons can be displayed in one task bar, and the squeeze of the display area caused by the increase in icons can be reduced. More specifically, a display area other than the task bar can be kept large, and a number of pieces of information can be displayed.

Furthermore, icons are displayed hierarchically in one task bar, whereby a number of icons can be displayed in one task bar, and the squeeze of the display area caused by the increase in icons can be reduced. Furthermore, the hierarchically arranged icons can be accessed directly, so that the operability can be enhanced.

Furthermore, by displaying a mark indicating that hierarchy is present in icons when the icons are displayed hierarchically in one task bar, the user can grasp the icons having hierarchy easily.

Furthermore, in the case where the number of icons included in one task bar is large, and all the icons cannot be displayed simultaneously, only a part of the icons is displayed, and further, a scroll bar is displayed in the task bar. Then, moving the scroll bar allows the task bar to be scrolled, and can shift the icons that are not originally displayed to a state in which they can be displayed.

When a window is contracted and displayed in a longitudinal direction, icons included in the window are contracted and displayed, whereby all the icons included in the window can be displayed, or as many as possible, even when the window is reduced in size.

Furthermore, the current setting states such as a volume and a brightness of a backlight of the display 4 are displayed in the task bar, whereby the current setting states such as a volume or a brightness can be checked easily without being bothered to open a volume display screen and a brightness display screen. Furthermore, by clicking on the icon displaying the setting state, a screen capable of changing the setting can be displayed.

Furthermore, when an icon is clicked on, another icon related to the clicked icon is displayed automatically. Thus, the operability can be enhanced. According to the prior art, in the case where another icon related to the clicked icon is present in another window or another task bar, it takes a long time to search for another icon. In the present embodiment, by displaying another related icon immediately, the time and labor for searching for another icon can be saved, which can enhance the operability.

An icon related to application software, which has been activated, is displayed, whereby the operability can be enhanced. More specifically, since the function that is frequently used in application software can be activated with the icon in the task bar, the function that is frequently used can be activated with less operation, which can enhance the operability. As a method for activating the function with less operation, there is a method (a so-called shortcut key) for activating the function by operating a predetermined plurality of keys on a keyboard simultaneously. However, such a shortcut key may vary depending upon an OS or application software, which causes effort and time for the user to remember the shortcut key. In the present embodiment, the function that is frequently used can be activated by one-touch clicking of the operation region 50, whereby it is not necessary to remember a shortcut key, which can enhance the operability.

Furthermore, since the operation region 50 is provided independently from the display 4, the display 4 can be prevented from being contaminated, compared with the configuration in which a touch panel is provided on the display 4. More specifically, in the present embodiment, since the user does not touch the display surface of the display 4, the contamination of the display 4 can be prevented.

Furthermore, the operation region 50 is placed at a position dose to the display 4 in the first housing 1, whereby a sense of integration with the contents displayed on the display 4 can be enhanced when an interlocked display with respective to the display 4 is performed, which can enhance the visibility.

Furthermore, the operation region 50 is placed in an upper portion of the keyboard 6 (a portion between the keyboard 6 and the second housing 2) as shown in FIG. 3, whereby the operability comparable to the keyboard operation can be realized.

The position of the operation region 50 is not limited to that shown in FIGS. 1 and 3, and for example, the operation region 50 may be placed adjacent to the keyboard 6 on the left or right side in a direction facing the drawing surface in FIG. 3 so as to have a longitudinal direction in the vertical direction. Furthermore, the operation region 50 may be placed adjacent to the pointing device 7 on the lower side in a direction facing the drawing surface in FIG. 3 so as to have a longitudinal direction in the horizontal direction. The arrangement shown in FIGS. 1 and 3 is most preferred.

Furthermore, the operation region 50 may be placed in the second housing 2 instead of the first housing 1. In the case where the operation region 50 is placed in the second housing 2, it is preferred that the operation region 50 is placed at a position as dose to the task bar 200 as possible, such as a position in the vicinity of the rotation shaft of the first housing 1 and the second housing 2.

In the present embodiment, the operation of switching the display of the task bar shown in FIG. 4 can be performed by clicking the operation region 5 corresponding to the task bar mark 200a or dragging the operation region 50 in the direction indicated by the arrow A or B. However, a hard key configuration may be used instead of such a soft key configuration. Examples of the hard key configuration include the configuration in which dedicated operation portions (a button, a wheel, etc.) for switching the display of the task bar is provided in the first housing 1, the configuration in which the operation can be performed using a cursor key on the keyboard 6, the configuration in which a dedicated region for switching the task bar is provided on the operation surface of the pointing device 7, and the configuration in which the display of the task bar is switched, interlocked with the rotation of a wheel provided at a mouse connected to a USB terminal in the interface 15.

Furthermore, icons displayed in the task bar in the present embodiment may be changed arbitrarily by the user. Examples of the contents to be changed include the deletion of icons registered as a default (at a time of shipping of a notebook PC), the additional registration of other icons, and the change in position of the registered icons. As a method for changing an icon, there is a method in which an icon setting screen is displayed on a display, and an icon can be added, deleted, or changed in position on the icon setting screen. Furthermore, there also is a method in which an icon desired to be added is moved by dragging to an arbitrary position on the task bar and is added by dropping, a registered icon is excluded out of the task bar by dragging and dropping, and a registered icon is changed in position by dragging and dropping. In the case of adding an icon by dragging and dropping, the icon can be added with the pointing device 7, a mouse connected to the interface 15, or the like.

Furthermore, regarding the expansion/contraction operation of the window 211 shown in FIGS. 5A to 5C, in the present embodiment, the window 211 can be expanded to the right end of the task bar 204. However, the window 211 may be expanded in a range in which all the icons 212 can be displayed. Furthermore, when the window 211 is contracted to a size equal to that of the icons, the window 211 may be dosed automatically to be switched to an icon display.

Furthermore, the initial size of the window is set to be the maximum size in a range in which all the icons and windows can be displayed simultaneously in the task bar while a plurality of windows are being displayed as shown in FIGS. 6 and 7. However, the window may have a fixed size irrespective of whether all the icons and windows can be displayed simultaneously in the task bar. In this case, although some icons and windows may not be displayed in the task bar, the icons and window that cannot be displayed can be displayed by scrolling, if a scroll bar is displayed at a lower end of the task bar so as to scroll the task bar.

Furthermore, one kind of a hierarchy mark is displayed in the case where the icons have hierarchy irrespective of the number of levels of hierarchy in the present embodiment. However, the form of the hierarchy mark may be changed depending upon the number of levels of hierarchy. For example, in the hierarchy mark displayed at an icon in an uppermost layer, a hierarchy mark in the case where there is one lower layer is made different from a hierarchy mark in the case where there are two lower layers. Because of this, the number of levels of hierarchy can be grasped merely by checking a hierarchy mark displayed at an icon in an uppermost layer. Furthermore, a numerical value indicating the number of levels of hierarchy is displayed at a hierarchy mark, whereby the number of levels of hierarchy can be grasped more easily.

Furthermore, the information processing unit of the present invention is not limited to a notebook PC as in the present embodiment. The present invention is useful as long as it is an appliance on which at least a GUI (Graphical User Interface) such as a task bar can be mounted. Application examples of the present invention include a desktop personal computer, a PDA (Personal Digital Assistance), a mobile telephone terminal, a game machine, and a medical appliance.

Particularly, the present invention is useful for an appliance having a display portion whose size is limited, such as a stationary DVD recorder (a display portion mounted on a front panel), an electronic photostand, a car navigation system, and a dock radio. In such an appliance, a display portion to be mounted is small so that the amount of information that can be displayed is limited; however, a large amount of information can be displayed in a display form as in the present embodiment.

Furthermore, the display 4 in the present embodiment is one example of the first display unit of the present invention. The operation region 50 and the touch sensor 53 in the present embodiment are examples of the operation unit of the present invention. The configurations that cause the display 4 or the display panel 42 to display an image, such as the CPU 11, the RAM 12, and the display control portion 41 in the present embodiment, are examples of the display control unit of the present invention. Furthermore, the task bar in the present embodiment is an example of the icon display area of the present invention.

The present invention can be used widely, for example, in an information processing unit that uses a plurality of system environments by switching, without being limited to a portable notebook PC.

Regarding the present embodiment, the following notes will be disclosed.

(Note 1)

An information processing unit that displays icons selected when predetermined processing is designated on a screen of a display unit, including:

a display control unit that causes an icon display area, in which a plurality of the icons related to each other are grouped, to be displayed; and

an operation unit that receives various operations by a user,

wherein, when the operation unit inputs a command for expanding or contracting the icon display area in a one-dimensional direction that is the same as an arrangement direction of the plurality of the icons in the icon display area, the display control unit causes the icon display area to be expanded or contracted in the one-dimensional direction.

(Note 2)

The information processing unit according to Note 1, including a first housing provided with the display unit, and a second housing via a rotation shaft that opens or doses the first housing rotatably,

wherein the operation unit is placed in a vicinity of the rotation shaft in the second housing.

(Note 3)

The information processing unit according to any one of Notes 1 and 2, wherein the operation unit receives respective operations at positions corresponding to the plurality of the icons displayed in the icon display area.

(Note 4)

The information processing unit according to any one of Notes 1 to 3, wherein the operation unit includes a designation portion, which designates a display or a non-display of the icon display area on the screen, in at least one end portion of the arrangement direction of the plurality of the icons.

### Embodiment 2

An information processing unit according to Embodiment 2 includes an operation unit that operates a function in accordance with an operating system or various application systems.

As the operation unit that operates a function in accordance with an operating system or an application system, a mouse operation and an operation called a “shortcut key” in which particular keys on a keyboard are combined are known. A shortcut key is, for example, an operation capable of copying a file or a character by operating a control key and a key “C” on a keyboard.

The mouse operation is an operation of pressing a button after moving a pointer to a particular position on a screen. Therefore, the mouse operation has an advantage of ease of visual understanding; however, it can execute only a function displayed on the screen.

On the other hand, according to the shortcut key operation, a combination of particular keys on a keyboard is operated, so that the shortcut key operation has an advantage of being able to execute a function at a high speed. However, in the shortcut key operation, it is necessary to press a plurality of keys corresponding to a function simultaneously, so that the user is bothered to remember a combination of a plurality of keys and functions corresponding thereto. Therefore, in spite of the fact that a variety of combinations of keys are prepared previously, the shortcut key has not actually spread so widely for the reason of complicatedness.

JP 2002-259009 A discloses the advantages of the above-mentioned mouse operation and shortcut key operation. A computer apparatus disclosed by JP 2002-259009 A includes a display device having a tool bar display area that displays tool bars. A plurality of tool bars displayed in the tool bar display area disclosed by JP 2002-259009 A can be rotated by a mouse operation. Another window is displayed at the center of the tool bar display area. One end of another window has a region in which a menu screen of a tool bar display and a title of another window are displayed. The other end of another window has a control region provided with icons of a plurality of operation buttons. By selecting an operation button in the control region by a mouse operation, the icons and tool bars displayed in another window are rotated and displayed.

Thus, JP 2002-259009 A proposes solving the largest problem that the mouse operation has less operation functions, by rotating and displaying a tool bar displaying icons displayed in another window. However, for example, in order to realize a variety of functions as seen in a shortcut key operation, the number of rotations of a tool bar displayed in another window increases, which takes a long time to find out a desired icon or tool bar. Furthermore, an icon provided in the control region is selected by a mouse operation, so that the user needs to detach his/her hand from a keyboard when moving a mouse, which may result in remarkably degraded operability.

The information processing unit according to Embodiment 2 has an object of selecting and executing a variety of functions by an operation similar to a key input.

### 1. Configuration of an Information Processing Unit

The information processing unit according to Embodiment 2 can be realized, for example, by a notebook PC. The information processing unit according to Embodiment 2 has a hardware configuration similar to that shown in FIGS. 1 and 2.

### 2. Operation of a Notebook PC by a Touch Sensor

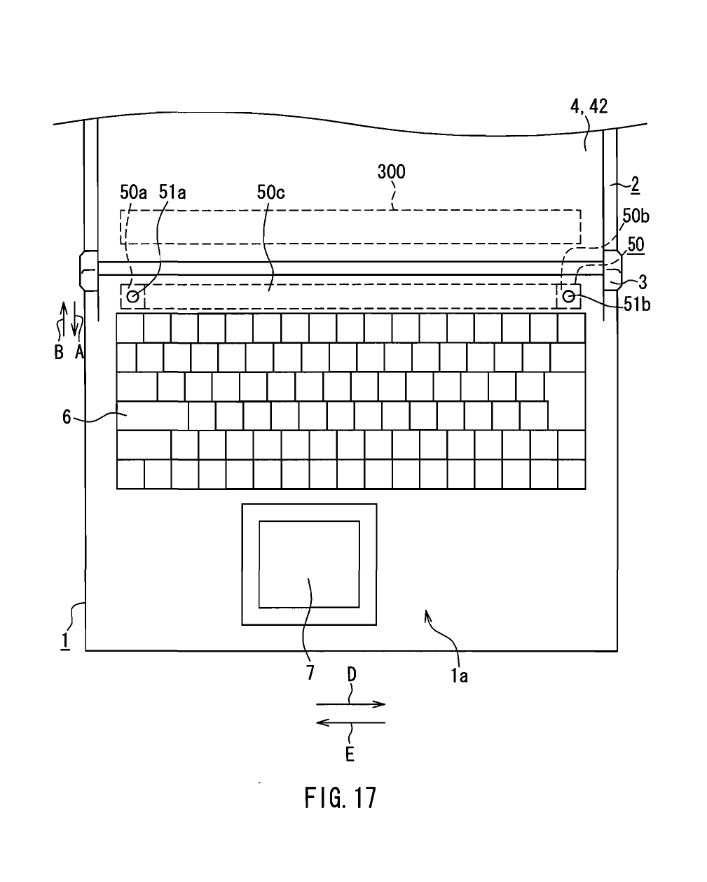

FIG. 17 is a plan view of a notebook PC in the present embodiment, mainly showing a configuration of an upper surface 1a of a first housing 1.

As shown in FIG. 17, an operation region 50 has a substantially rectangular shape. The operation region 50 has a shape with a long side being much larger than a short side. The operation region 50 is placed so that a longitudinal direction thereof is substantially parallel to the long side of the first housing 1. The operation region 50 indicates a part of the upper surface 1a of the first housing 1, corresponding to a region in which the touch sensor 53 (see FIG. 2) is placed inside the first housing 1. That is, when the user presses at least a part of the operation region 50, the matrix switch included in the touch sensor 53 (see FIG. 2) is switched from OFF to ON.

The operation region 50 indicates a region in which the touch sensor 53 (see FIG. 2) is capable of detecting the user's pressing. In the present embodiment, circular marks 51a and 51b are provided at both ends in the longitudinal direction of the operation region 50, whereby the user can be informed of that regions in the vicinity of the circular marks 51a and 51b and a region sandwiched between the circular marks 51a and 51b correspond to the operation region 50.

Although the operation region 50 does not appear in the external appearance of the first housing 1 in the present embodiment, a broken line shown in FIG. 17 is described actually in the first housing 1 with a solid line, or a region corresponding to the operation region 50 on the upper surface 1a of the first housing 1 can be colored. With such a configuration, the user can grasp the position of the operation region 50 easily, which can enhance the operability.

The operation region 50 includes a first region 50a, a second region 50b, and a third region 50c. In portions of the operation surface corresponding to the first region 50a and the second region 50b, the circular marks 51a and 51b are described, respectively. The circular marks 51a and 51b are used for notifying the user of the position of the first region 50a or the second region 50b when the user performs an operation of displaying a menu bar (described later). Although a portion of the operation surface corresponding to the third region 50c is not provided with a mark or the like in the present embodiment, it is preferred to provide a mark or the like for notifying the user that the portion is the operation region.

The matrix switches in the first region 50a and the second region 50b are assigned the same function, respectively. Specifically, the matrix switches in the first region 50a and the second region 50b are assigned a function of displaying a menu bar (described later) on the display 4 and a function of switching the display of the menu bar. The matrix switches in the first region 50a and the second region 50b are assigned the same function, whereby the operability for the user to perform an operation of displaying a menu bar and an operation of switching the display of the menu bar can be enhanced. For example, while the user is holding the left end of the first housing 1 (the left end of the first housing 1 shown in FIG. 17 in a direction facing the drawing surface) with the left hand, the user can press the second region 51b with a finger of the right hand. Furthermore, while the user is holding the right end of the first housing 1 with the right hand, the user can press the first region 50a with a finger of the left hand. Thus, the movement amount of a finger and a hand can be reduced during the operation of displaying a menu bar, so that the operability can be enhanced. Furthermore, the movement amount of a finger and a hand can be reduced during the operation of displaying a menu bar irrespective of the dominant hand of the user, so that the operability can be enhanced.

The matrix switch in the first region 50a or the second region 50b may be assigned different functions instead of the same function. For example, the execution of the commands in various application programs may be designated by pressing the first region 50a, and the cancellation of the execution in various application programs or the display of a sub-menu may be designated by pressing the second region 50b.

Furthermore, the operation region for displaying a menu bar (described later) may be at least one of the first region 50a and the second region 50b. Furthermore, at least one of the marks 51a and 51b may be indicated depending upon whether the first region 50a or the second region 50b is provided.

The third region 50c refers to a region in which various operations in a menu bar can be performed while a menu bar (described later) is being displayed on the display 4. A specific operation method will be described later.

### 3. Display Operation of a Menu Bar

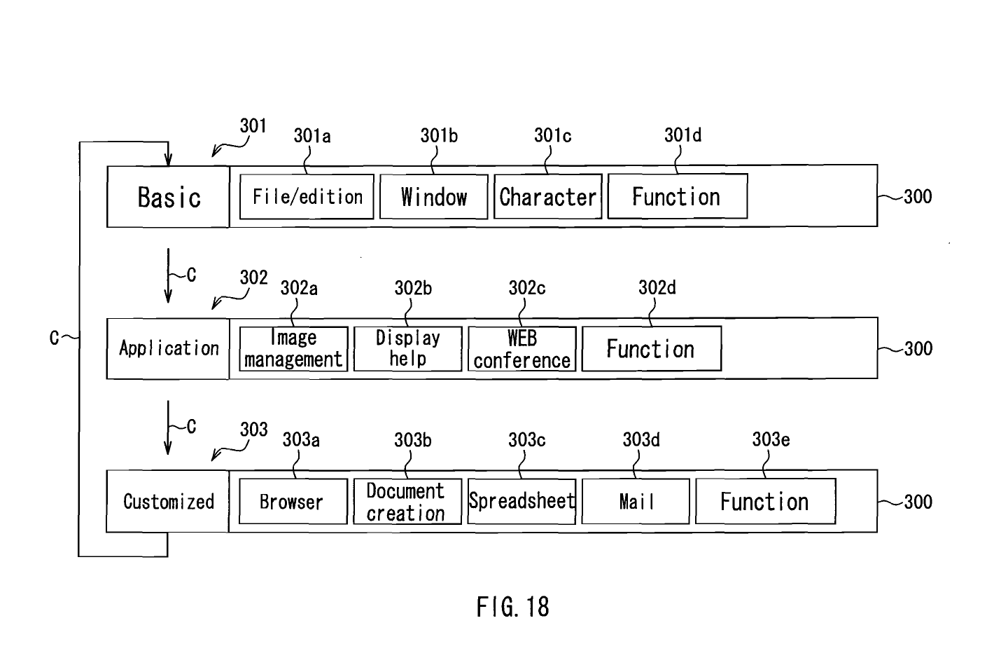

FIG. 18 is a schematic view showing display contents of a menu bar. Menu bars 301 to 303 shown in FIG. 18 can be displayed in a part of the display 4. The menu bars 301 to 303 are displayed in the vicinity of a lower side of the display 4 (a side closest to the first housing 1 among four sides of an effective display area of the display 4 in a substantially rectangular shape).

The menu bar 300 has three display patterns: a first menu bar 301, a second menu bar 302, and a third menu bar 303 shown in FIG. 18, and any one of them is displayed on the display 4 selectively. The three display patterns shown in FIG. 18 can be switched arbitrarily by pressing the first region 50a or the second region 50b in the operation region 50. In the present embodiment, although the menu bar 300 includes three kinds, two or more kinds of menu bars may be displayed selectively.

The first menu bar 301 displays a basic menu. The basic menu includes a sub-menu enabling the shift to various modes such as a file/edition mode, a window mode, a character mode, and a function mode. The file/edition mode is capable of performing various operations of a file such as copying and pasting of a file. The selection of an icon 301a enables the shift to the file/edition mode. The window mode is capable of switching application software that is being activated, and performing various operations regarding a window displayed on a display panel 42, such as maximizing or minimizing the size of the window displayed on the display panel 42. The selection of the icon 301b enables the shift to the window mode. The character mode is capable of selecting the kinds of characters (Japanese cursive syllabary, Japanese square syllabary, alphanumeric characters, etc.) to be displayed on the display panel 42 when the keyboard 6 is operated by the user. The selection of the icon 301c enables the shift to the character mode. The function mode is capable of adjusting the brightness of a backlight of the display panel 42, adjusting the volume of a speaker 21, and the like. The selection of an icon 301d enables the shift to the function mode.

The second menu bar 302 displays an application menu. The application menu includes a sub-menu enabling the shift to various modes such as an image management mode, a display help mode, a WEB conference mode, and a function mode. The image management mode is capable of executing an application program that can manage image files stored in an HDD 14, a memory card (not shown), or the like. The selection of an icon 302a enables the shift to the image management mode. The display help mode is capable of realizing the enhancement of efficiency of an operation, such as a collective movement of a plurality of windows to an external monitor. The selection of an icon 302b enables the shift to the display help mode. The WEB conference mode is capable of connecting a notebook PC to a network conference system via a network interface 17. The selection of an icon 302c enables the shift to the WEB conference mode. The function mode is capable of adjusting the brightness of a backlight of the display panel 42, adjusting the volume of a speaker 21, and the like. The selection of an icon 302d enables the shift to the function mode.

The third menu bar 303 displays a customizing menu. The customizing menu includes a sub-menu enabling the shift to various modes such as a browser mode, a document creating mode, a spreadsheet program mode, a mail mode, and a function mode. The browser mode is capable of activating browser software capable of displaying a web page. The selection of an icon 303a enables the shift to the browser mode. The document creating mode is capable of activating document creating software. The selection of an icon 303b enables the shift to the document creating mode. The spreadsheet program mode is capable of activating spreadsheet software. The selection of an icon 303c enables the shift to the spreadsheet program mode. The mail mode is capable of activating electronic mail software. The selection of an icon 303d enables the shift to a mail mode. The function mode is capable of adjusting the brightness of a backlight of the display panel 42, adjusting the volume of a speaker 21, and the like. The selection of an icon 303e enables the shift to the function mode.

The kinds of the menu bar 300 (basic menu, application menu, customizing menu) are examples. Furthermore, the contents of the sub-menus included in the basic menu, the application menu, and the customizing menu are examples.

Hereinafter, a method for displaying the menu bar 300 will be described.

The menu bar 300 is not displayed on the display panel 42 at a time when a particular operation is not performed, such as a time immediately after the activation of an OS. With such a configuration, when an operation such as document creation is performed in a notebook PC, an operation region displayed on the display panel 42 can be kept large, which can enhance the operation efficiency. In the present embodiment, although the menu bar 300 is not displayed on the display panel 42 when a particular operation is not performed, it may be displayed on the display panel 42 at all times. Furthermore, the menu bar 300 may be displayed on the display panel 42 as an icon when it is not displayed on the display panel 42.

The user can display the menu bar 300 on the display panel 42 by pressing the first region 50a or the second region 50b in the operation region 50. Specifically, when detecting that the first region 50a or the second region 50b in the operation region 50 of the touch sensor 53 is pressed by the user, the operation detecting portion 54 (see FIG. 2) sends a detection signal to a CPU 11. When receiving the detection signal from the operation detecting portion 54, the CPU 11 sends a command for displaying the menu bar 300 to a display control portion 41. The display control portion 41 causes the menu bar 300 shown in FIG. 18 to be displayed on the display panel 42 based on the command sent from the CPU 11.

In the present embodiment, when the first region 50a or the second region 50b is pressed by the user, the basic menu shown in FIG. 18 is displayed at all times. However, the present invention is not limited thereto. For example, the display contents of the menu bar 300 at a time when the display of the menu bar 300 is deleted are memorized, and when the first region 50a or the second region 50b is pressed by the user, the memorized display contents may be displayed in the menu bar 300. That is, in the case where the display of the menu bar 300 is deleted while the application menu is being displayed, the application menu may be displayed when the menu bar 300 is displayed next. With such a configuration, the previous operation can be restarted rapidly, which can enhance the operability.

Furthermore, the number of selections or the cumulative display time of each of the basic menu, the application menu, and the customizing menu is counted, and a menu with a high use frequency may be displayed preferentially. That is, a menu with the largest number of selections or a menu with the longest cumulative display time is displayed preferentially. With such a configuration, a menu with a high use frequency can be displayed preferentially at an activation of a notebook PC, which can enhance the operability.

Furthermore, the user arbitrarily may select the contents of the menu bar 300 to be displayed initially. With such a configuration, for example, the user can set a menu with a high use frequency as the menu bar 300 to be displayed initially. The “initial display” refers to the display contents of the menu bar 300 displayed at a time when the first region 50a or the second region 50b is pressed while the menu bar 300 is not being displayed on the display 4. Furthermore, the “initial display” contains the display contents of the menu bar 300 to be displayed initially at an activation of the notebook PC in the case where the “initial display” is set so as to be displayed on the display 4 at all times.

When the first region 50a or the second region 50b in the operation region 50 is pressed while the basic menu 301 shown in FIG. 18 is being displayed in the menu bar 300, the CPU 11 sends a command for switching the display of the menu bar 300 to the display control portion 41. The display control portion 41 causes the menu bar 300 displayed on the display panel 42 to be switched from the basic menu 301 to the application menu 302 as indicated by an arrow C based on the command from the CPU 11.

When the first region 50a or the second region 50b in the operation region 50 is pressed while the application menu 302 is being displayed in the menu bar 300, the CPU 11 sends a command for switching the display of the menu bar 300 to the display control portion 41. The display control portion 41 causes the menu bar 300 displayed on the display panel 42 to be switched from the application menu 302 to the customizing menu 303 as indicted by the arrow C based on the command from the CPU 11.

When the first region 50a or the second region 50b in the operation region 50 is pressed while the customizing menu 303 is being displayed in the menu bar 300, the CPU 11 sends a command for switching the display of the menu bar 300 to the display control portion 41. The display control portion 41 causes the menu bar 300 displayed on the display panel 42 to be switched from the customizing menu 303 to the basic menu 301 as indicted by the arrow C based on the command from the CPU 11. That is, the menu bar 300 can switch the display repeatedly in the following order: the basic menu 301, the application menu 302, the customizing menu 303, the basic menu 301, . . . as indicated by the arrows C every time the first region 50a or the second region 50b is pressed.

The menu bar 300 can switch the display contents when either one of the first region 50a and the second region 50b is pressed intermittently, and even when the first region 50a and the second region 50b are pressed alternately.

Furthermore, although the menu bar 300 can switch the display contents when either one of the first region 50a and the second region 50b is pressed, the menu bar 300 may switch the display contents when either one of the first region 50a and the second region 50b is slid in the direction indicated by an arrow A or B in FIG. 17. For example, when the first region 50a is slid in the direction indicated by the arrow A in FIG. 17, the display contents of the menu bar 300 may be shifted as indicated by the arrow C in FIG. 18. Furthermore, when the first region 50a is slid in the direction indicated by the arrow B in FIG. 17, the display contents of the menu bar 300 may be shifted in the direction opposite to that indicated by the arrows C (in the order of the customizing menu 303, the application menu 302, the basic menu 301, the customizing menu 301 . . . ).

The display of the menu bar 300 can be deleted by performing a predetermined operation with respect to the first region 50a and the second region 50b. Examples of the “predetermined operation” include pressing either one of the first region 50a and the second region 50b continuously for several seconds (for example, 2 seconds), and pressing the first region 50a and the second region 50b simultaneously.

When an icon included in any of the basic menu 301, the application menu 302, and the customizing menu 303 is selected, the display is switched to a sub-menu or an application program is executed. For example, in the case where the browser icon 303a in the customizing menu 303 is selected, browser software previously installed on the notebook PC is executed to display a browser screen on the display 4. On the other hand, in the case where the file/edition icon 301a in the basic menu 301 is selected, a sub-menu regarding the file/edition icon 301 is displayed. Hereinafter, a sub-menu will be described.

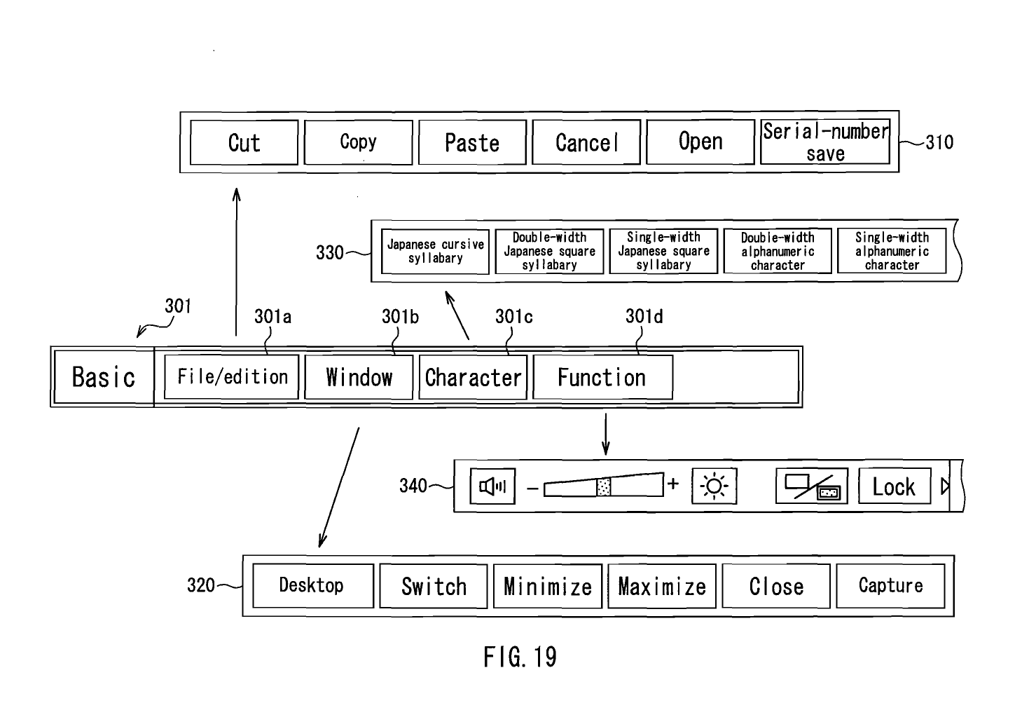

FIG. 19 shows a hierarchical structure of sub-menus included in the basic menu 301. The sub-menu includes icons capable of performing operations corresponding to conventional shortcut keys. The shift to a first sub-menu 310 can be performed by selecting the icon 301a. The first sub-menu 310 includes a cut icon capable of cutting a part of a file or a document, etc., a copy icon capable of copying a part of a file or a document, etc. The first sub-menu 310 can be expanded from a position where the file/edition icon 301a is displayed in the menu bar 300 by selecting the file/edition icon 301a. A second sub-menu 320 includes a switching icon for switching a window selected from a plurality of windows displayed on the display 4, a minimizing icon for minimizing the size of a window, and the like. The second sub-menu 320 is capable of being expanded from a position where the window icon 301b is displayed in the menu bar 300 by selecting the window icon 301b. A third sub-menu 330 includes a Japanese cursive syllabary icon capable of shifting a character input mode to a Japanese cursive syllabary input mode, a double-width Japanese square syllabary icon capable of shifting a character input mode to a mode capable of inputting a double-width Japanese square syllabary, and the like. The third sub-menu 330 is capable of being expanded from a position where the character icon 301c is displayed in the menu bar 300 by selecting the character icon 301c. A fourth sub-menu 340 includes a slide bar capable of adjusting the volume of a voice output from a speaker 21, a slide bar capable of adjusting the brightness of a backlight of the display 4, and the like. The fourth sub-menu 340 is capable of being expanded from a position where the function icon 301d is displayed in the menu bar 300 by selecting the function icon 301d.

Hereinafter, a switching operation of a display from the basic menu 301 to a sub-menu will be described. As an example of the switching operation of a display, an operation will be described in which the icon 301a in the basic menu 301 is selected.

### [3-1. Display Operation of a Sub-Menu]

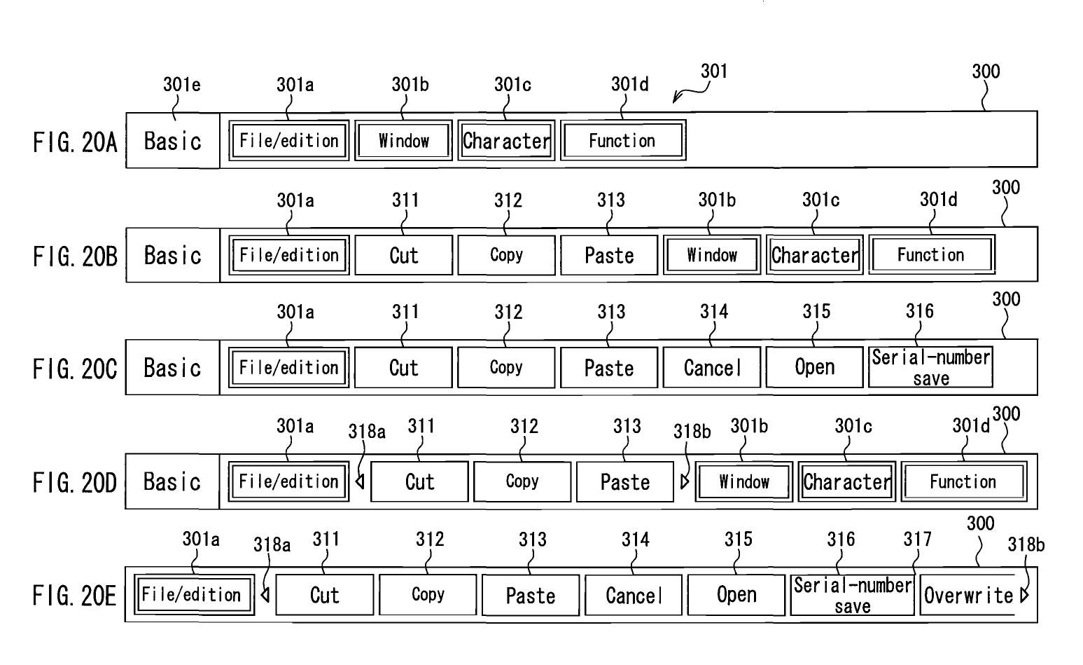

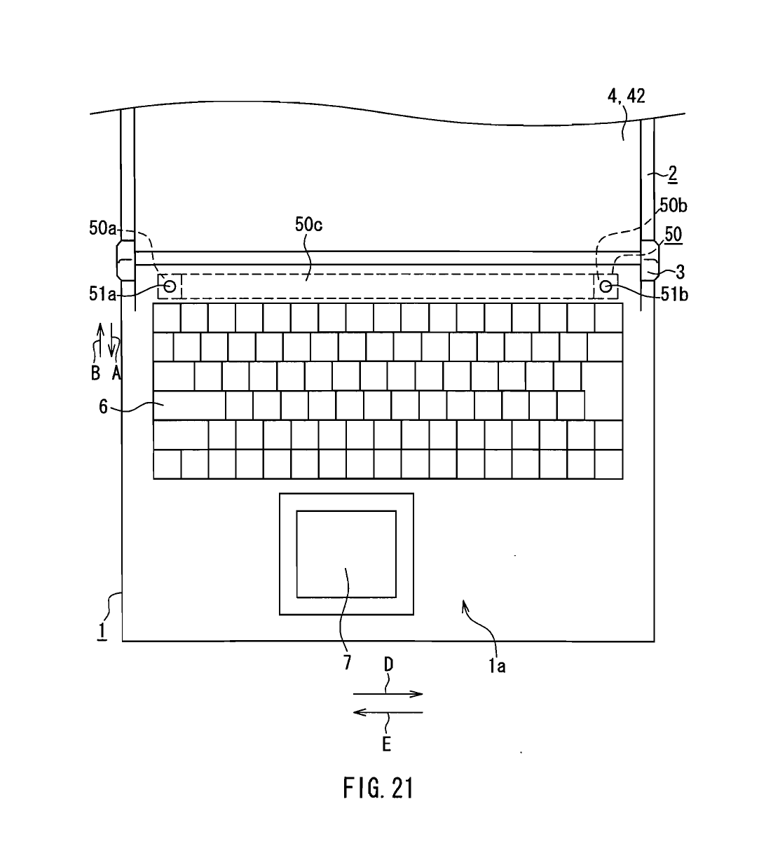

FIG. 20 shows display contents of the menu bar 300. FIG. 20A shows a state in which the basic menu 301 is displayed in the menu bar 300. FIGS. 20B to 20D respectively show a state in which a sub-menu of the file/edition icon 301a is displayed. In the basic menu 301 shown in FIG. 20A, when the file/edition icon 301a is selected, the display is switched to any of FIGS. 20B, 20C, and 20D.

First, FIG. 20 B shows the case where the number of icons included in a sub-menu is small. Specifically, in the case where only three icons: a cut icon 311, a copy icon 312, and a paste icon 313 are included in a sub-menu, the cut icon 311, the copy icon 312, and the paste icon 313 are displayed between the file/edition icon 301a and the window icon 301b, as shown in FIG. 20B. The window icon 301b to the function icon 301d respectively are displayed while being displaced in the right direction in the figure. In the display form shown in FIG. 20B, the icons 301a to 301d, the cut icon 311, the copy icon 312, and the paste icon 313 can be all displayed simultaneously in the menu bar 300. In the example shown in FIG. 20, seven icons can be displayed in the menu bar 300 simultaneously (the width of each icon is fixed to a predetermined value), so that the basic menu 301 including four icons and the sub-menu including three icons can be displayed simultaneously.

On the other hand, FIG. 20C shows the case where the sub-menu includes six icons. More specifically, on the right side of the icon 301a in the figure, the cut icon 311, the copy icon 312, the paste icon 313, a cancel icon 314, an open icon 315, and a serial-number saving icon 316 are displayed adjacent to each other. The icons 301b to 301d are not displayed in the menu bar 300 since the number of icons included in the sub-menu is large. In the example shown in FIG. 20, seven icons can be displayed simultaneously in the menu bar 300, so that the basic menu 301 including four icons and the sub-menu including six icons cannot be displayed simultaneously. Thus, the display is performed with the display of the icons included in the basic menu 301 deleted. With such a display form, all the icons included in the sub-menu can be displayed simultaneously. Thus, the user can select a desired icon easily from the icons included in the sub-menu.

FIG. 20D shows the case where the sub-menu includes six or more icons. In the display form shown in FIG. 20D, a part (three in the present example) of icons among six icons included in the sub-menu and the icons 301b to 301d are displayed A part of the six icons included in the sub-menu is displayed between the icon 301a and the icon 301b. A triangle mark 318a directed to the left in the figure is displayed between the icon 301a and the cut icon 311, and a triangle mark 318b directed to the right in the figure is displayed between the paste icon 313 and the icon 301b. The triangle marks 318a and 318b show that a scroll display can be performed in the directions indicated by the marks. When the icons in the sub-menu are displayed by scrolling, the operation region 50 corresponding to the icons in the sub-menu is slid in the direction indicated by the arrow D or E (see FIG. 17). By the sliding operation, the icons hidden in the display shown in FIG. 20D are displayed, and the icons displayed in FIG. 20D can be hidden instead. With such a display form, while all the icons included in the basic menu 301 are being displayed simultaneously, the icons included in the sub-menu can be displayed selectively.

FIG. 20E also shows the case where the sub-menu includes six or more icons. More specifically, the icon 301a is displayed at a position where a title 301e in the basic menu 301 is displayed in FIG. 20A. More specifically, the display of the title 301e is deleted, and the icon 301a is displayed. The cut icon 311, the copy icon 312, the paste icon 313, the delete icon 314, the open icon 315, the serial-number saving icon 316, an overwrite storing icon 317, and the like are displayed adjacent to each other on the right side of the icon 301a in the figure. The triangle mark 318a directed to the left in the figure is displayed between the icon 301a and the cut icon 311. The triangle mark 318b directed to the right in the figure is displayed at a right end of the menu bar 300. As shown in FIG. 20E, in the case where the sub-menu includes seven or more icons, all the icons included in the sub-menu cannot be displayed simultaneously since the display area of the menu bar 300 is limited. In such a case, a part of the icons included in the sub-menu is displayed, and the icons included in the sub-menu are displayed by scrolling, whereby the icons included in the sub-menu can be displayed selectively. When the icons in the sub-menu are displayed by scrolling, the operation region 50 corresponding to the icons in the sub-menu is slid in the direction indicated by the arrow D or E (see FIG. 17). By performing the slide operation, the icons hidden in the display shown in FIG. 20E are displayed and the icons displayed in FIG. 20E can be hidden instead. With such a display form, even in the case where the number of icons included in the sub-menu is large, all the icons can be displayed selectively. In the display form shown in FIG. 20E, although the title icon 301e is not displayed, the user selects the file/edition icon 301a, being aware that the file/edition icon 301a is included in the basic menu 301, so that no confusion is caused in the user.

As described above, the display form of a sub-menu can be varied depending upon the number of icons included in the sub-menu. More specifically, assuming that M represents the number of icons that can be displayed simultaneously, N represents the number of icons included in the basic menu 301 (M>N), and the number of icons included in a sub-menu is S in the menu bar 300, when the number of icons S satisfies:

S≦M−N

the display is performed with a display form shown in FIG. 20. On the other hand, when the number of icons S satisfies:

S>M−N,

the display is performed in a display form shown in FIG. 20C or 20D. Furthermore, when the number of icons S satisfies:

S>M

the display is performed in the display form shown in FIG. 20E.

In the case where the number of icons included in the basic menu 301 is equal to or more than the number of icons that can be displayed simultaneously in the menu bar 300 (i.e., M≦N), the display form can be switched in the same manner as the above. In the case where the number of icons included in the basic menu 301 is larger than the number of icons that can be displayed simultaneously in the menu bar 300 (M<N), a part of the icons that already have been included in the basic menu is not displayed while the basic menu 301 is being displayed as shown in FIG. 20A. In such a case, it is preferred that the icons can be displayed by scrolling, since all the icons can be displayed selectively. In the case where the number of icons included in the basic menu 301 is equal to the number of icons that can be displayed simultaneously in the menu bar 300 (M=N), while the basic menu 301 is being displayed as shown in FIG. 20A, all the icons included in the basic menu 300 can be displayed; however, a part of the icons included in the basic menu 301 will not be displayed when a sub-menu including at least one icon is displayed in the sub-menu. Even in such a case, all the icons can be displayed selectively by a display form in which the icons can be displayed by scrolling, so that such a display form is preferred.

### 4. Effects of an Embodiment, Etc.

According to the present embodiment, the functions of shortcut keys are classified, and a sub-menu can be displayed and selected for each classification, whereby a shortcut key registered in the sub-menu can be selected in a small operation procedure. Thus, the operability can be enhanced.

Furthermore, a sub-menu can be operated in the operation region 50 placed in the vicinity of the keyboard 6 in the first housing 1, whereby the sub-menu can be operated by the same operation as that of the keyboard 6, which can enhance the operability. Furthermore, it is not necessary to operate a mouse for operating a sub-menu, so that the user does not need to detach the hand from the keyboard largely, which can enhance the operability.

Furthermore, as shown in FIG. 20E, in the case where the number of icons in a sub-menu is large, the icons in the basic menu 301 are displayed in place of the display of the title 301e such as the basic menu 301, whereby the icon display area in the menu bar 300 can be enlarged, and a maximum possible number of icons can be displayed.

Furthermore, in the case where the number of icons included in one menu bar is large, and all the icons cannot be displayed simultaneously, only some of the icons are displayed, and a sub-menu is allowed to be scrolled. With such a configuration, the icons that have not been displayed originally can be shifted to a state in which the icons can be displayed.

Furthermore, since the operation region 50 is provided independently from the display 4, the display 4 can be prevented from being contaminated, compared with the configuration in which a touch panel is provided on the display 4. More specifically, in the present embodiment, since the user does not touch the display surface of the display 4, the contamination of the display 4 can be prevented.

Furthermore, the operation region 50 is placed at a position dose to the display 4 in the first housing 1, whereby a sense of integration with the contents displayed on the display 4 can be enhanced when an interlocked display with respect to the display 4 is performed, which can enhance the visibility.

Furthermore, the operation region 50 is placed in an upper portion of the keyboard 6 (a portion between the keyboard 6 and the second housing 2) as shown in FIG. 17, whereby the operability comparable to that of the keyboard operation can be realized.

The position of the operation region 50 is not limited to that shown in FIGS. 1 and 17, and for example, the operation region 50 may be placed adjacent to the keyboard 6 on the left or right side in a direction facing the drawing surface in FIG. 17 so as to have a longitudinal direction in the vertical direction. Furthermore, the operation region 50 may be placed adjacent to the pointing device 7 on the lower side in a direction facing the drawing surface in FIG. 17 so as to have a longitudinal direction in the horizontal direction. The arrangement shown in FIGS. 1 and 17 is most preferred.

Furthermore, the operation region 50 may be placed in the second housing 2 instead of the first housing 1. In the case where the operation region 50 is placed in the second housing 2, it is preferred that the operation region 50 is placed at a position as close to the menu bar 300 as possible, such as a position in the vicinity of rotation shaft of the first housing 1 and the second housing 2.

In the present embodiment, the operation of switching the display of the menu bar shown in FIG. 18 can be performed by clicking the operation region 50 corresponding to the menu bar mark 100a or dragging the operation region 50 in the direction indicated by the arrow A or B. However, a hard key configuration may be used instead of such a soft key configuration. Examples of the hard key configuration include the configuration in which dedicated operation portions (a button, a wheel, etc.) for switching the display of the menu bar is provided in the first housing 1, the configuration in which the operation can be performed using a cursor key on the keyboard 6, the configuration in which a dedicated region for switching the menu bar is provided on the operation surface of the pointing device 7, and the configuration in which the display of the menu bar is switched, interlocked with the rotation of a wheel provided at a mouse connected to a USB terminal in the interface 15.

Furthermore, icons displayed in the menu bar in the present embodiment may be changed arbitrarily by the user. Examples of the contents to be changed include the deletion of icons registered as a default (at a time of shipping of a notebook PC), the additional registration of other icons, and the change in position of the registered icons. As a method for changing an icon, there is a method in which an icon setting screen is displayed on a display, and an icon can be added, deleted, or changed in position on the icon setting screen. Furthermore, there also is a method in which an icon desired to be added is moved by dragging to an arbitrary position on the menu bar and is added by dropping, a registered icon is excluded out of the menu bar by dragging and dropping, and a registered icon is changed in position by dragging and dropping. In the case of adding an icon by dragging and dropping, the icon can be added with the pointing derive 7, a mouse connected to the interface 15, or the like.

Furthermore, the icons included in the basic menu 301, the application menu 302, and the customizing menu 303 respectively can be changed in arrangement order depending upon the use frequency of the icons. For example, in the case where the use frequency of the icon 301c among those included in the basic menu 301 is higher than the use frequency of the icon 301a, the arrangement order can be changed in such a manner that the icon 301c is displayed at a left end of the menu bar 300 in the figure (adjacent to the title 301e on the right side), and the icon 301a is displayed adjacent to the icon 301c on the right side. An icon with a high use frequency can be displayed at a closer position by allowing the arrangement order of the icons to be changed depending upon the use frequency. Thus, a small amount of a movement of a finger of the user for selecting an icon by operating the operation region 50 suffices, which can enhance the operability. Regarding the icons included in a sub-menu, the arrangement order can be changed depending upon the use frequency.

Furthermore, the icons included in the basic menu 301, the application menu 302, and the customizing menu 303 respectively are set to have the same width. However, the width can be changed depending upon the number of characters and the size of graphics indicated in each icon. For example, regarding the “character” of the icon 301c shown in FIG. 18, the number of characters indicated in the icon is smaller, compared with that of the “file/edition” of the icon 301a. Therefore, it is preferred that the width of the icon 301c is smaller than that of the icon 301a. Thus, in the case where the number of characters to be indicated in an icon is small and the case where the graphics indicated in an icon are small, the width of the icon is reduced, whereby the number of icons that can be displayed simultaneously in the menu bar 300 can be increased compared with the case where all the widths of the icons are the same. This can enhance the operability. The width of the icon may be changed automatically on the device side depending upon the number of characters to be indicated, or the user may change the width of the icon arbitrarily. Furthermore, the height of the icon may be changed instead of the width thereof.

Furthermore, the information processing unit of the present invention is not limited to a notebook PC as in the present embodiment. The present invention is useful as long as it is an appliance on which at least a GUI (Graphical User Interface) such as a menu bar can be mounted. Application examples of the present invention include a desktop personal computer, a PDA (Personal Digital Assistance), a mobile telephone terminal a game machine, and a medical appliance.

Particularly, the present invention is useful for an appliance having a display portion whose size is limited, such as a stationary DVD recorder (a display portion mounted on a front panel), an electronic photostand, a car navigation system, and a dock radio. In such an appliance, a display portion to be mounted is small so that the amount of information that can be displayed is limited; however, a large amount of information can be displayed in a display form as in the present embodiment.

Furthermore, the display 4 in the present embodiment is one example of the first display unit of the present invention. The operation region 50 and the touch sensor 53 in the present embodiment are examples of the operation unit of the present invention. The configurations, which cause the display 4 or the display panel 42 to display an image, such as the CPU 11, the RAM 12, and the display control portion 41 in the present embodiment, are examples of the display control unit of the present invention. The basic menu 301, the application menu 302, and the customizing menu 303 in the present embodiment are an exemplary group of the present invention. The icons 301a to 301d in the present embodiment are examples of grouped icons in the present invention. The icons 311 to 317 in the present embodiment are examples of related icons in the present invention.

The present invention can be used widely, for example, in an information processing unit that uses a plurality of system environments by switching, without being limited to a portable notebook PC.

Regarding the present embodiment, the following notes will be disclosed.

(Note 1)

An information processing unit that displays icons selected when predetermined processing is designated on a screen of a display unit, including:

a display control unit that causes an icon display area, in which a plurality of the icons related to each other are grouped, to be displayed; and

an operation unit that receives various operations by a user,

wherein, when the operation unit inputs a command for expanding or contracting the icon display area in a one-dimensional direction that is the same as an arrangement direction of the plurality of the icons in the icon display area, the display control unit causes the icon display area, which is being displayed on the screen, to be expanded or contracted in the one-dimensional direction.

(Note 2)

The information processing unit according to Note 1, wherein, when one of the grouped plurality of icons is selected, the display control unit causes the plurality of related icons related to the one icon to be expanded and displayed in the icon display area adjacent to the one icon.

(Note 3)

The information processing unit according to any one of Notes 1 and 2, comprising the grouped plurality of icons in plural kinds, wherein the display control unit selects and displays a group to be displayed in the icon display area.

(Note 4)

The information processing unit according to any one of Notes 1 to 3, wherein the operation unit receives respective operations at positions corresponding to the plurality of the icons displayed in the icon display area.

### Embodiment 3

According to the configuration disclosed by JP 2002-259009, when the number of registered icons increases to increase the number of task bars, the number of rotations of the task bars for searching for a desired icon increases, which takes a long time to find out the desired icon, resulting in the decrease in operability.

Furthermore, there is a demand from the market that the information processing unit has a function capable of changing profiles such as the brightness or the display contents of a display device depending upon a place where an operator operates the information processing unit. In the case of changing profiles in accordance with the operation environment in the configuration disclosed by JP 2002-259009 A, it is necessary to change the profiles, such as the brightness of a display device and the volume of a speaker, by displaying a setting screen for each profile. Thus, changing the profiles is very complicated.

An object of the information processing unit according to Embodiment 3 is to shorten a time for searching for a desired icon to enhance the operability, and set profiles in accordance with the operation environment.

### 1. Configuration of an Information Processing Unit

The information processing unit according to Embodiment 3 can be realized, for example, by a notebook PC. The information processing unit according to Embodiment 3 has a hardware configuration similar to that shown in FIGS. 1 and 2.

### 2. Operation of a Notebook PC by a Touch Sensor

FIG. 21 is a plan view of a notebook PC in the present embodiment, mainly showing a configuration of an upper surface 1a of a first housing 1.

As shown in FIG. 21, an operation region 50 has a substantially rectangular shape. The operation region 50 has a shape with a long side being much larger than a short side. The operation region 50 is placed so that a longitudinal direction thereof is substantially parallel to the long side in the first housing 1. The operation region 50 indicates a part of the upper surface 1a of the first housing 1, corresponding to a region in which the touch sensor 53 (see FIG. 2) is placed inside the first housing 1. That is, when the user presses at least a part of the operation region 50, the matrix switch included in the touch sensor 53 (see FIG. 2) is switched from OFF to ON.

The operation region 50 indicates a region in which the touch sensor 53 (see FIG. 2) is capable of detecting the user's pressing. In the present embodiment, circular marks 51a and 51b are provided at both ends in the longitudinal direction of the operation region 50, whereby the user can be informed of that regions in the vicinity of the circular marks 51a and 51b and a region sandwiched between the circular marks 51a and 51b correspond to the operation region 50.

Although the operation region 50 does not appear in the external appearance of the first housing 1 in the present embodiment, a broken line shown in FIG. 21 is described actually in the first housing 1 with a solid line, or a region corresponding to the operation region 50 on the upper surface 1a of the first housing 1 can be colored. With such a configuration, the user can grasp the position of the operation region 50 easily, which can enhance the operability.

The operation region 50 includes a first region 50a, a second region 50b, and a third region 50c. In portions of the operation surface corresponding to the first region 50a and the second region 50b, the circular marks 51a and 51b are described, respectively. The circular marks 51a and 51b are used for notifying the user of the position of the first region 50a or the second region 50b when the user performs an operation of displaying a menu bar (described later). Although a portion of the operation surface corresponding to the third region 50c is not provided with a mark or the like in the present embodiment, it is preferred to provide a mark or the like for notifying the user that the portion is the operation region.

The matrix switches in the first region 50a and the second region 50b are assigned the same function, respectively. Specifically, the matrix switches in the first region 50a and the second region 50b are assigned a function of displaying a menu bar (described later) on the display 4 and a function of switching the display of the menu bar. The matrix switches in the first region 50a and the second region 50b are assigned the same function, whereby the operability for the user to perform an operation of displaying a menu bar and an operation of switching the display of the menu bar can be enhanced. For example, while the user is holding the left end of the first housing 1 (the left end of the first housing 1 shown in FIG. 21 in a direction facing the drawing surface) with the left hand, the user can press the second region 50b with a finger of the right hand. Furthermore, while the user is holding the right end of the first housing 1 with the right hand, the user can press the first region 50a with a finger of the left hand. Thus, the movement amount of a finger and a hand can be reduced during the operation of displaying a menu bar, so that the operability can be enhanced. Furthermore, the movement amount of a finger and a hand can be reduced during the operation of displaying a menu bar irrespective of the dominant hand of the user, so that the operability can be enhanced.

The matrix switch in the first region 50a or the second region 50b may be assigned different functions instead of the same function. For example, the execution of the commands in various application programs may be designated by pressing the first region 50a, and the cancellation of the execution of various application programs and the display of a sub-menu may be designated by pressing the second region 50b.

Furthermore, the operation region for displaying a menu bar (described later) may be at least one of the first region 50a and the second region 50b. Furthermore, at least one of the marks 51a and 51b may be indicated depending upon whether the first region 50a or the second region 50b is provided.

The third region 50c refers to a region in which various operations in a menu bar can be performed while a menu bar (described later) is being displayed on the display 4. A specific operation method will be described later.

### 3. Display Operation of a Menu Bar

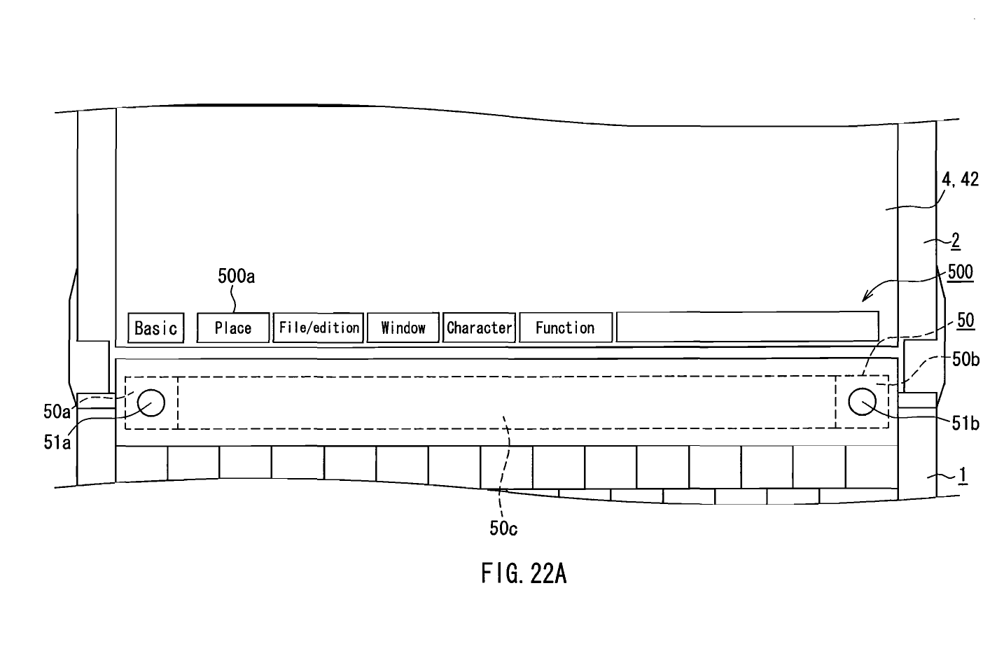

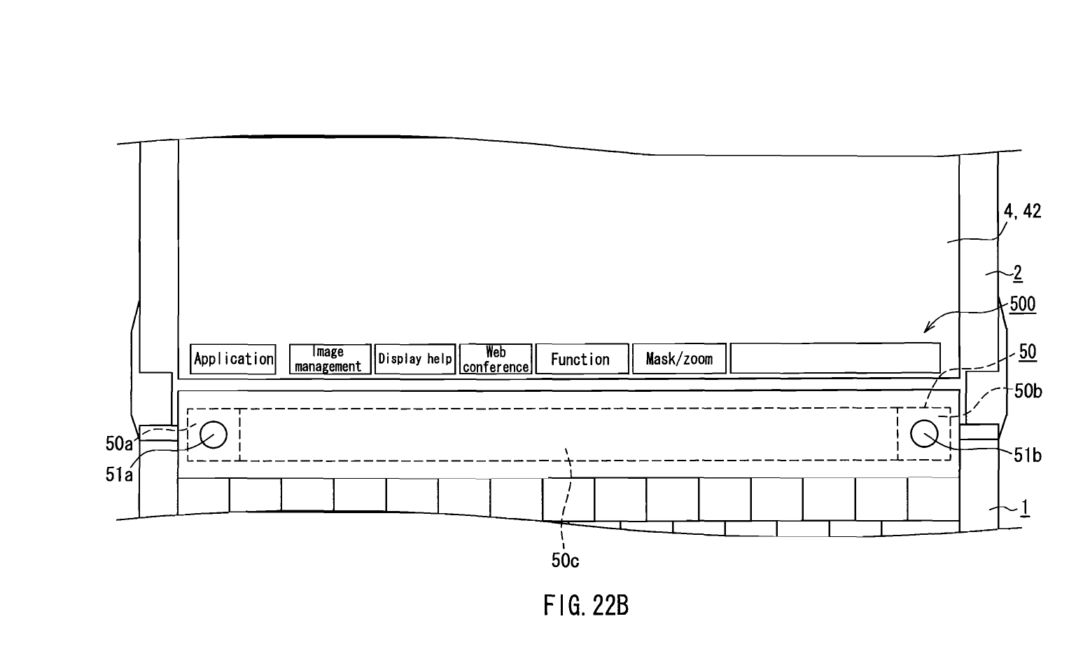

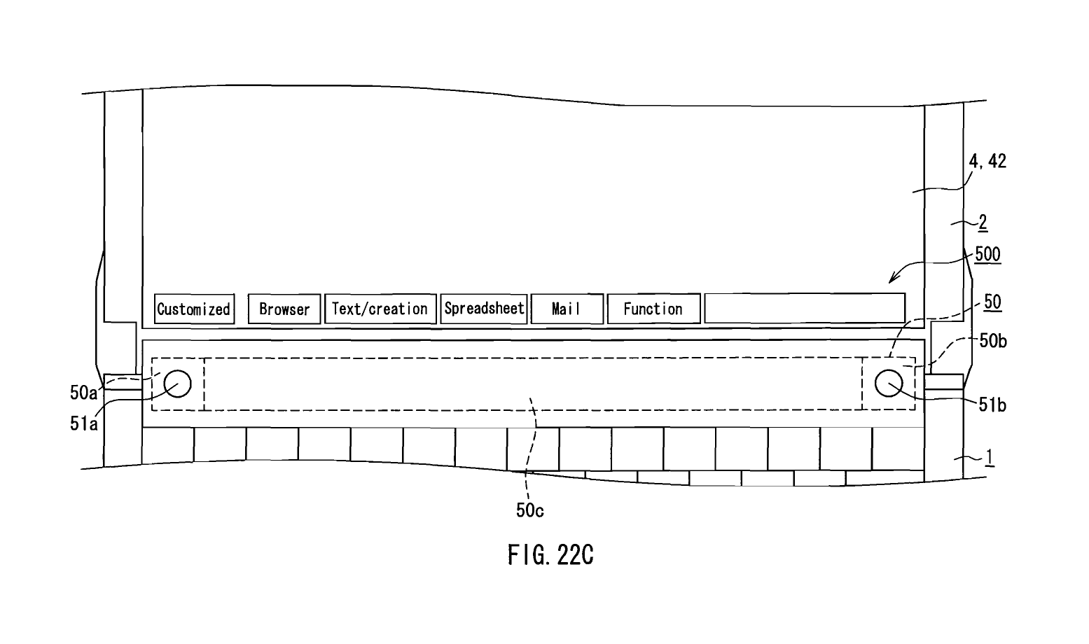

FIGS. 22A to 22C are schematic views showing display contents of a menu bar. FIGS. 22A to 22C show the vicinity of the operation region 50 in the first housing 1, and the vicinity of a long side of the display 1 on the first housing 1 side. As shown in FIGS. 22A to 22C, the notebook PC in the present embodiment can display a menu bar 500 in a part of the display panel 42.

The menu bar 500 has three display patterns shown in FIGS. 22A to 22C. The three display patterns shown in FIGS. 22A to 22C can be switched arbitrarily by pressing the first region 50a or the second region 50b in the operation region 50. In the present embodiment, although the menu bar 500 has three kinds, two or more kinds of menu bars may be displayed selectively.

The menu bar 500 shown in FIG. 22A displays a basic menu. The basic menu includes a sub-menu enabling the shift to various modes such as a place mode, a file/edition mode, a window mode, a character mode, and a function mode. The place mode. The place mode is capable of changing the connection setting of a network, the volume setting of the speaker 21, and the display setting of the display panel 42. The specific operation of the place menu will be described later. The file/edition mode is capable of performing various operations of a file such as copying and pasting of a file. The window mode is capable of switching application software that is being activated, and performing various operations regarding a window displayed on the display panel 42, such as maximizing or minimizing the size of the window displayed on the display panel 42. The character mode is capable of selecting the kinds of characters (Japanese cursive syllabary, Japanese square syllabary, alphameric characters, etc.) to be displayed on the display panel 42 when the keyboard 6 is operated by the user. The function mode is capable of adjusting the brightness of a backlight of the display panel 42, adjusting the volume of the speaker 21, and the like.

The menu bar 500 shown in FIG. 22B displays an application menu. The application menu includes a sub-menu enabling the shift to various modes such as an image management mode, a display help mode, a WEB conference mode, and a function mode. The image management mode is capable of executing an application program that can manage image files stored in an HDD 14, a memory card (not shown), or the like. The display help mode is capable of realizing the enhancement of efficiency of an operation, such as a collective movement of a plurality of windows to an external monitor. The WEB conference mode is capable of connecting a notebook PC to a network conference system via a network interface 17. The function mode is capable of adjusting the brightness of a backlight of the display panel 42, adjusting the volume of the speaker 21, and the like.

The menu bar 500 shown in FIG. 22C displays a customizing menu. The customizing menu includes a sub-menu enabling the shift to various modes such as a browser mode, a document creating mode, a spreadsheet program mode, a mail mode, and a function mode. The browser mode is capable of activating browser software capable of displaying a web page. The document creating mode is capable of activating document creating software. The spreadsheet program mode is capable of activating spreadsheet software. The mail mode is capable of activating electronic mail software. The function mode is capable of adjusting the brightness of a backlight of the display panel 42, adjusting the volume of the speaker 21, and the like.

The kinds of the menu bar 500 (basic menu, application menu, customizing menu) are examples. Furthermore, the contents of the sub-menus included in the basic menu, the application menu, and the customizing menu are examples.

Hereinafter, a method for displaying the menu bar 500 will be described.

The menu bar 500 is not displayed on the display panel 42 at a time when a particular operation is not performed, such as a time immediately after the activation of an OS. With such a configuration, when an operation such as document creation is performed in a notebook PC, an operation region displayed on the display panel 42 can be kept large, which can enhance the operation efficiency. In the present embodiment, although the menu bar 500 is not displayed on the display panel 42 when a particular operation is not performed, it may be displayed on the display panel 42 at all times. Furthermore, the menu bar 500 may be displayed on the display panel 42 as an icon when it is not displayed on the display panel 42.

The user can display the menu bar 500 on the display panel 42 by pressing the first region 50a or the second region 50b in the operation region 50. Specifically, when detecting that the first region 50a or the second region 50b in the operation region 50 of the touch sensor 53 is pressed by the user, the operation detecting portion 54 (see FIG. 2) sends a detection signal to a CPU 11. When receiving the detection signal from the operation detecting portion 54, the CPU 11 sends a command for displaying the menu bar 500 to a display control portion 41. The display control portion 41 causes the menu bar 500 shown in FIG. 22A to be displayed on the display panel 42 based on the command sent from the CPU 11.

In the present embodiment, when the first region 50a or the second region 50b is pressed by the user, the basic menu shown in FIG. 22A is displayed at all times. However, the present invention is not limited thereto. For example, the display contents of the menu bar 500 at a time when the display of the menu bar 500 is deleted are memorized, and when the first region 50a or the second region 50b is pressed by the user, the memorized display contents may be displayed in the menu bar 500. That is, in the case where the display of the menu bar 500 is deleted while the application menu is being displayed, the application menu may be displayed when the menu bar 500 is displayed next.

Furthermore, the user arbitrarily may select the contents of the menu bar 500 to be displayed initially. With such a configuration, for example, the user can set a menu with a high use frequency as the menu bar 500 to be displayed initially.

When the first region 50a or the second region 50b in the operation region 50 is pressed while the basic menu is being displayed as shown in FIG. 22A, the CPU 11 sends a command for switching the display of the menu bar 500 to the display control portion 41. The display control portion 41 causes the menu bar 500 displayed on the display panel 42 to be switched from the basic menu to the application menu (see FIG. 22B) based on the command from the CPU 11.

When the first region 50a or the second region 50b in the operation region 50 is pressed while the application menu is being displayed as shown in FIG. 22B, the CPU 11 sends a command for switching the display of the menu bar 500 to the display control portion 41. The display control portion 41 causes the menu bar 500 displayed on the display panel 42 to be switched from the application menu to the customizing menu (see FIG. 22C) based on the command from the CPU 11.

When the first region 50a or the second region 50b in the operation region 50 is pressed while the customizing menu is being displayed as shown in FIG. 22C, the CPU 11 sends a command for switching the display of the menu bar 500 to the display control portion 41. The display control portion 41 causes the menu bar 500 displayed on the display panel 42 to be switched from the customizing menu to the basic menu (see FIG. 22A) based on the command from the CPU 11.

That is, the display can be switched repeatedly in the following order: the basic menu, the application menu, and the customizing menu every time the first region 50a or the second region 50b is pressed.

The menu bar 500 can switch the display contents when either one of the first region 50a and the second region 50b is pressed intermittently, and even when the first region 50a and the second region 50b are pressed alternately.

The display of the menu bar 500 can be deleted by performing a predetermined operation with respect to the first region 50a and the second region 50b. Examples of the “predetermined operation” include pressing either one of the first region 50a and the second region 50b continuously for several seconds (for example, 2 seconds), and pressing the first region 50a and the second region 50b simultaneously.

### 4. Operation of a Place Mode

Hereinafter, the operation when a place button 500a in the basic menu shown in FIG. 22A is selected will be described.

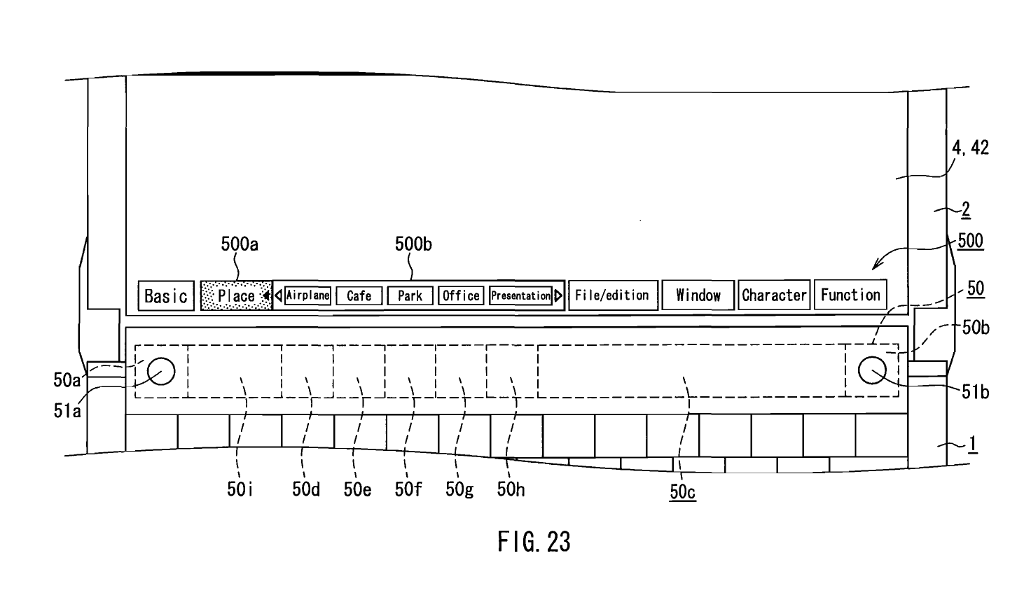

FIG. 23 shows display contents of the menu bar 500 when a site corresponding to the place button 500a in the operation region 50 is pressed while the basic menu is being displayed on the display panel 42. More specifically, FIG. 23 shows the display contents of the menu bar 50 when a notebook PC is shifted to the place mode.

The place mode refers to a mode in which, when one of a plurality of previously set place species is selected, the state of a network connection in a notebook PC, the volume of the speaker 21, and the brightness level of the display panel 42 are set. The state of the network connection includes two states: an ON state and an OFF state. When the network connection is in an ON state, the network connection has two states: a LAN connection and a WAN connection. The volume of the speaker 21 is digitized in a range of 0 to 10, and “0” indicates that a voice output is in an OFF state and “10” indicates the maximum volume. The brightness level of the display panel 42 is digitized in a range of 1 to 10, and “1” indicates a minimum brightness and “10” indicates a maximum brightness.

In the present embodiment, the place species include five kinds: an “airplane”, a “café”, a “park”, an “office”, and a “presentation”. The setting contents of the “airplane” are effective in the case of using a notebook PC in a place that is a relatively small space where others are present in the surrounding, such as the inside of an airplane and the inside of a train. The setting contents of the “café” are effective in the case of using a notebook PC in a place that is a relatively large space where others are present in the surrounding, such as the inside of a restaurant and the inside of a café. The setting contents of the “park” are effective in the case of using a notebook PC outdoors. The setting contents of the “office” are effective in the case of using a notebook PC in an indoor office. The setting contents of the “presentation” are effective when a presentation is performed with a notebook PC or a notebook PC connected to a projector device.

In the case where a site corresponding to the place button 500a in the operation region 50 is pressed, the operation detecting portion 54 (see FIG. 2) sends a detection signal to the CPU 11. When receiving the detection signal from the operation detecting portion 54, the CPU 11 (see FIG. 2) sends a command for displaying a place species menu to the display control portion 41 (see FIG. 2). When receiving the command from the CPU 11, the display control portion 41 causes the display panel 42 to display a place species menu 500b in a lower layer of the place button 500a, as shown in FIG. 23. In the place species menu 500b, buttons indicating various place species such as the “airplane”, the “café”, the “park”, the “office”, and the “presentation” are displayed.

In the display shown in FIG. 23, desired place species can be selected by operating a third region 50c corresponding to the desired place species. For example, by pressing a fourth region 50d that is a part of the third region 50c, the “airplane” in the place species menu 500b can be selected.

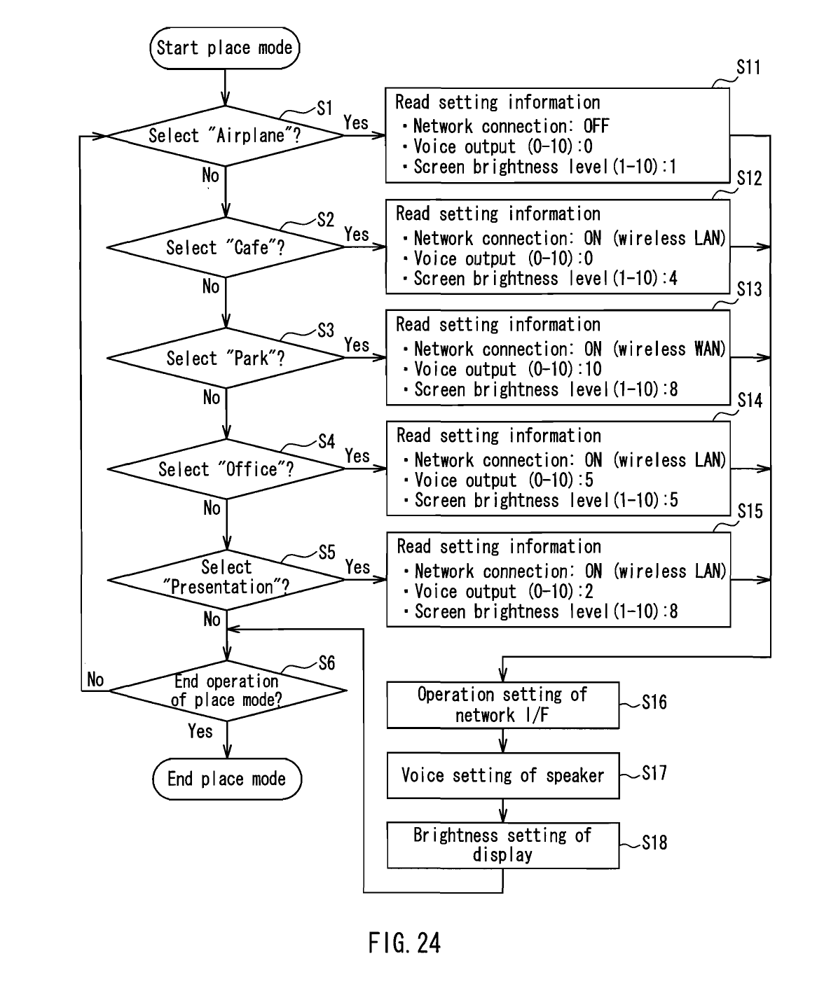

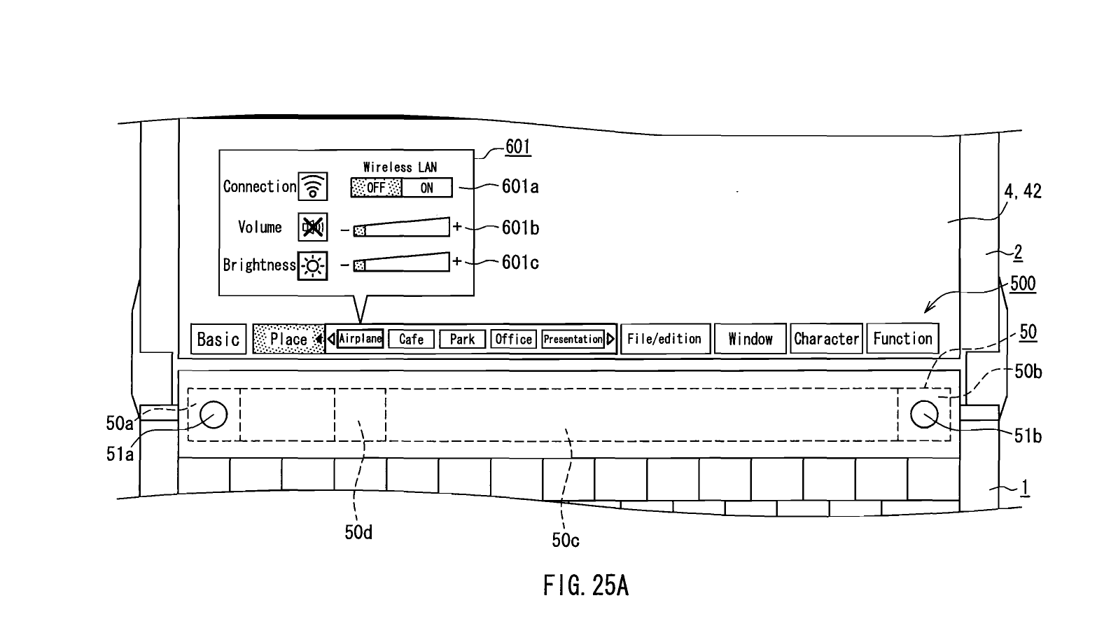

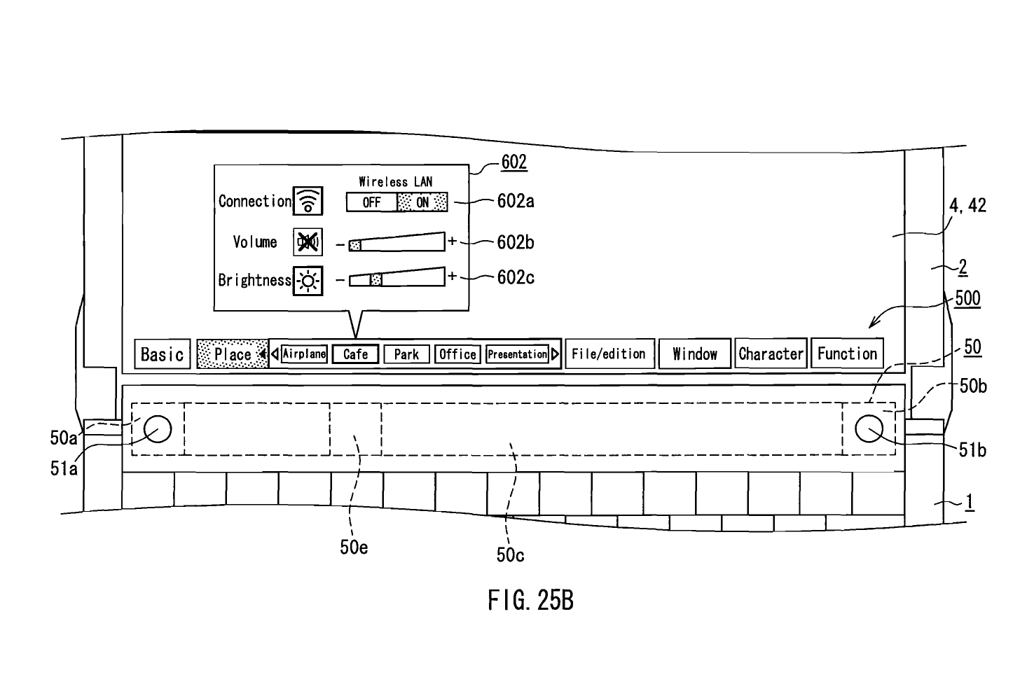

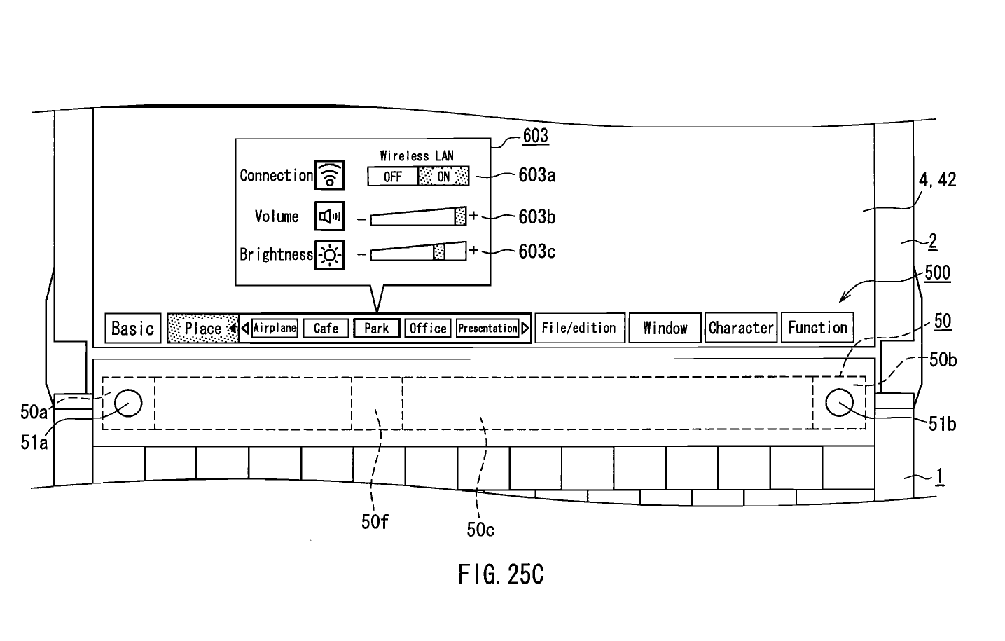

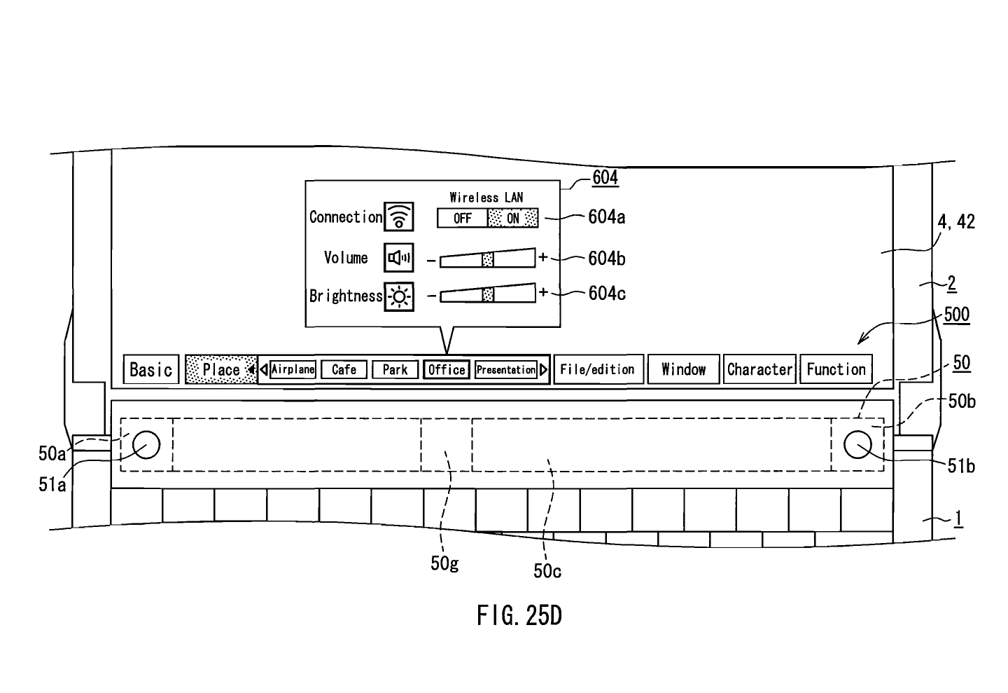

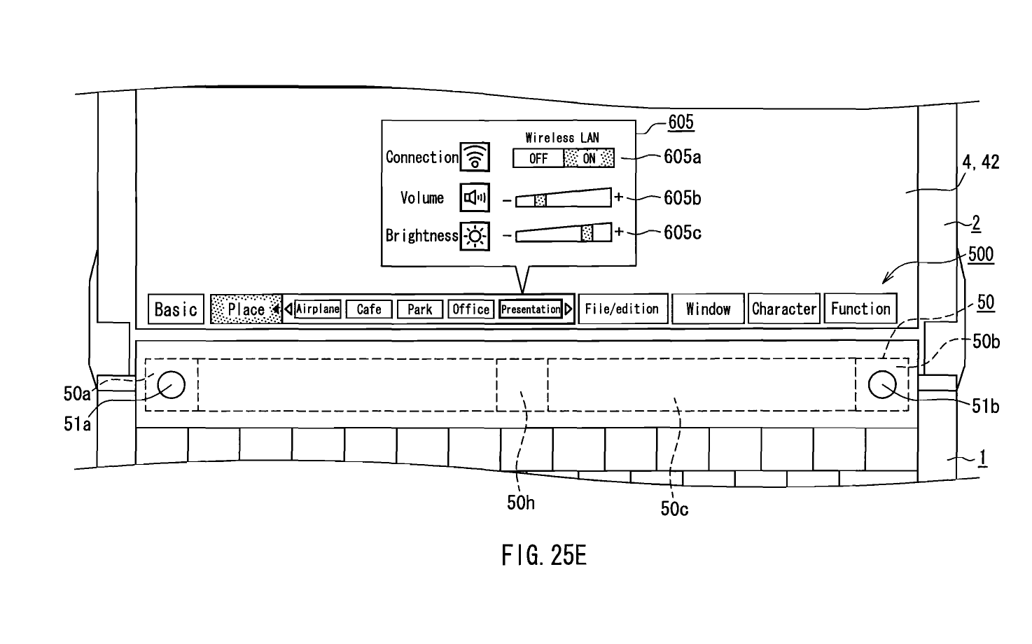

FIG. 24 shows an operation flow in the place mode. FIG. 25A shows display contents when the “airplane” in the place species menu 500b is selected. FIG. 25B shows display contents when the “café” in the place species menu 500b is selected FIG. 25C shows display contents when the “park” in the place species menu 500b is selected. FIG. 25D shows display contents when the “office” in the place species menu 500b is selected. FIG. 25E shows display contents when the “presentation” in the place species menu 500b is selected.

[4-1. Case where the “Airplane” is Selected]

When the operation detecting portion 54 (see FIG. 2) detects that the fourth region 50d shown in FIG. 23 is pressed (YES in S1), the CPU 11 determines that the “airplane” in the menu bar 500 is selected, and reads first setting information stored in the HDD 14 (S11).

The first setting information corresponds to the place species “airplane”, and the network connection is set to be “OFF”, the volume of the speaker 21 is set to be “0”, and the brightness level of the display panel 42 is set to be “1”. More specifically, since the network connection may adversely influence measuring instruments inside an airplane or the like, it is preferred that the setting of the network connection is set to be OFF. In an environment in which a network is permitted in an airplane such as an in-flight LAN using a satellite, the in-flight LAN can be connected by changing the connection setting of the network from OFF to ON. A method for changing the network connection setting will be described later. Furthermore, when a voice is output from the speaker 21 or the backlight of the display panel 42 is too bright inside an airplane or the like, the nearby people may be annoyed. Therefore, it is preferred to set the speaker volume to be 0 and to lower the brightness level of the display panel 42.

When determining that the “airplane” is selected in the menu bar 500, the CPU 11 sends a command for displaying a setting information window 601 shown in FIG. 25A to the display control portion 41. The display control portion 41 causes the display panel 42 to display the setting information window 601 based on the command from the CPU 11. The setting information window 601 displays setting information 601a of the network connection, setting information 601b of a speaker volume, and setting information 601c of the brightness level of the display panel 42. Each setting information is displayed by an icon as well as an ON/OFF display or a level meter.

The CPU 11 outputs a command for displaying the setting information window 601 to the display panel 42, and causes the network interface 17 to be placed in an OFF state (S16), and instructs the voice output control portion 20 to set the volume of the speaker 21 to be “0” (S17) and instructs the display control portion 41 to set the brightness level of the display panel 42 to be “1” (S18). The network interface 17 is placed in an OFF state by the control from the CPU 11. The voice output control portion 20 prevents the speaker 21 from outputting a voice based on the command from the CPU 11. The display control portion 41 adjusts the lightness of the backlight of the display panel 42 to the lightness (minimum brightness) corresponding to a brightness level “1” based on the command from the CPU 11.

[4-2. Case where the “Café” is Selected]

When the operation detecting portion 54 (see FIG. 2) detects that a fifth region 50e shown in FIG. 23 is pressed (YES in S2), the CPU 11 determines that the “café” in the menu bar 500 is selected and reads second setting information stored in the HDD 14 (S12).

The second setting information corresponds to the place species “café”, and the network connection is set to be “ON (wireless LAN)”, the volume of the speaker 21 is set to be “0”, and the brightness level of the display 4 is set to be “4”. More specifically, an access point of a wireless LAN may be set inside a café or the like, and a LAN can be connected through wireless communication by setting the network connection to be ON. Furthermore, when a voice is output from the speaker 21 inside the café or the like, the nearby people may be annoyed. Therefore, it is preferred to set the speaker volume to be 0. Furthermore, there is a high possibility that the environmental illumination is lower inside the café or the like, compared with the outdoor environmental illumination in the daytime; therefore, it is preferred to set the brightness of the backlight of the display panel 42 to be lower since the feeling of fatigue to the eye of the user is alleviated.

When determining that the “café” in the menu bar 500 is selected, the CPU 11 sends a command for displaying a setting information window 602 shown in FIG. 25B to the display control portion 41. The display control portion 41 causes the display panel 42 to display the setting information window 602 based on the command from the CPU 11. The setting information window 602 displays setting information 602a on a network connection, setting information 602b on a speaker volume, and setting information 602c on the brightness level of the display panel 42. Each setting information is displayed by an icon as well as an ON/OFF display or a level meter.

The CPU 11 outputs a command for displaying the setting information window 602 to the display panel 42 and causes the network interface 17 to be placed in an ON state (wireless LAN) (S16), and instructs the voice output control portion 20 to set the volume of the speaker 21 to be “0” (S17) and instructs the display control portion 41 to set the brightness level of the display panel 42 to be “4” (S18). The network interface 17 is placed in an “ON state” by the control from the CPU 11, and is placed in a state connectable to the LAN through wireless communication. The voice output control portion 20 prevents the speaker 21 from outputting a voice based on the command from the CPU 11. Based on the command from the CPU 11, the display control portion 41 adjusts the lightness of the backlight of the display panel 42 to the lightness corresponding to the brightness level “4”.

[4-3. Case where the “Park” is Selected]

When the operation detecting portion 54 (see FIG. 2) detects that a sixth region 50f shown in FIG. 23 is pressed (YES in S3), the CPU 11 determines that the “park” in the menu bar 500 is selected and reads third setting information stored in the HDD 14 (S13). The third setting information corresponds to the place species “park”, and the network connection is set to be “ON (wireless WAN)”, the volume of the speaker 21 is set to be “10”, and the brightness level of the display panel 42 is set to be “8”. More specifically, a WAN may be connected through wireless communication in an outdoor place such as the park, and the WAN can be connected by setting the network connection to be ON. Furthermore, since there are few other people in the surrounding in an outdoor place such as the park, even if a voice is output from the speaker 21, the nearby people may not be annoyed. Furthermore, in an outdoor place such as the park, it may be difficult to hear the voice output from the speaker 21 due to the surrounding environmental sound (traveling sound of automobiles, etc.), so that it is preferred to maximize the volume of the speaker 21. Furthermore, in the outdoor place such as the park (in the daytime), the surrounding environmental illumination is sufficiently high. Therefore, it is preferred to set the brightness level of the backlight of the display panel 42 to be higher since the display of the display panel 42 is easy to see.

When determining that the “park” is selected in the menu bar 500, the CPU 11 sends a command for displaying a setting information window 603 shown in FIG. 25C to the display control portion 41. The display control portion 41 causes the display panel 42 to display the setting information window 603 based on the command from the CPU 11. The setting information window 603 displays setting information 603a on a network connection, setting information 603b on a speaker volume, and setting information 603c on the brightness level of the display panel 42. Each setting information is displayed by an icon as well as an ON/OFF display or a level meter.

The CPU 11 outputs a command for displaying the setting information window 603 to the display panel 42 and causes the network interface 17 to be placed in an ON state (wireless WAN) (S16), and instructs the voice output control portion 20 to set the volume of the speaker 21 to be “10” (S17) and instructs the display control portion 41 to set the brightness level of the display panel 42 to be “8” (S18). The network interface 17 is placed in an “ON state” by the control from the CPU 11, and is placed in a state connectable to the WAN through wireless communication. The voice output control portion 20 adjusts the voice output from the speaker 21 to the voice corresponding to the volume “10” based on the command from the CPU 11. Based on the command from the CPU 11 the display control portion 20 adjusts the lightness of the backlight of the display panel 42 to the lightness corresponding to the brightness level “8”.

[4-4. Case where the “Office” is Selected]

When the operation detecting portion 54 (see FIG. 2) detects that a seventh region 50g shown in FIG. 23 is pressed (YES in S4), the CPU 11 determines that the “office” in the menu bar 500 is selected and reads fourth setting information stored in the HDD 14 (S13).

The fourth setting information corresponds to the place species “office”, and the network connection is set to be “ON (wireless LAN)”, the volume of the speaker 21 is set to be “5”, and the brightness level of the display 42 is set to be “5”. More specifically, an access point connectable to a LAN may be set in an office, and the LAN in the office can be connected through the access point by setting the network connection to be ON. Furthermore, in an indoor office, lighting equipment using a fluorescent lamp is lit to keep environmental lightness in most cases, so that it is preferred to set the brightness level of the display panel 42 to be an intermediate level.

When determining that the “office” in the menu bar 500 is selected, the CPU 11 sends a command for displaying a setting information window 604 shown in FIG. 25D to the display control portion 41. The display control portion 41 causes the display panel 42 to display the setting information window 604 based on the command from the CPU 11. The setting information window 604 displays setting information 604a on a network connection, setting information 604b on a speaker volume, and setting information 604c on the brightness level of the display panel 42. Each setting information is displayed by an icon as well as an ON/OFF display or a level meter.

The CPU 11 outputs a command for displaying the setting information window 604 to the display panel 42 and causes the network interface 17 to be placed in an ON state (wireless LAN) (S16), and instructs the voice output control portion 20 to set the volume of the speaker 21 to be “5” (S17) and instructs the display control portion 41 to set the brightness level of the display panel 42 to be “5” (S18). The network interface 17 is placed in an ON state by the control from the CPU 11, and is placed in a state connectable to the LAN through wireless communication. The voice output control portion 20 adjusts a voice output from the speaker 21 to the volume corresponding to the volume “5” based on the command from the CPU 11. Based on the command from the CPU 11, the display control portion 41 adjusts the lightness of the backlight of the display panel 42 to the lightness corresponding to the brightness level “5”.

[4-5. Case where the “Presentation” is Selected]

When the operation detecting portion 54 (see FIG. 2) detects that an eighth region 50h shown in FIG. 23 is pressed (YES in S5), the CPU 11 determines that the “presentation” in the menu bar 500 is selected and reads fifth setting information stored in the HDD 14 (S13).

The fifth setting information corresponds to the place species “presentation”, and the network connection is set to be “ON (wireless LAN)”, the volume of the speaker 21 is set to be “2”, and the brightness level of the display panel 42 is set to be “8”. More specifically, when presentation is performed using a notebook PC in an office or the like, a LAN may be connected in the office or the like, and the LAN can be connected by setting the network connection to be ON. Furthermore, when the presentation is performed, it is preferred to set the brightness of the backlight of the display panel 42 to be higher since the display of the display panel 42 is easy to see.

When determining that the “presentation” in the menu bar 500 is selected, the CPU 11 sends a command for displaying a setting information window 605 shown in FIG. 25E to the display control portion 41. The display control portion 41 causes the display panel 42 to display the setting information window 605 based on the command from the CPU 11. The setting information window 605 displays setting information 605a on a network connection, setting information 605b on a speaker volume, and setting information 605c on the brightness level of the display panel 42. Each setting information is displayed by an icon as well as an ON/OFF display or a level meter.

The CPU 11 outputs a command for displaying the setting information window 605 to the display panel 42 and causes the network interface 17 to be placed in an ON state (wireless LAN) (S16), and instructs the voice output control portion 20 to set the volume of the speaker 21 to be “2” (S17) and instructs the display control portion 41 to set the brightness level of the display panel 42 to be “8” (S18). The network interface 17 is placed in an “ON state” by the control from the CPU 11, and is placed in a state connectable to the LAN through wireless communication. The voice output control portion 20 adjusts a voice output from the speaker 21 to the volume corresponding to the volume “2” based on the command from the CPU 11. Based on the command from the CPU 11, the display control portion 41 adjusts the lightness of the backlight of the display panel 42 to the lightness corresponding to the brightness level “8”.

### [4-6. End Operation of a Place Mode]

When the place mode is ended, a region 50i corresponding to the place button 500a is pressed. As shown in FIG. 23 or the like, when detecting that the region 50i is pressed while the place species menu 500b is being displayed, the operation detecting portion 54 (see FIG. 2) sends a detection signal to the CPU 11. When receiving the detection signal from the operation detecting portion 54, the CPU 11 sends a command for deleting the display of the place species menu 500b to the display control portion 41. Based on the command sent from the CPU 11, the display control portion 41 causes the display panel 42 to delete the display of the place species menu 500b. As a result, the display of the display panel 42 is returned to the state shown in FIG. 22A.

The end operation of the place mode is not limited to the above operation. For example, the following configuration may be possible: a button indicating the “end of a place mode” is displayed in the place species menu 500b, and a part of the operation region 50 corresponding to the button is pressed, whereby the place mode is ended. When a previously set time (for example, 10 seconds) has elapsed after the shift to the place mode, the place mode may be ended automatically.

### [4-7. Method for Changing Setting Information]

It is preferred that the first to fifth setting information can be changed arbitrarily.

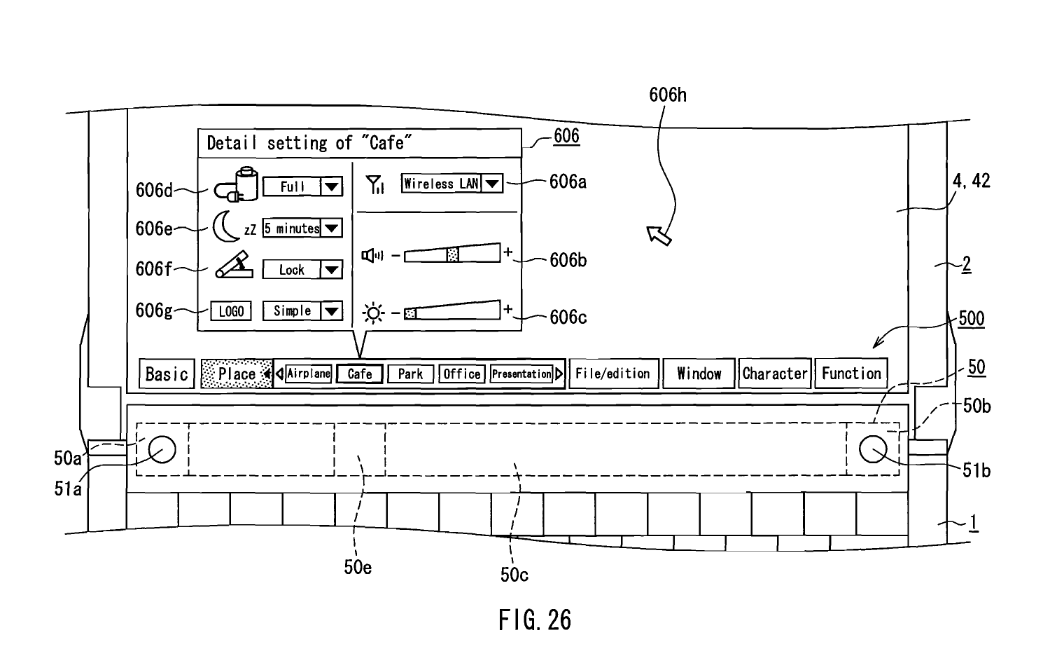

FIG. 26 shows display contents of a detail setting window 606. The detail setting window 606 shown in FIG. 26 can be displayed by performing a predetermined operation while the setting information window 601 is being displayed as shown in FIG. 25A or the like. The predetermined operation is a double-click operation of the operation region 50 corresponding to the place species for which it is desired to display the detail setting window. More specifically, when detecting that a particular region in the touch sensor 53 is double-clicked on, the operation detecting portion 54 (see FIG. 2) sends a detection signal to the CPU 11. When receiving the detection signal from the operation detecting portion 54, the CPU 11 sends a command for displaying the detail setting window to the display control portion 41. Based on the command sent from the CPU 11, the display control portion 41 causes the display panel 42 to display a detail setting window.

For example, when the user double-clicks on the fifth region 50e while the place species menu 500b is being displayed on the display panel 42 as shown in FIG. 23, the display control portion 42 causes the display panel 42 to display the detail setting window 606 of the place species “café” shown in FIG. 26.

As shown in FIG. 26, the detail setting window 606 includes a network connection setting portion 606a, a brightness adjusting portion 606b, and a speaker volume adjusting portion 606c. The network connection setting portion 606a can reject the connection to a network and set a connection destination of the network The brightness adjusting portion 606b can change the brightness of the backlight of the display panel 42 to an arbitrary value. The speaker volume adjusting portion 606c can change the volume of the speaker 21 to an arbitrary value. In the case of changing the setting of a network connection, the pointing device 7 or a mouse connected externally is operated to move a cursor 606h displayed on the display panel 42 to the network connection setting portion 606a and a click operation is performed. Then, a pull-down menu is displayed, and desired network connection method and network connection destination are selected from the menu. Furthermore, in the case of adjusting a brightness and a volume, the pointing device 7 or the like is operated to move the cursor 606h to the brightness adjusting portion 606b or the speaker volume adjusting portion 606c, and a pointer of the level meter is dragged to a plus side or a minus side in the figure. The brightness of the display panel 42 or the volume of the speaker can be set to be an arbitrary value by moving the pointer of the level meter to a desired position (level).

It is preferred that the detail setting window 606 can set power source management and a sleep operation in addition to the above setting items. The detail setting window 606 shown in FIG. 26 further includes a power source management setting portion 606d, a sleep setting portion 606e, an operation setting portion 606f at a time of dosing, and a wallpaper selecting portion 606b in addition to the above setting items. When the notebook PC is not operated for a predetermined period of time, the power source management setting portion 606a can perform setting related to the control of turning off the power supply to the display panel 42 and the HDD. The sleep setting portion 606e can set a time taken for the notebook PC to shift to the sleep state. The sleep refers to storing data under operation in an HDD temporarily and turning off the power source of the notebook PC. The operation setting portion 606f at a time of dosing 606f can set the operation of the notebook PC at a time when the second housing 2 shown in FIG. 1 is rotated to a closed position. The setting contents include, for example, locking of an operation of the notebook PC and the shift to a sleep state. The dosed position refers to the position of the second housing 2 with respect to the first housing 1, when the display surface of the display 4 and the operation surface of a keyboard placed in the first housing 1 are substantially parallel to each other. The wallpaper selecting portion 606g can select a wallpaper displayed on the display panel 42. The power source management setting portion 606d, the sleep setting portion 606e, the operation setting portion at a time of dosing 606f and the wallpaper selecting portion 606g all have a pull-down system, and the setting contents can be changed by the same setting method as that of the network connection setting portion 606a.

The setting items included in the detail setting window 606 shown in FIG. 26 are examples.

In the present embodiment, when it is detected that the operation region 50 corresponding to the place species is double-clicked on, the detail setting window 606 is displayed. However, the following configuration may be possible: when it is detected that the operation region 50 corresponding to the place species is clicked on while a setting information window is being displayed, the detail setting window 606 is displayed. For example, the fourth region 50d is clicked on while the setting information window 601 of the place species “airplane” is being displayed as shown in FIG. 25A, whereby a detail setting window capable of changing the setting information of the place species “airplane” is displayed.

### 5. Effects of an Embodiment, Etc.

According to the present embodiment, profiles such as the brightness of the display panel 42 and the volume of the speaker 21 can be changed easily by providing a place mode and selecting a place species suitable for the use environment (use place) from a plurality of place species, so that the operability can be enhanced. More specifically, in the conventional example, the adjustment of the brightness of the display panel 42, the adjustment of the volume of the speaker 21, and the setting of the connection of a network should be performed respectively depending upon the use environment (use place) of a notebook PC; however, according to the present embodiment, the adjustment of the brightness of the display panel 42, the adjustment of the volume of the speaker 21, and the connection setting of a network can be performed merely by selecting one place species from the place species menu 500b.

In the present embodiment, five place species: “airplane”, “café”, “park”, “office”, and “presentation” are used. However, these place species may be changed to other place species or other place species may be added. In addition to the above place species, for example, a “home” and a “meeting room” can be considered The “home” is assumed to be used, for example, by being connected to a utility power source, and the setting information thereof can be as follows: power source setting or the like is set to be performance priority. The setting information of the “meeting room” can be, for example, as follows: the network connection is set to be ON, the speaker volume is set to be “0”, and the brightness level of the display panel is set to be “1”.

Furthermore, place species may be provided for each country such as “Japan” and “the U.S.”. Such a place species is effective in the case where connection destinations of a network are different depending upon each country. Furthermore, in the where a place species is provided for each country, it is preferred that time information is included in setting information of the place species. Thus, by selecting a place species corresponding to the country where a notebook PC is used, a current time of an internal dock in the notebook PC is corrected based on a time difference, and the current time in a country where the notebook PC is used can be displayed.

Furthermore, the name of a place species can be changed by the user to an arbitrary name. As a change method, for example, there is a method in which a character input area capable of changing a name is placed in the detail setting window 606 shown in FIG. 26, and a new name is input in the character input area, whereby the name can be changed.

Furthermore, in the present embodiment, although the respective buttons included in the menu bar 500 or the place species buttons included in the place species menu display function names and button names in characters, these buttons may display graphics. More specifically, each button may have a form that is generally called an “icon”. Each button (button displaying characters) in the present embodiment is assumed to be included in the range of the “icon”

Furthermore, the first region 50a, the second region 50b, and the third region 50c indicate regions independent from each other. Furthermore, the regions 50d, 50e, 50f, 50g, 50h, and 50i indicate parts of the third region 50c.

Furthermore, each button included in the menu bar 500 in the present embodiment is an example of the icon of the present invention. The “icon” generally indicates graphics obtained by symbolizing an instruction or a command to be given to a computer so as to make it understood easily. The “icon” in the present invention is intended to be interpreted broadly so as to include not only the above graphics but also the buttons included in the menu bar 500 as shown in FIG. 22A, for example. Furthermore, the display panel 42 or the display 4 including the display panel 42 in the present embodiment is an example of a display unit or a display device of the present invention. Furthermore, the menu bar 500 in the present embodiment is an example of the icon display area of the present invention. Furthermore, the display control unit 41 in the present embodiment is an example of the display control unit of the present invention. Furthermore, the operation portion 16 in the present embodiment is an example of the operation unit or the signal input portion of the present invention. Furthermore, the place species in the present embodiment is an example of the operation environment of the present invention. Furthermore, the setting information in the present embodiment is an example of the profiles of the present invention. Furthermore, the place species button in the present embodiment is an example of a profile switching unit of the present invention. Furthermore, the second housing 2 in the present embodiment is an example of the second housing of the present invention. Furthermore, the first housing 1 in the present embodiment is an example of the first housing of the present invention. Furthermore, a spindle included in the hinge portion 3 in the present embodiment is an example of the rotation shaft of the present invention. Furthermore, the operation region 50 and the touch sensor 53 in the present embodiment are examples of the contact operation portion of the present invention. Furthermore, the first region 50a and the second region 50b in the present embodiment are examples of the designation portion of the present invention.

The present invention can be used widely in an information processing unit using a plurality of system environments by switching, for example, without being limited to a portable notebook PC.

Regarding the present embodiment, the following notes will be disclosed

(Note 1)

An information processing unit that displays icons selected when predetermined processing is designated on a screen of a display unit, including:

a display control unit that causes an icon display area, in which a plurality of the icons related to each other are grouped, to be displayed on the screen; and

an operation unit that receives various operations by a user,

wherein, when the operation unit inputs a command for expanding or contracting the icon display area in a one-dimensional direction that is the same as an arrangement direction of the plurality of the icons in the icon display area, the display control unit causes the icon display area displayed on the screen to be expanded or contracted in the one-dimensional direction.

(Note 2)

The information processing unit according to Note 1, including a second housing provided with the display unit, and a first housing via a rotation shaft that opens or doses the second housing rotatably,

wherein the operation unit is placed in a vicinity of the rotation shaft in the first housing.

(Note 3)

The information processing unit according to any one of Notes 1 and 2, wherein the operation unit receives respective operations at positions corresponding to the plurality of the icons displayed in the icon display area.

(Note 4)

The information processing unit according to any one of Notes 1 to 3, wherein the operation unit includes a designation portion, which designates a display or a non-display of the icon display area on the screen, in at least one end portion of the arrangement direction of the plurality of the icons.

(Note 5)

The information processing unit according to Note 1, wherein the plurality of the icons are a profile switching unit that specifies an operation environment in which the user operates the operation unit and displays a profile in accordance with the operation environment on the display unit.

(Note 6)

The information processing unit according to Note 1, further including a second housing provided with a display device that displays a visual signal, a first housing provided with a signal input portion for inputting a signal to be displayed on the display device, and a rotation shaft that axially supports the second housing with respect to the first housing so as to open or dose the second housing freely,

wherein the profile switching unit is a plurality of icons corresponding to a plurality of the profiles, and in a vicinity of the rotation shaft in the display device, the information processing unit includes an icon display area that displays the plurality of the icons in a row, and a contact operation portion that corresponds to positions of the plurality of the icons displayed in the icon display area and is placed between the single input portion in the second housing and the rotation shaft.

### Embodiment 4

According to the configuration disclosed by JP 2002-259009, when the number of registered icons increases to increase the number of tool bars, the number of rotations of the tool bars for searching for a desired icon increases, which takes a long time to find out the desired icon, resulting in the decrease in operability.

An object of the information processing unit according to Embodiment 4 is to shorten a time for searching for a desired icon to enhance the operability.

### 1. Configuration of an Information Processing Unit

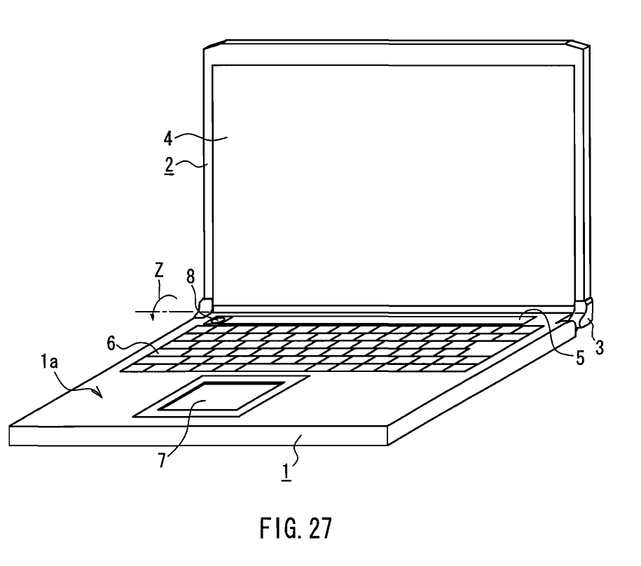

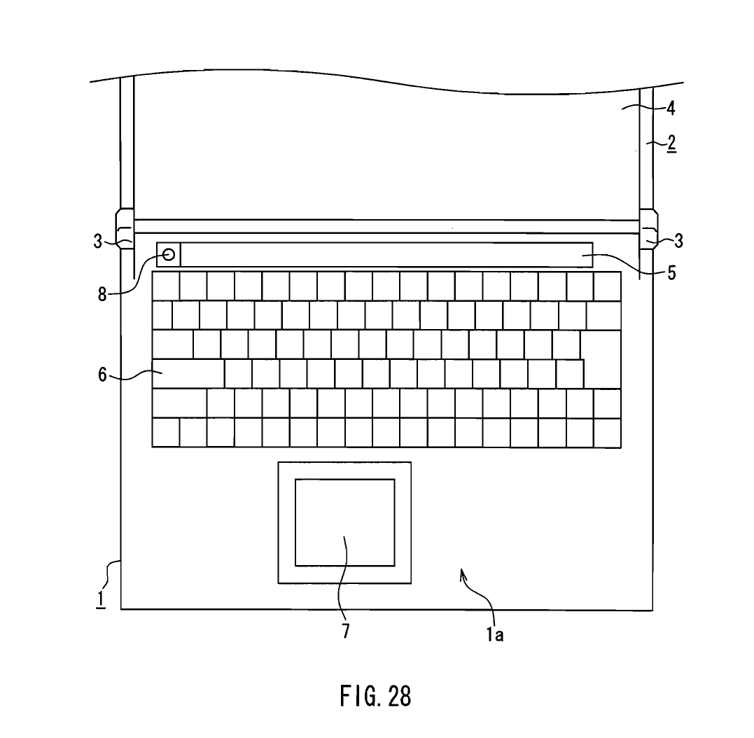

FIG. 27 is a perspective view showing an outer appearance of a notebook PC that is an example of an information processing unit in the present embodiment. FIG. 28 is a plan view of the notebook PC, mainly showing a first housing 1 side.

In FIGS. 27 and 28, the notebook PC includes a first housing 1 containing a central processing unit, a hard disk drive, and the like, and a second housing 2 having a main display 4. The first housing 1 and the second housing 2 are supported by a hinge portion 3 so as to rotate in a direction indicated by an arrow Z or an opposite direction thereto. On an upper surface 1a of the first housing 1, various operation units such as a keyboard 6, a pointing device 7, and a power source switch 8 are placed. The upper surface 1a of the first housing 1 has a sub-display 5 capable of displaying various pieces of information. The sub-display 5 is composed of a touch panel type monitor, and is composed of a touch panel type liquid crystal monitor in the present embodiment.

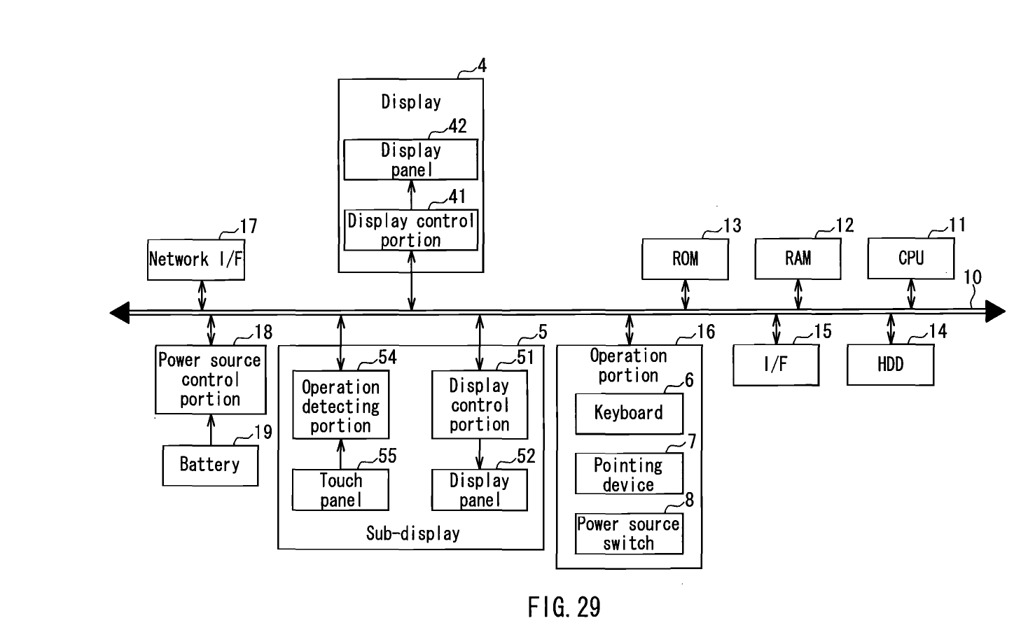

FIG. 29 is a block diagram showing a hardware configuration of the notebook PC of the present embodiment. As shown in FIG. 29, the hardware of the notebook PC of the present embodiment is configured in such a manner that the central processing unit (CPU) 11, a RAM (Random Access Memory) 12, a ROM (Read Only Memory) 13, an HDD (Hard Disk Drive) 14, an interface 15, an operation portion 16, a network interface 17, a power source control portion 18, a display control portion 41, a display control portion 51, and an operation detecting portion 54 can communicate with each other through a bus 10.

The CPU 11 is a device controlling each portion in the notebook PC, and specifically, a device that processes data stored in the RAM 12 temporarily. The ROM 13 stores information on a BIOS (Basic Input Output System) and the like. The CPU 11, the RAM 12, and the ROM 13 are examples of the control units of the present invention.

The HDD 14 stores various data contained in an OS and data generated by the user in a file format. Although the HDD 14 is provided in the present embodiment, a recording medium in another form such as a semiconductor memory may be provided as long as it can store at least data in a file format.

The interface 15 is used for connecting the notebook PC to an external appliance, and includes a port pursuant to, for example, a USB (Universal Serial Bus) specification, a headphone terminal, and the like.

The operation portion 16 includes the keyboard 6, the pointing device 7, and the power source switch 8. The keyboard 6 is composed of a plurality of keys capable of inputting various characters. The pointing device 7 has an operation surface, for example, in a rectangular shape as shown in FIG. 28, and a sensor capable of detecting that the operation surface is operated with a finger or the like is provided under the operation surface. The user can move a cursor displayed on a display panel 42 to an arbitrary position by pressing the operation surface with a finger or the like and moving the finger pressing the operation surface in a plane direction (arbitrary direction) of the operation surface (hereinafter, this operation will be referred to as a slide operation). Furthermore, the pointing device 7 includes two push-button switches in the vicinity of the operation surface. Of the two switches, a first switch is capable of inputting commands such as “determination” and “selection” in various situations. Furthermore, of the two switches, a second switch is capable of inputting a command such as “cancel”.

The network interface 17 is a terminal capable of connecting the notebook PC to a network. The network interface 17 includes, for example, a LAN port capable of being connected to a LAN (Local Area Network) and a modem port capable of being connected directly to an external network.

The power source control portion 18 supplies electric power supplied from a battery 19 to each portion in the notebook PC. The notebook PC of the present embodiment is not limited to a configuration driven with electric power supplied from the battery 19, and may include a configuration driven with electric power supplied from a utility power source.

The main display 4 includes the display control portion 41 and the display panel 42.

The display control portion 41 converts image data processed and generated by the CPU 11 and the RAM 12 into an image signal capable of being displayed on the display panel 42, and displays an image based on the converted image signal on the display panel 42.

The display panel 42 is composed of, for example, a liquid crystal display panel of about 10 to 14 inches, and generally, in the case where the user performs an operation using the notebook PC, the display panel 42 displays information related to the operation.

The sub-display 5 includes a display control portion 51, a display panel 52, an operation detecting portion 54, and a touch panel 55.

The display control portion 51 converts image data processed and generated by the CPU 11 and the RAM 12 into an image signal capable of being displayed on the display panel 52, and causes the display panel 52 to display an image based on the converted image signal.

The display panel 52 is composed of, for example, a liquid crystal display panel with a size of about 20 mm×about 200 mm. When the user performs an operation using the notebook PC, the display panel 52 is capable of displaying information related to the operation.

The touch panel 55 is placed on the display surface of the display panel 52, and is configured so as to perform an arbitrary operation by pressing a reverse surface hereinafter, referred to as an operation surface) of a surface opposite to the display surface of the display panel 52 with a finger or the like. Specifically, the touch panel 55 includes matrix switches placed in a lattice shape on the operation surface side, and is configured so that, when an arbitrary position on the operation surface is pressed with a finger, a stylus pen, or the like, the matrix switch at that position is switched from OFF to ON (the matrix switch is in an OFF state at all times when the operation surface is not being pressed). By retrieving positional information (coordinate) of the matrix switch that is switched from OFF to ON, it can be detected that an arbitrary position in the touch sensor 55 is pressed. Examples of the touch panel 55 include a resistance film type, a capacitance type, and a surface acoustic wave type, any of which may be mounted. Furthermore, the touch panel 55 is configured in such a manner that at least a portion covering an effective display area of the display panel 52 is transparent so that an image displayed on the display panel 52 can be identified visually from outside (operation surface side of the touch panel 55).

The operation detecting portion 54 generates information (coordinate) on the pressed position, based on the ON/OFF state of the matrix switch in the touch panel 55. Furthermore, the operation detecting portion 54 sends the generated positional information to the CPU 11. The touch sensor 55 and the operation detecting portion 54 are examples of a region selecting unit of the present invention.

Hereinafter, the basic operation of the information processing unit will be described.

As shown in FIG. 29, when the user operates a power source switch 8, the power source control portion 18 pulls in electric power from the battery 19 and supplies the electric power to each portion in the notebook PC. Then, the CPU 11 reads BIOS information from the ROM 13 and reads a file of the OS stored in the HDD 14, thereby performing startup processing. During the startup processing, the display control portion 41 causes the display panel 42 to display a startup screen. In a state in which the startup processing of the notebook PC is completed, icons and the like for activating various pieces of application software are displayed on the display panel 42. Furthermore, a tool bar (described later) is displayed on the display panel 52.

After the activation of the notebook PC, when the keyboard 6 is operated by the user, the CPU 11 detects an operated key among a plurality of keys placed on the keyboard 6 and sends a command to the display control portion 41 so as to cause the display panel 42 of the main display 4 to display a character corresponding to the operated key. The display control portion 41 causes the display panel 42 to display the character based on the command from the CPU 11. Furthermore, when the user operates the pointing device 7, the pointing device 7 outputs information on the position of the operation surface pressed by the user. The CPU 11 sends a command for moving a cursor displayed on the display panel 42 to the display control portion 41, based on the positional information output from the pointing device 7. The display control portion 41 causes the cursor displayed on the display panel 42 to move to an arbitrary position based on the command from the CPU 11.

Furthermore, when the first switch is pressed once by the user while the cursor is placed at an arbitrary position, the CPU 11 detects the operation to control each portion (hereinafter, this operation will be referred to as a “click operation”). Furthermore, when the first switch is pressed twice continuously by the user, the CPU 11 detects this operation to control each portion (hereinafter, this operation will be referred to as a “double-click operation”). Furthermore, when the operation surface of the pointing device 7 is slid while the first switch is being pressed continuously by the user, for example, an icon displayed on the display panel 42 can be moved to an arbitrary position, or an arbitrary region of an image displayed on the display panel 42 can be encircled (hereinafter, this operation will be referred to as a “drag operation”). Furthermore, when the continuous pressing of the first switch is cancelled from the state where the user is performing the drag operation, the operation executed based on the drag operation can be finished hereinafter, this operation will be referred to as a “drop operation”). Thus, the user can execute various operations by operating the keyboard 6 and the pointing device 7.

On the other hand, the sub-display 5 has the touch panel 55. Therefore, the user can perform a click operation, a double-click operation, a drag operation, and a drop operation by pressing a display area directly with a finger, a stylus pen, or the like. The click operation refers to an operation in which an arbitrary display area in the sub-display 5 is pressed for a short period of time (for example, one second or less). Furthermore, the double-click operation refers to an operation in which the click operation is performed twice intermittently. Furthermore, the drag operation refers to an operation in which an arbitrary display area in the sub-display 5 is pressed, and the finger is slid on the touch panel 55 while the display area is being pressed. The drop operation refers to an operation in which the finger is detached from the touch panel 55 after the drag operation. The drop operation refers to, in particular, an operation in which an icon displayed on the sub-display 5 is moved to another position in the display area of the sub-display 5 by the drag operation, and the position of the icon can be confirmed.

### 2. Display Operation of the Sub-Display 5

As shown in FIGS. 27 and 28, the sub-display 5 is composed of a band-shaped display having a longitudinal direction in a one-dimensional direction in the first housing 1 of the notebook PC.

In the present embodiment, the sub-display 5 is placed at a position dose to the second housing 2 on the first housing 1. By placing the sub-display 5 at this position, the sub-display 5 can be placed in the vicinity of the main display 4, and the display interlocked with the display on the main display 4 can be realized on the sub-display 5.

Furthermore, the sub-display 5 is placed at a position on the second housing 2 side with respect to the keyboard 6, whereby the user can detach the sub-display 5 from the position of the hand or the arm when the user is operating the keyboard 6 or the pointing device 7 in an ordinary posture. Therefore, the hand or the arm of the user is unlikely to touch the sub-display 5 unexpectedly, whereby the wrong operation of the sub-display 5 can be prevented.

Furthermore, the sub-display 5 is placed on the upper surface 1a on which the keyboard 6 and the like are placed in the first housing 1, whereby a small movement of a line of sight among the main display 4, the sub-display 5, and the keyboard 6 suffices, so that the display contents can be visually identified easily. Furthermore, the movement amount of the finger from the keyboard 6 can be reduced when the touch panel 55 of the sub-display 5 is operated, which can enhance the operability.

Hereinafter, the specific display operation of the sub-display 5 will be described.

### 2-1. Display of a Tool Bar

The sub-display 5 can display a tool bar. The tool bar is a region that displays icons for operating various functions in the notebook PC and for activating application software installed on the notebook PC. The icons displayed in the tool bar previously are associated with commands capable of activating startup files of various functions and application software. The user can activate a desired function, application software, or the like by operating the touch panel 55 to select an icon displayed in the tool bar. The tool bar in the present embodiment is an example of a band-shaped display area indicating a particular region in which icons and the like are displayed, and those which have the same function are included in the range of the “tool bar” in the present embodiment even if they have different designations.

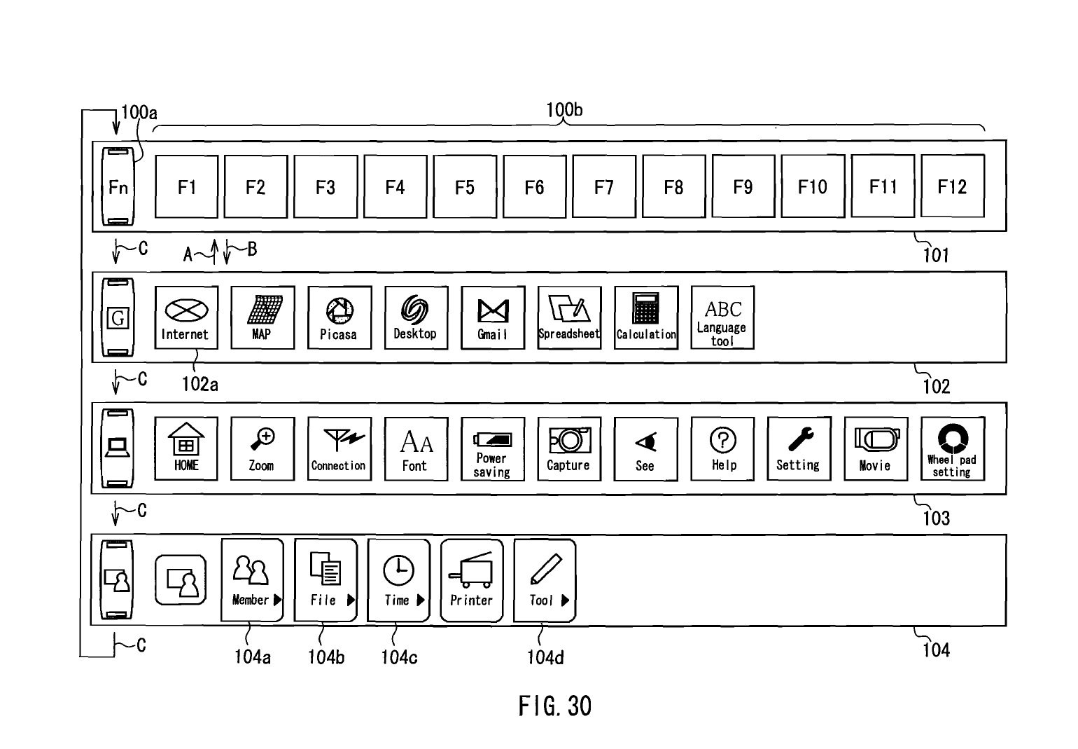

FIG. 30 is a schematic diagram showing display contents of tool bars displayed on the sub-display 5. In the present embodiment, four tool bars can be switched to be displayed. The tool bars that can be displayed in the present embodiment include a first tool bar 101, a second tool bar 102, a third tool bar 103, and a fourth tool bar 104. The first tool bar 101 is assigned functions corresponding to function keys of the keyboard 6. The second tool bar 102 is assigned icons capable of activating various pieces of application software such as Internet browser software. The third tool bar 103 is assigned a function capable of performing various settings of the notebook PC. The fourth tool bar 104 is assigned a function capable of executing a videoconference system.

In the example shown in FIG. 30, although the four tool bars 101 to 104 can be switched to be displayed, the number of the tool bars is not limited to four. Needless to say, one tool bar may be displayed, and five or more tool bars may be displayed. However, when the number of the tool bars is too large, it takes time and labor for the user to search for a desired icon; therefore, it is preferred that about four tool bars are displayed as shown in FIG. 30, since the operability is not decreased. Furthermore, the functions and application software registered in each tool bar in the present embodiment are shown for illustrative purposes. Arrows C in FIG. 30 indicate the shift directions of the tool bars 101 to 104. The shift of the displays may be opposite to the direction indicated by the arrows C.

The tool bars 101 to 104 respectively have a selective operation portion 100a and an icon display portion 100b. The selective operation portion 100a can perform operations in which the user switches the displays of a plurality of tool bars successively while the plurality of tool bars can be switched to be displayed. For example, when the user single-clicks on the selective operation portion 100a while the first tool bar 101 is being displayed on the sub-display 5, the display of the sub-display 5 is switched from the first tool bar 101 to the second tool bar 102. Thereafter, every time the selective operation portion 100a is single-clicked on, the display of the sub-display 5 is switched from the third tool bar 103, the fourth tool bar 104, the first tool bar 101, the second tool bar 102, . . . .

The tool bars displayed on the sub-display 5 can be switched even by sliding the selective operation portion 100a in a direction indicted by an arrow A or B. For example, when the selective operation portion 100a is slid in the direction indicated by the arrow Awhile the first tool bar 101 is being displayed on the current sub-display 5, the display of the sub-display 5 is switched from the first tool bar 101 to the second tool bar 102. Furthermore, when the selective operation portion 100a is slid in the direction indicated by the arrow B while the second tool bar 102 is being displayed on the sub-display 5, the display of the sub-display 5 is switched from the second tool bar 102 to the first tool bar 101.

Furthermore, the selective operation portion 100a shows characters and graphics representing the contents of a currently selected tool bar. For example, when the first tool bar 101 is being displayed, since the first tool bar 101 is assigned functions corresponding to function keys generally provided on the keyboard 6, characters “Fn” are displayed in the selective operation portion 100a.

Furthermore, the selective operation portion 100a may display the serial number of a currently selected tool bar and the total number of registered tool bars. In the case of the example shown in FIG. 30, when the first tool bar 101 is being displayed, a fraction “¼” is displayed in the selective operation portion 100a, and when the second tool bar 102 is being displayed, a fraction “ 2/4” is displayed in the selection operation portion 100a. In this display form, the numerator represents the page number of a tool bar, and the denominator represents the total number of tool bars. With such a configuration, the starting point of the tool bar can be grasped easily. Furthermore, the page number of a tool bar is not limited to the display of a numerical value, and may be displayed by an icon.

Furthermore, the icon display portion 100b is a region in which icons registered in each tool bar are displayed. For example, in the case of the first tool bar 101, icons such as “F1” and “F2” corresponding to function keys generally mounted on the keyboard 6 are displayed in the icon display portion 100b. As described above, when the display of the tool bar is switched when the user operates the selective operation portion 100a, icons displayed in the icon display portion 100b also are switched.

The user clicks on a desired icon among the icons displayed in the icon display portion 100b, thereby executing the function associated with the clicked icon and activating application software associated therewith. The function and application software executed by the operation of the icon are displayed on the main display 4. For example, when an Internet icon 102a in the second tool bar 102 is clicked on, the CPU 11 reads and starts up a file of Internet browser software from the HDD 14. Next, the display control portion 41 of the main display 4 causes the display panel 42 to display a browser screen.

### 2-2. Expansion/Contraction Display of a Window

In the previous section, the configuration is described in which, when the icon displayed in the icon display portion 100b of the tool bar is clicked on, various functions and application software are activated. In the case where the clicked icon has a hierarchical structure, a window in a lower layer is displayed on the sub-display 5. A window in the present embodiment is an exemplary window-shaped display area that is displayed in the tool bar and indicates a particular region displaying icons and the like, and those which have the same function are included in the range of the “window” in the present embodiment even if they have different designations.

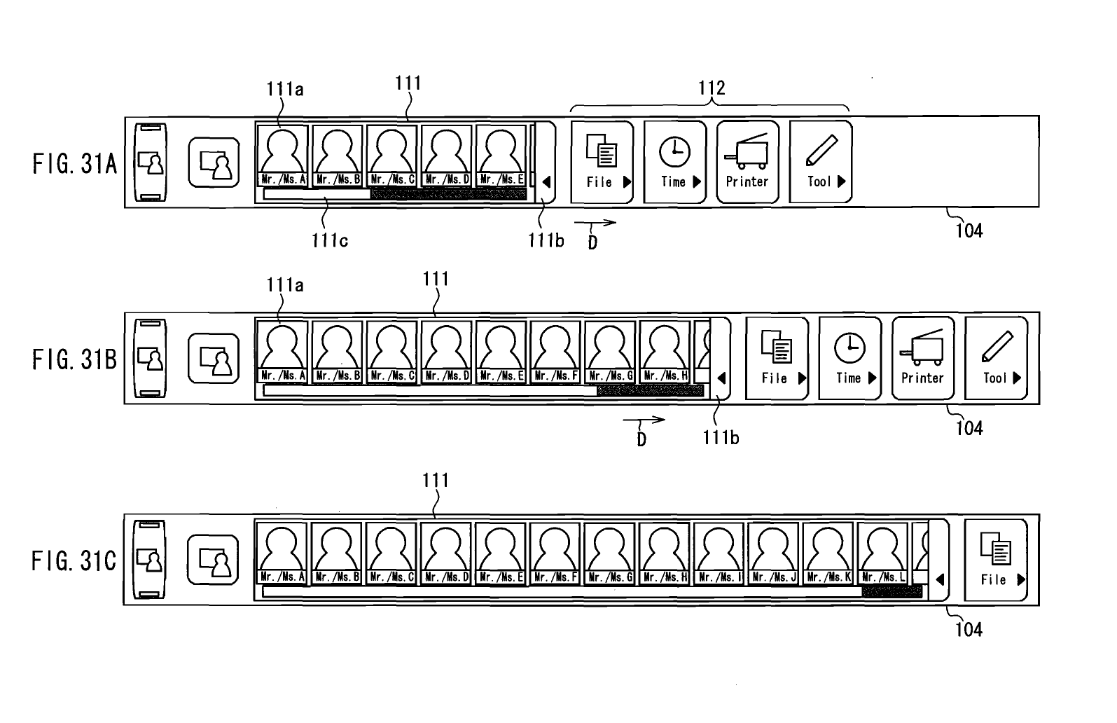

FIG. 31A shows a state in which a window is displayed in the tool bar. FIG. 31A shows, for example, a state that is displayed when a member icon 104a of the fourth tool bar 104 (tool bar of a videoconference system) in FIG. 30 is clicked on. As shown in FIG. 31A, when the member icon 104a (see FIG. 30) is clicked on, the member icon 104a displayed in the fourth tool bar 104 is deleted and a window 111 is displayed. In the window 111, the information on the lower layer of the member icon 104a is displayed by icons 111a. In the present embodiment, the icons 111a display information on members that are being connected to the videoconference system or members that can be connected thereto. The information on the members included in the icons 111a includes face images and names of the members in the present embodiment, which merely are shown for illustrative purposes.

The size of the window 111 displayed first when the member icon 104a is clicked on is arbitrary; however, when the number of icons to be displayed in the window 111 is too large for the size of the window 111 displayed as shown in FIG. 31A and all the icons cannot be displayed simultaneously, only some of the icons may be displayed together with a scroll bar 111c.

Furthermore, the icons displayed in the window 111 are arranged based on a predetermined priority order. For example, in the case of the videoconference system as shown in FIG. 31, the “predetermined priority order” may be the order in which the names of the members connected to the system are arranged according to Japanese 50 phonetic characters or may be the order in which the members have been connected to the system. Alternatively, the use frequency of the icons is monitored and the icons may be displayed automatically so as to be arranged at all times in the decreasing order of the use frequency, and such a display can enhance the ease of use.

Furthermore, a drag region 111b is provided at an end in the longitudinal direction of the window 111. The user presses the drag region 111b on the touch panel 55 with a finger or the like, and drags the drag region 111b in a direction indicated by an arrow D while pressing the drag region 111b, thereby expanding the window 111 in the longitudinal direction as shown in FIG. 31B.

The size of the icon 111a in the window 111 before the expansion of the window 111 (FIG. 31A) does not change after the expansion thereof (FIG. 31B), and the number of the icons 111a displayed in the window 111 increases. Furthermore, other icons 112 displayed adjacent to the window 111 in the fourth tool bar 104 move in the direction indicated by the arrow D along with the expansion of the window 111 in the direction indicated by the arrow D.

Furthermore, when the drag region 111b is dragged in the direction indicated by the arrow D from the state shown in FIG. 31B, whereby the window 111 can be expanded further, as shown in FIG. 31C. At this time, the other icons 112 displayed in the fourth tool bar 104 further move in the direction indicated by the arrow D. As shown in FIG. 31C, when a part of the icons 112 cannot be displayed in the fourth tool bar 104 any more as a result of the expansion of the window 111, only an icon that can be displayed among the icons 112 is displayed, and a scroll bar (not shown) is displayed in the fourth tool bar 104. This enables the icons 112 that cannot be displayed any more to be displayed. The icons that cannot be displayed any more in the tool bar as a result of the expansion of the window may be displayed in an end portion (for example, a right end) of the tool bar, with the size in the longitudinal direction of the tool bar being compressed. With such a display, it is possible to grasp the presence of the icons that cannot be displayed any more even without displaying and operating the scroll bar.

The window 111 also can be contracted by dragging the drag region 111b in a direction opposite to the direction indicated by the arrow D. That is, the user can adjust the winder 111 to an arbitrary size by dragging the drag region 111b to move the drag region 111b to an arbitrary position.

Furthermore, the window 111 can be returned to the icon display shown in FIG. 30, for example, by double-clicking on the drag region 111b.

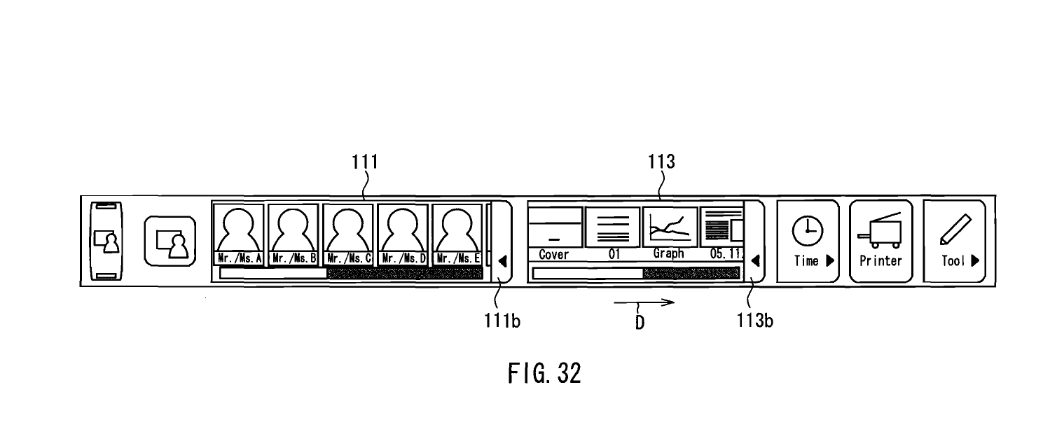

FIG. 32 shows a state in which two windows are displayed simultaneously in the sub-display 5. As shown in FIG. 32, the number of windows that can be displayed in the tool bar is not limited to one, and a plurality of windows also can be displayed. The example shown in FIG. 32 shows a state in which the window 111 is opened by clicking on the member icon 104a in the fourth tool bar 104 in FIG. 30 and a window 113 is opened by clicking on the file icon 104b. The window 113 displays, for example, icons of files such as documents and data that can be opened to the other members connected to the videoconference system.

Even in such a display, the window 111 can be adjusted to an arbitrary size by dragging the drag region 111b in the direction indicated by the arrow D or the direction opposite thereto. Furthermore, the window 113 can be adjusted to an arbitrary size by dragging the drag region 113b in the direction indicated by the arrow D or the direction opposite thereto.

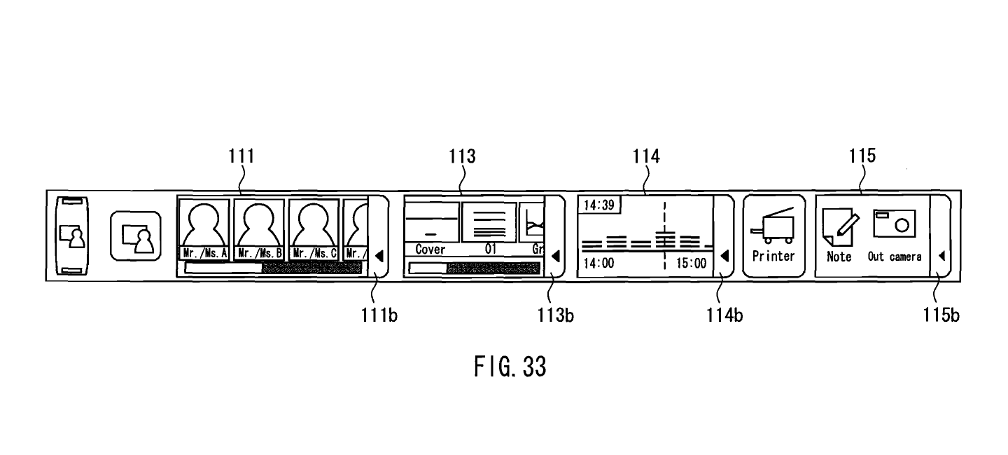

The number of the windows that can be displayed simultaneously in the sub-display 5 is not limited to one as shown in FIG. 31 or two as shown in FIG. 32, and at least three windows also can be displayed simultaneously. FIG. 33 shows a state in which four windows 111, 113, 114, and 115 are displayed simultaneously. In FIG. 33, the window 114 is displayed by clicking on a time icon 104c in the fourth tool bar 104 shown in FIG. 30. The window 115 is displayed by clicking on a tool icon 104d in the fourth tool bar 104 shown in FIG. 30. The windows 114 and 115 have drag regions 114b and 115b that can change a window size in the same way as in the other windows (the description of the operation of changing a window size will be omitted). Furthermore, the window 114 can be returned to the time icon 104c and the window 115 can be returned to the tool icon 104d by double-clicking on the drag regions 114b and 115b.

In the above configuration, although the size of the icons in the window when the drag region is dragged is not changed, and the icons that cannot be displayed in the window any more are allowed to be displayed only when the display is scrolled by dragging the scroll bar, the size of the icons in the window may be adjusted automatically along with the change in size of the window. FIGS. 34A to 34C show display examples when the window is contracted.

First, as shown in FIG. 34A, in the case where the drag region 121b is dragged in the direction indicated by the arrow E while a plurality of icons 121a (six icons in the present example) of an ordinary size are being displayed in the window 121 displayed in the tool bar 120, the size of the window 121 is reduced in the longitudinal direction. At this time, the size of all the icons 121a displayed in the window 121 also is reduced in the width direction (the same direction as the longitudinal direction of the window) while all the icons 121a displayed in the state shown in FIG. 34A are being displayed. FIG. 34B shows a state in which the size of the window 121 is reduced. In the state shown in FIG. 34B, six icons 121a with the size reduced in the width direction are displayed side by side in the longitudinal direction of the window 121.

Furthermore, when the drag region 121b is dragged further in the direction indicated by the arrow E from the state shown in FIG. 34B, the size of the window 121 in the longitudinal direction is reduced. At this time, the size of all the icons 121a displayed in the window 121 also is reduced in the width direction (the same direction as the longitudinal direction of the window) while all the icons 121a displayed in the state shown in FIG. 34B are being displayed. However, if the size of the window 121 in the longitudinal direction is reduced too much, the size of the icon 121a in the width direction becomes too small, which makes it difficult to identify characters and marks of the icons 121a visually. In the present embodiment, when the size of the window 121 in the longitudinal direction or the size of the icon in the width direction becomes a predetermined size or less, the icons are displayed in a plurality of stages in the window 121. FIG. 34C shows an example in which six icons 121a are displayed in two stages, each stage containing three icons. With such a display, even if the size of the window 121 is reduced in the longitudinal direction, all the icons included in the window 121 can be displayed. Furthermore, the aspect ratio of the contracted icons is equal to that of the icons before the contraction, so that the visibility of the characters and marks in the icons is higher compared with that in the case where the icons are contracted only in the width direction. The display form shown in FIG. 34C is an example, and for example, three stages may be displayed depending upon the size of the window and the number of icons.

The display can be shifted to the display form shown in FIG. 34B or 34A by dragging the drag region 121b from the state shown in FIG. 34C in the direction opposite to the direction indicated by the arrow E.

### 2-3. Hierarchy Display

The tool bar display in the present embodiment can be provided with a plurality of levels of hierarchy.

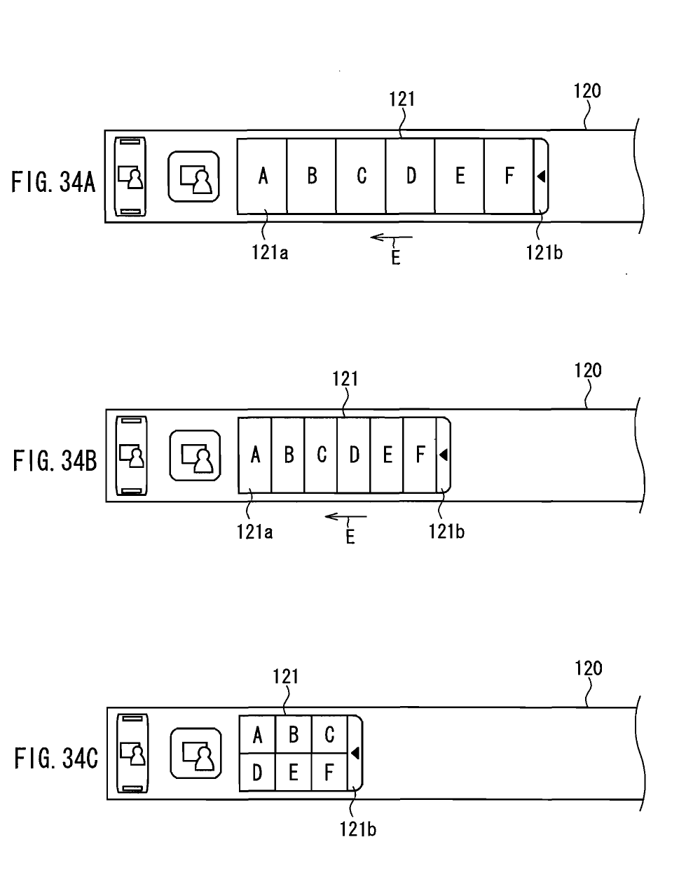

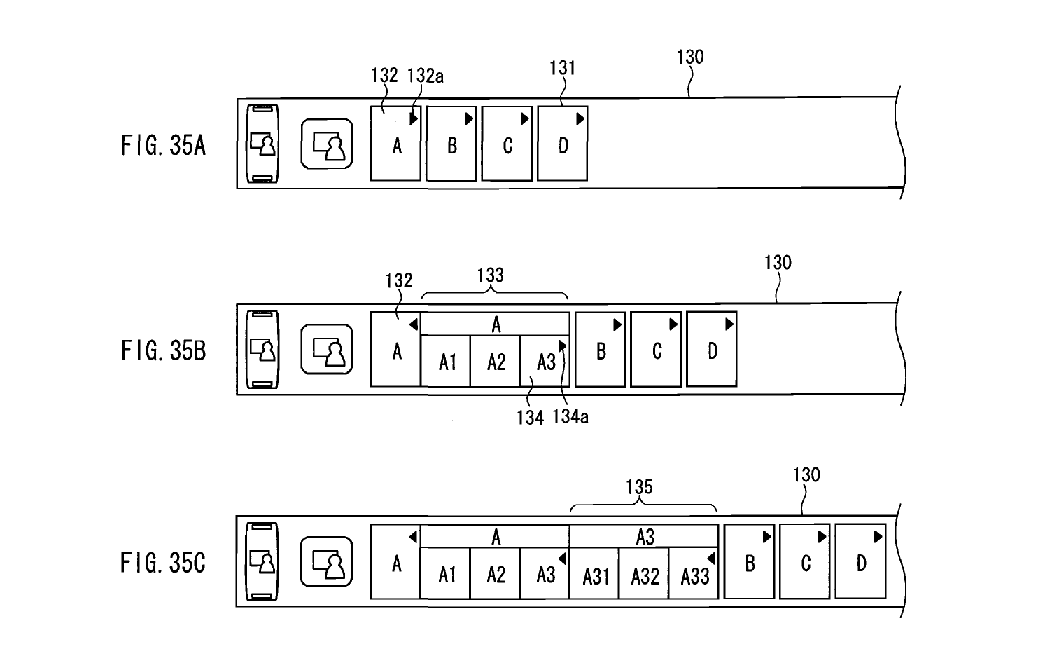

FIGS. 35A to 35C show the shift of a display of a tool bar having a plurality of levels of hierarchy. First, in an ordinary display state (in which four icons 132 are displayed in a window 131) shown in FIG. 35A, icons having other icons in lower layers are displayed with hierarchy marks 132a. When the icon 132 is clicked on as an example of the icon having a lower layer, a group of icons 133 in the lower layer of the icon 132 is displayed between the icon 132 and the icon adjacent thereto, as shown in FIG. 35B. The illustrated example shows that a group of icons 133 composed of three icons is present in the lower layer of the icon 132.

Furthermore, when the group of icons 133 is displayed, the hierarchy mark 132a in the icon 132 is switched from a rightward triangular display to a leftward triangular display. The rightward triangular display means that the icon with that display has other icons in a lower layer thereof, and thus, the icon is displayed with the icons in the lower layer not displayed. On the other hand, the leftward triangular display means that the display of the icons in the lower layer can be deleted, so that the icon with the leftward triangular display is displayed while the icons in the lower layer are being displayed. When the icon 132 is clicked on while the hierarchy mark 132a represents the leftward triangular display, the display of the group of icons 133 in the lower layer is deleted, returning to the display shown in FIG. 35A Hereinafter, although the description will be omitted, the above similarly applies to the hierarchy icons displayed in the other icons.

As shown in FIG. 35B, in the case where there is an icon (icon 134) further having a lower layer in the group of icons 133, the icon 134 is displayed with a hierarchy mark 134a. When the icon 134 provided with the hierarchy mark 134a is clicked on, a group of icons 135 in the lower layer of the icon 134 is displayed adjacent to the icon 134, as shown in FIG. 35C. The illustrated example shows that the group of icons 135 composed of three icons further is present in the lower layer of the icon 134. If there is an icon further having other icons in a lower layer among the icons included in the group of icons 135, the icon is displayed with a hierarchy mark in the same way as the above.

In the state shown in FIG. 35C, the display of the group of icons 135 is deleted, for example, by double-clicking on a region of the group of icons 135, returning to the display of the icon 134 that is an upper layer of the group of icons 135, as shown in FIG. 35B. Furthermore, in the state shown in FIG. 35B, the display of the group of icons 133 is deleted, for example, by double-clicking on a region of the group of icons 133, returning to the display of the icon 132 that is an upper layer of the group of icons 133, as shown in FIG. 35A.

### 2-4. Scroll Display

As shown in FIGS. 35B and 35C, if the number of icons included in a group of icons is about three, all the icons included in the group of icons can be displayed as shown in these figures. However, if the number of icons included in a group of icons is too large, all the icons may not be displayed simultaneously.

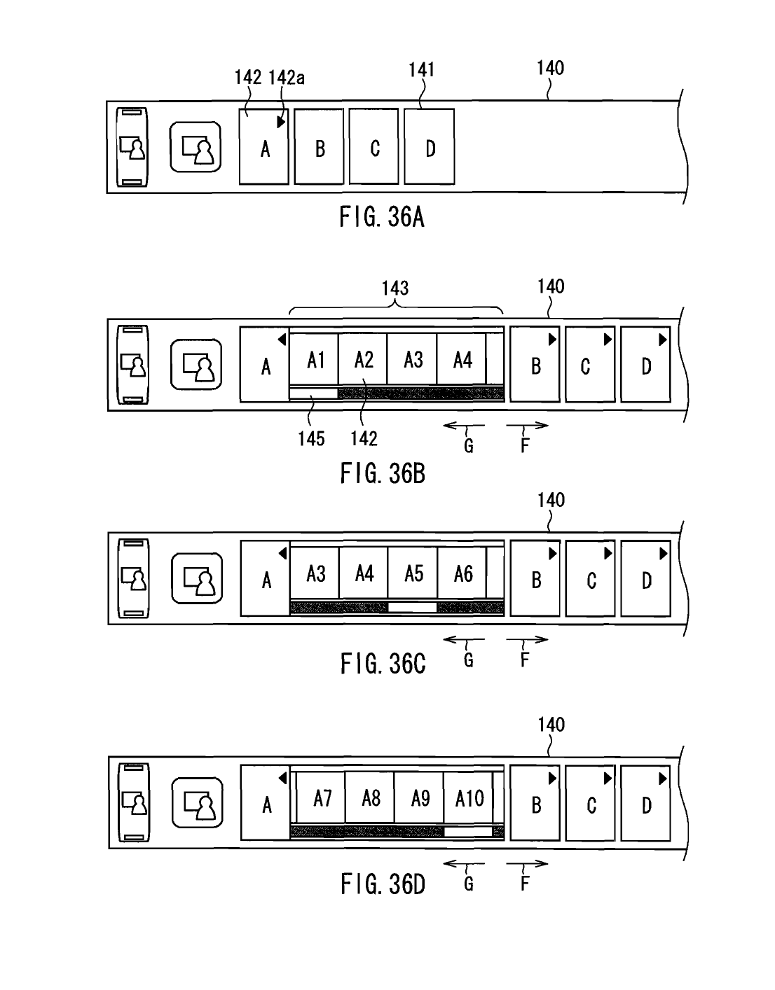

FIGS. 36A to 36D show a display form in the case where the number of icons included in a group of icons is large. First, as shown in FIG. 36A, in an ordinary display state (in which four icons 142 are displayed in a window 141), the icon having other icons in a lower layer is displayed with a hierarchy mark 142a. When the icon 142 is clicked on as an example of the icon having a lower layer, a group of icons 143 in the lower layer of the icon 142 is displayed between the icon 142 and the icon adjacent thereto, as shown in FIG. 36B. In the illustrated example shown in FIG. 36, although the group of icons 143 composed of 10 icons is present in the lower layer of the icon 142, the number of the icons 144 that can be displayed simultaneously in the group of icons 143 is set to be four due to the size of the display area of a task bar 140. Specifically, the first four icons are displayed when 10 icons included in the group of icons 143 are arranged in a predetermined order. Furthermore, a scroll bar 145 is displayed below the icons 144.

In order for the user to selectively display and operate all the icons 144 included in the group of icons 143, the scroll bar 145 is dragged in a direction indicated by an arrow F from a position shown in FIG. 36B. When the scroll bar 145 is dragged in the direction indicated by the arrow F, the icons 144 displayed in the display area of the group of icons 143 move in a direction indicated by an arrow G. For example, when the scroll bar 145 is moved to a position shown in FIG. 36C, the third to sixth icons 144 are displayed. When the scroll bar 145 is dragged further in the direction indicated by the arrow F from the position shown in FIG. 36C, the icons 144 displayed in the display area of the group of icons 143 move in the direction indicated by the arrow G to obtain a state shown in FIG. 36D. In the state shown in FIG. 36D, the seventh to tenth icons 144 are displayed.

When the scroll bar 145 is dragged in the direction indicated by the arrow G while the scroll bar 145 is placed at a position shown in FIG. 36D, the icons 144 included in the group of icons 143 move in the direction indicated by the arrow F, and the state is shifted to the one shown in FIG. 36C, for example. Similarly, the scroll bar 145 is dragged in the direction indicated by the arrow F from the state shown in FIG. 36C, whereby the state is shifted to the one shown in FIG. 36B.

Thus, the icons 144 included in the group of icons 143 are moved in the direction indicated by the arrow G or F to be displayed by dragging the scroll bar 145 in the direction indicated by the arrow F or G. Thus, all the icons included in the group of icons 143 can be displayed selectively so as to be placed in an operable state.

### 2-5. Display of Setting Contents

In the above description, the icons displayed in the tool bar are used for activating predetermined functions and application software, and provided with designations and marks indicating the functions and application software. The tool bar in the present embodiment can be provided with various pieces of information, in addition to such a display.

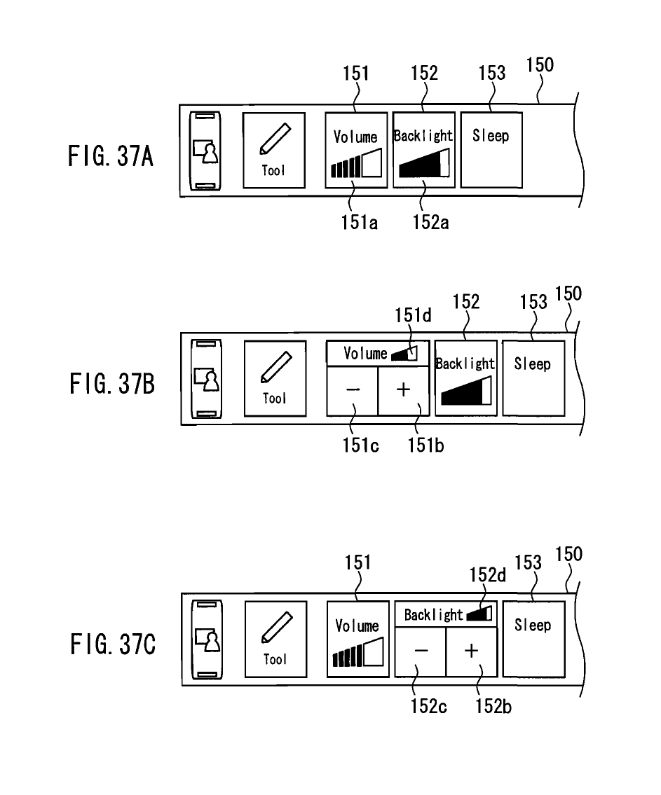

FIGS. 37A to 37C show display forms of icons in a tool bar in the present embodiment. As shown in FIG. 37A, a tool bar 150 displays a volume adjusting icon 151, a backlight adjusting icon 152, and a sleep icon 153. At this time, the volume adjusting icon 151 displays information 151a on a current volume level. Furthermore, the backlight adjusting icon 152 displays information 152a on a current brightness level of a backlight of the display 4 (in the case where the display 4 includes a liquid crystal display panel). Furthermore, a sleep icon 153 is capable of shifting the notebook PC to a sleep state. Thus, by allowing the icons displayed in the tool bar 150 to display current various setting states, the user can grasp the current setting states immediately without opening the screen displaying the current setting states.

FIG. 37B shows a display form at a time of adjusting a volume. In the state shown in FIG. 37A, when the volume adjusting icon 151 is clicked on, the volume adjusting icon 151 is switched to a display form shown in FIG. 37B to be displayed. In the display form shown in FIG. 37B, a plus button 151b and a minus button 151c capable of adjusting a volume are displayed. Every time the user clicks on the plus button 151b, the volume of a voice output from an internal speaker (not shown) or a headphone terminal included in the interface 15 shown in FIG. 29) is raised, and every time the minus button 151c is clicked on, the volume is lowered. By operating the plus button 151b or the minus button 151c, the level display in a volume indicator 151d displayed in the vicinity of the plus button 151b increases or decreases. The user can adjust a volume while checking the current volume setting by watching the display of the volume indicator 151d.

Furthermore, when adjusting the brightness of a backlight, the user clicks on the backlight adjusting icon 152 in FIG. 37A. When the user clicks on the backlight adjusting icon 152, the backlight adjusting icon 152 is switched to a display form shown in FIG. 37C to be displayed. In the display form shown in FIG. 37C, the plus button 152b and the minus button 152c capable of adjusting the brightness of the backlight are displayed. Every time the user clicks on the plus button 152b, the brightness of the backlight in the main display 4 is raised, and every time the user clicks on the minus button 152c, the brightness of the backlight in the main display 4 is lowered. By operating the plus button 152b or the minus button 152c, the level display in a brightness indicator 152d displayed in the vicinity of the plus button 152b increases or decreases. The user can adjust the brightness while checking the current brightness setting by watching the display of the brightness indicator 152d.

In the present embodiment, the volume setting and the brightness setting of a backlight are described, which are shown for illustrative purposes.

### 2-6. Interlocked Display of a Main Display and a Sub-Display

Next, the display operation of the main display 4 when a tool bar displayed on the sub-display 5 is operated will be described.

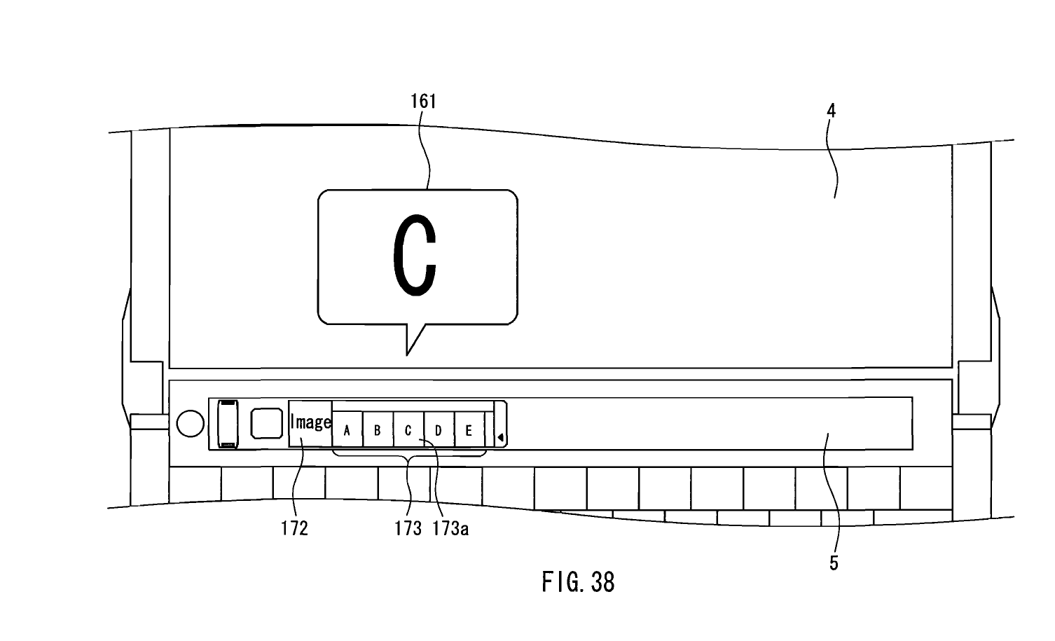

FIG. 38 shows an interlocked display state of the main display 4 and the sub-display 5. In the present embodiment, displaying a list of image files on the sub-display 5 will be described as an example.

First, in the sub-display 5, when a hierarchy mark 172a of an image display icon 172 is clicked on, a group of icons 173 is displayed in a region adjacent to the image display icon 172. Each icon included in the group of icons 173 displays a thumbnail image (scaled-down image) of an image file.

Next, when the icon (for example, an icon 173a) in a desired image file among the group of icons 173 is clicked on, an image based on the image file corresponding to the clicked icon 173a is displayed on the main display 4. The image to be displayed on the main display 4 may extend over the entire area of the main display 4 or a scaled-down image 161 may be displayed as shown in FIG. 38. The scaled-down image 161 has a size larger than at least that of the thumbnail image displayed on the sub-display 5. The scaled-down image 161 is displayed in the vicinity of the icon 173a clicked on in the sub-display 5, whereby the relationship with the icon 173a can be displayed clearly. The scaled-down image 161 may be displayed in a rectangular shape; however, the relationship with the icon 173a can be displayed more clearly by displaying the scaled-down image 161 in a balloon shape, as shown in FIG. 38. Furthermore, the operation of displaying the scaled-down image 161 on the main display 4 is not limited to a method for clicking on the icon displayed on the sub-display 5. For example, the following configuration may be adopted: an icon desired to be displayed as the scaled-down image 161 is slid toward the main display 4 on the sub-display 5, thereby allowing the scaled-down image 161 based on the image file corresponding to the icon to be displayed on the main display 4.

By clicking on another icon in the group of icons 173 from the state shown in FIG. 38, a scaled-down image corresponding to the clicked icon can be displayed in addition to the scaled-down image 161 that is currently being displayed. That is, a plurality of scaled-down images can be displayed simultaneously on the main display 4. A plurality of scaled-down images are displayed simultaneously, whereby the plurality of scaled-down images can be compared with each other on the main display 4. A scaled-down image that has been displayed in the past may be deleted by displaying only the scaled-down image corresponding to the clicked icon on the main display 4, instead of displaying a plurality of scaled-down images simultaneously.

Furthermore, when the scaled-down image displayed on the main display 4 is switched to a scaled-up display, the scaled-down image 161 is scaled up so as to be displayed over the entire area of the main display 4 by clicking on the icon displayed on the sub-display 5 corresponding to the scaled-down image 161 again. Furthermore, the scaled-down image 161 also can be scaled up by operating the pointing device 7 or the like to drag an edge of the scaled-down image 161 in an image scale-up direction.

Furthermore, when the scaled-down image displayed on the main display 4 is deleted, the display of the scaled-down image 161 can be deleted by double-clicking on the icon displayed on the sub-display 5 corresponding to the scaled-down image 161. Furthermore, the scaled-down image 161 also can be deleted by operating the pointing device 7 or the like to click or double-click on the scaled-down image 161.

In the present embodiment, although a thumbnail (icon) of an image file is displayed on the sub-display 5, and a scaled-down image or a scaled-up image corresponding to the thumbnail is displayed on the main display 4, information that can be handled is not limited to an image file. For example, the present embodiment also can be used in a videoconference system.

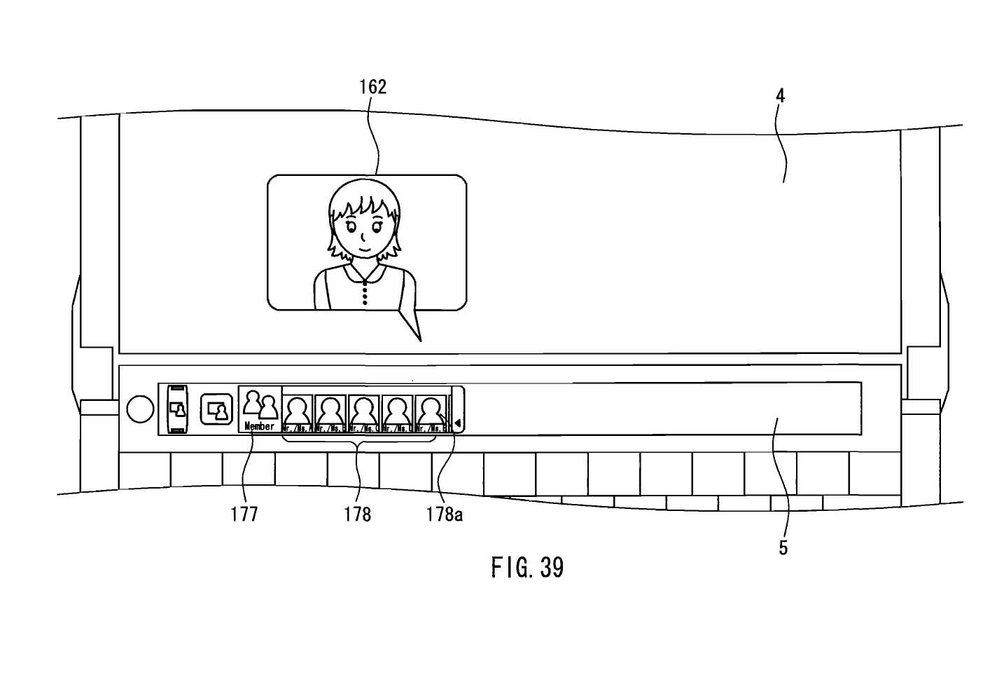

FIG. 39 shows an interlocked display form of the main display 4 and the sub-display 5 in a videoconference system. In the example shown in FIG. 39, when a hierarchy mark 177a displayed in the member icon 177 is clicked on in the sub-display 5, a group of icons 178 corresponding to members connected to the videoconference system or members connectable thereto are displayed.

Next, an icon (for example, an arbitrary icon 178a) corresponding to a member that the user desires is clicked on, and an image based on image data sent from a personal computer of the member corresponding to the icon 178a through a network is displayed on the main display 4 as a scaled-down image 162. Specifically, a face image (a still image or a moving image) of the member photographed by a camera connected to the personal computer of the member corresponding to the icon 178a is displayed as the scaled-down image 162. A method for scaling up the scale-down image 162 and a method for deleting the display of the scaled-down image 162 are as described with reference to FIG. 12, so that the description thereof will be omitted.

### 2-7. Interlocked Display with Application Software

Next, a display form of the sub-display 5 while application software is being activated on the main display 4 will be described.

FIG. 40A shows a tool bar including icons capable of activating various pieces of application software. An application desired to be activated is activated by clicking on an icon corresponding to the application in a tool bar 180 shown in FIG. 40A. In the present embodiment, the description will be made assuming that an icon 181 capable of activating spreadsheet program is clicked on.

When the icon 181 is clicked on, a spreadsheet program installed on a notebook PC is activated, and a screen of the spreadsheet program is displayed on the main display 4. At this time, the sub-display 5 is switched from the display of the tool bar 180 to that of a tool bar 182 shown in FIG. 40B. The tool bar 182 includes icons having functions executable in the spreadsheet program. Specifically, the tool bar 182 includes an open icon 182a capable of opening a file that has already been created, a save icon 182b capable of saving a created table in a predetermined file format, a copy icon 182c capable of creating a copy of arbitrary data in the table, a cut icon 182d capable of cutting arbitrary data in the table, a paste icon 182e capable of pasting the data subjected to copying or cutting to an arbitrary position in the table, a print icon 182f capable of printing the created table, a preview icon 182g capable of previewing a printed image on the main display 4 before printing the created table, and the like. A desired icon among the icons displayed in the tool bar 182 is clicked on, whereby the function corresponding to the icon can be executed.

Furthermore, the number of kinds of the tool bar 182 shown in FIG. 40B may be one. However, if application software is multifunctional and the number of icons to be registered in the tool bar is large, a plurality of kinds of tool bars may be provided. In this case, when a selective operation portion 182h is clicked on or dragged in the state shown in FIG. 40B, whereby the display of the tool bars can be switched in the same way as in the switching operation shown in FIG. 30.

The tool bar 182 shown in FIG. 40B is a tool bar displayed first when the spreadsheet program is activated, and the kinds of icons to be included in the tool bar vary depending upon application software to be activated.

When the spreadsheet program is completed, the tool bar displayed on the sub-display 5 also returns to the display form shown in FIG. 40A.

### 2-8. Specific Example

Next, a specific example using a tool bar displayed on the sub-display 5 in the present embodiment will be described. As the specific example, a videoconference system will be illustrated.

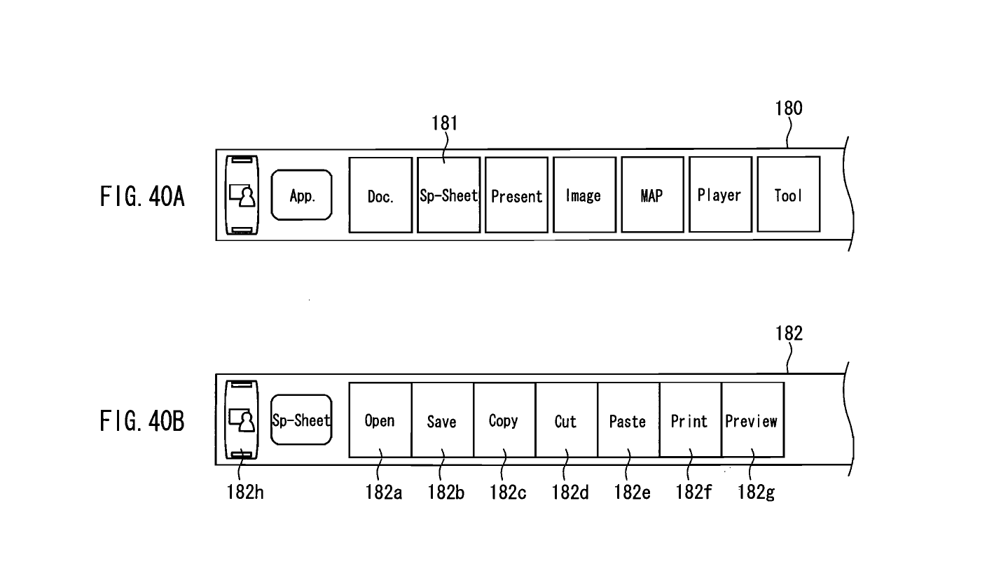

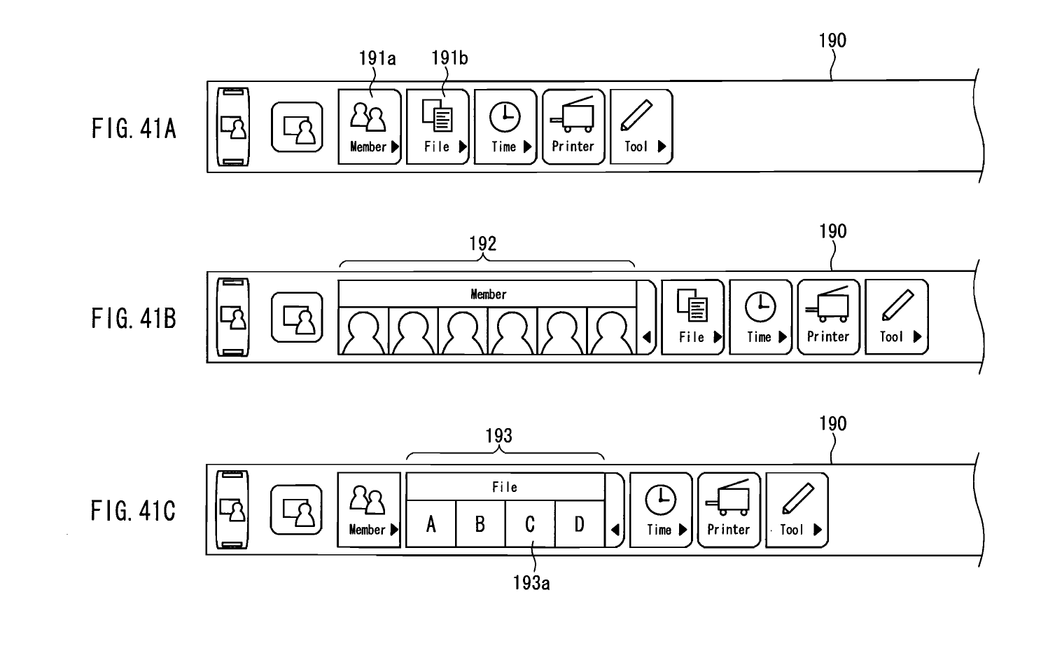

FIG. 41A shows an initial state of a tool bar displayed on the sub-display 5, which corresponds to the tool bar 104 shown in FIG. 30. First, in the tool bar shown in FIG. 41A, when a member icon 191a is clicked on. Then, as shown in FIG. 41B, a list of members connected to the videoconference system or members connectable thereto is displayed as a group of icons 192. If an icon of a member desired to be connected is clicked on among the displayed group of icons 192, a state is obtained in which direct exchange can be performed with respect to the PC of the member.

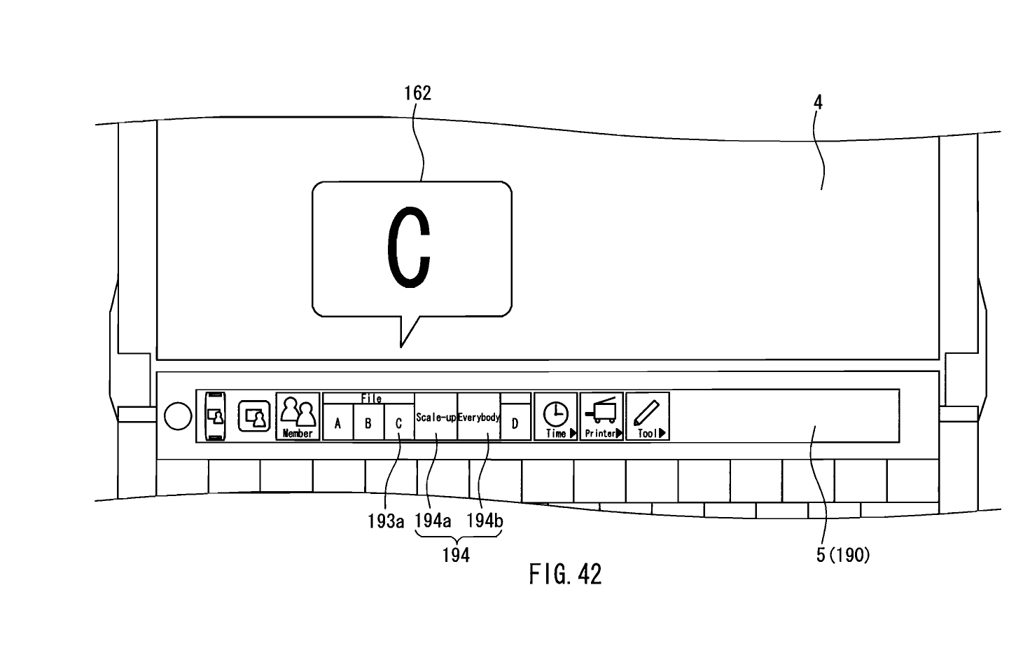

On the other hand, in the tool bar shown in FIG. 41A, if a file icon 191b is clicked on, a list of files can be displayed as a group of icons 193, as shown in FIG. 41C. The files listed in the group of icons 193 are image files, material files for presentation, and the like. Next, in FIG. 41C, when a desired icon (for example, an icon 193a) is clicked on among the group of icons 193, a scaled-down image 162 is displayed on the main display 4 and a sub-menu 194 is displayed in the tool bar of the sub-display 5, as shown in FIG. 42.

The sub-menu 194 includes a scale-up button 194a and an everyone button 194b. When the scale-up button 194a is clicked on, a file corresponding to the icon 193a is opened and displayed on the main display 4 with a scaled-up size. Furthermore, when the everyone button 194b is clicked on, the file corresponding to the icon 193a can be opened to the members connected to the videoconference system.

Furthermore, in FIG. 42, when an arbitrary icon displayed on the sub-display 5 is touched continuously for a predetermined period of time (for example, about 2 seconds), the touched icon is placed in a state capable of being dragged. For example, when an arbitrary file icon that is displayed on the sub-display 5 is touched with a finger continuously for a predetermined period of time, the file icon is placed in a state capable of being dragged. When the finger is slid as it is, the file icon is moved, interlocked with the movement of the finger (drag operation). When the moved file icon is moved to a position overlapping the everyone button 194b, and the finger is detached from the sub-display 5 (drop operation), the file icon is caused to be opened to the PCs of the other members connected to the videoconference system. Furthermore, when the dragged file icon is dropped onto a printer icon, data associated with the file icon is sent to a printer connected to the PC. The printer prints data sent from the PC. Thus, by dragging and dropping an arbitrary icon (a file icon, etc.) onto another icon (an icon regarding various pieces of processing), processing regarding a file can be executed and the operability can be enhanced.

### 3. Effects of the Present Embodiment, Etc.

According to the present embodiment, windows and icons displayed in a tool bar can be contracted or expanded, whereby a number of icons can be displayed in one tool bar, and the squeeze of the display area caused by the increase in icons can be reduced. More specifically, a number of display areas other than the tool bar can be kept, and a number of pieces of information can be displayed.

Furthermore, icons are displayed hierarchically in one tool bar, whereby a number of icons can be displayed in one tool bar, and the squeeze of the display area caused by the increase in icons can be reduced. Furthermore, the hierarchically arranged icons can be accessed directly, so that the operability can be enhanced.

Furthermore, by displaying a mark indicating that hierarchy is present in icons when the icons are displayed hierarchically in one tool bar, the user can grasp the icons having hierarchy easily.

Furthermore, in the case where the number of icons included in one tool bar is large, and all the icons cannot be displayed simultaneously, only a part of the icons is displayed, and further, a scroll bar is displayed in the tool bar. Then, moving the scroll bar allows the tool bar to be scrolled, and can shift the icons that are not originally displayed to a state in which they can be displayed.

When a window is contracted and displayed in a longitudinal direction, icons included in the window are contracted and displayed, whereby the icons included in the window can be displayed all or as many as possible even when the window is reduced in size.

Furthermore, the current setting states such as a volume and a brightness of a backlight of the main display 4 are displayed in icons, whereby the current setting states such as a volume and a brightness can be checked easily without being bothered to open a volume display screen and a brightness display screen. Furthermore, by clicking on an icon displaying a setting state, a screen capable of changing the setting can be displayed.

Furthermore, when an icon is clicked on, another icon related to the clicked icon is displayed automatically. Thus, the operability can be enhanced. According to the prior art, in the case where another icon related to the clicked icon is present in another window or another tool bar, it takes a long time to search for another icon. In the present embodiment, by displaying another related icon immediately, the time and labor for searching for another icon can be saved, which can enhance the operability.

An icon related to application software, which has been activated, is displayed, whereby the operability can be enhanced. More specifically, since the function that is frequently used in application software can be activated with the icon in the tool bar, the function that is frequently used can be activated with less operation, which can enhance the operability. As a method for activating the function with less operation, there is a method (a so-called shortcut key) for activating the function by operating a predetermined plurality of keys on a keyboard simultaneously. However, such a shortcut key may vary depending upon an OS or application software, which causes a user to take labor and time to remember the shortcut key. In the present embodiment, the function that is frequently used can be activated by one-touch clicking of the sub-display 5, whereby it is not necessary to remember a shortcut key, which can enhance the operability.

Furthermore, since the sub-display 5 independent from the main display 4 is provided, and a tool bar that includes icons capable of activating various functions and application software is displayed on the sub-display 5, the operability can be enhanced without squeezing the display area of the main display 4.

Furthermore, the sub-display 5 includes the touch panel 55, and various operations can be performed by a touch operation of the user, whereby a display dedicated for operations is provided. Thus, the main display 4 can be prevented from being contaminated, compared with the configuration in which the touch panel is provided on the main display 4.

Furthermore, the sub-display 5 is placed at a position close to the main display 4 in the first housing 1, whereby a sense of integration with the contents displayed on the main display 4 can be enhanced when an interlocked display with the main display 4 is performed, which can enhance the visibility.

Furthermore, the sub-display 5 is placed in an upper portion of the keyboard 6 as shown in FIG. 28, whereby the operability comparable to the keyboard operation can be realized.

Furthermore, the sub-display 5 is composed of a touch panel type display, so that an instinctive operation can be realized, which can enhance the operability.

In the present embodiment, although the main display 4 and the sub-display 5 are provided, the configuration of the present invention is effective even in an information processing unit having only a main display, such as a conventionally existing notebook PC. More specifically, a tool bar to be displayed on the sub-display 5 in the present embodiment is displayed in a part of the main display, whereby the configuration and effects similar to those of the present invention can be obtained. When a tool bar in the present embodiment is displayed on a main display, the main display is not hindered by placing the tool bar in the vicinity of an edge of the main display.

Furthermore, even in the case where the sub-display 5 is composed of a touch panel function having no display function, the configuration and effects similar to those of the present invention can be obtained by displaying a tool bar to be displayed on the sub-display 5 in the present embodiment in a part of the main display.

Furthermore, in the present embodiment, although the sub-display 5 is composed of a touch panel type display to enhance the operability, it is not necessary that the sub-display 5 is composed of a touch panel type display. In the case where the sub-display 5 is composed of a display having only a display function, the keyboard 6 and the pointing device 7 may be allowed to operate the sub-display 5.

Furthermore, the main display 4 also may be composed of a touch panel type display. With such a configuration, more direct operability can be realized.

The position of the sub-display 5 is not limited to that shown in FIGS. 1 and 3, and for example, the sub-display 5 may be placed adjacent to the keyboard 6 on the left or right side in a direction facing the drawing surface in FIG. 3 so as to have a longitudinal direction in the vertical direction. Furthermore, the sub-display 5 may be placed adjacent to the pointing device 7 on the lower side in a direction facing the drawing surface in FIG. 3 so as to have a longitudinal direction in the horizontal direction. The arrangement shown in FIGS. 1 and 3 is most preferred.

Furthermore, the sub-display 5 may be placed in the second housing 2 instead of the first housing 1.

Furthermore, in the present embodiment, the operation of switching the display of the tool bar shown in FIG. 4 can be performed by clicking on the selective operation portion 100a or dragging the selective operation portion 100a in the direction indicated by the arrow A or B. However, a hard key configuration may be used instead of such a soft key configuration. Examples of the hard key configuration include the configuration in which dedicated operation portions (a button, a wheel, etc.) for switching the display of the tool bar is provided in the first housing 1, the configuration in which the operation can be performed using a cursor key on the keyboard 6, the configuration in which a dedicated region for switching the tool bar is provided on the operation surface of the pointing device 7, and the configuration in which the display of the tool bar is switched, interlocked with the rotation of a wheel provided at a mouse connected to a USB terminal in the interface 15.

Furthermore, icons displayed in the tool bar in the present embodiment may be changed arbitrarily by the user. Examples of the change contents include the deletion of icons registered as a default (at a time of shipping of a notebook PC), the additional registration of other icons, and the change in position of the registered icons. As a method for changing an icon, there is a method in which an icon setting screen is displayed on a main display, and an icon can be added, deleted, or changed in position on the icon setting screen. Furthermore, there also is a method in which an icon desired to be added is moved by dragging to an arbitrary position on the tool bar and is added by dropping, a registered icon is excluded out of the tool bar by dragging and dropping, and a registered icon is changed in position by dragging and dropping. In the case of adding an icon by dragging and dropping, the icon can be added with the pointing derive 7, a mouse connected to the interface 15 or the like.

Furthermore, regarding the expansion/contraction operation of the window 111 shown in FIGS. 31A to 31C, in the present embodiment, the window 111 can be expanded to the right end of the tool bar 104. However, the window 111 may be expanded in a range in which all the icons 112 can be displayed. Furthermore, when the window 111 is contracted to a size equal to that of the icons, the window 111 may be dosed automatically to be switched to an icon display.

Furthermore, the initial size of the window is set to be the maximum size in a range in which all the icons and windows can be displayed simultaneously in the tool bar while a plurality of windows are being displayed as shown in FIGS. 32 and 33. However, the window may have a fixed size irrespective of whether all the icons and windows can be displayed simultaneously in the tool bar. In this case, although some icons and windows may not be displayed in the tool bar, the icons and windows that cannot be displayed can be displayed by scrolling, if a scroll bar is displayed at a lower end of the tool bar so as to scroll the tool bar.

Furthermore, one kind of hierarchy mark is displayed in the case where the icons have hierarchy irrespective of the number of levels of hierarchy in the present embodiment. However, the form of a hierarchy mark may be changed depending upon the number of levels of hierarchy. For example, in the hierarchy mark displayed at an icon in an uppermost layer, a hierarchy mark in the case where there is one lower layer is made different from a hierarchy mark in the case where there are two lower layers. Because of this, the number of levels of hierarchy can be grasped merely by checking a hierarchy mark displayed on an icon in an uppermost layer. Furthermore, a numerical value indicating the number of levels of hierarchy is displayed at a hierarchy mark, whereby the number of levels of hierarchy can be grasped more easily.

Furthermore, the information processing unit of the present invention is not limited to a notebook PC as in the present embodiment. The present invention is useful as long as it is an appliance on which at least a GUI (Graphical User Interface) such as a tool bar can be mounted Application examples of the present invention include a desktop PC, a PDA (Personal Digital Assistance), a game machine, and a medical appliance.

Particularly, the present invention is useful for an appliance having a display portion whose size is limited, such as a stationary DVD recorder (a display portion mounted on a front panel), an electronic photostand, a car navigation system, and a clock radio. In such an appliance, a display portion to be mounted is small, so that the amount of information that can be displayed is limited; however, a large amount of information can be displayed in a display form as in the present embodiment.

Furthermore, the main display 4 in the present embodiment is one example of the first display unit of the present invention. The sub-display 5 in the present embodiment is an example of the second display unit of the present invention. Various operation units such as the keyboard 6, the pointing device 7, the power source button 8, the touch panel 55, and the mouse connectable to the interface 15 in the present embodiment are examples of the operation unit of the present invention. The configurations, which cause the display panels 42 and 52 to display an image, such as the CPU 11, the RAM 12, and the display control portions 41 and 52 in the present embodiment are examples of the display control unit of the present invention. Furthermore, the window and the tool bar in the present embodiment are examples of the icon display area of the present invention.

The present invention can be used widely, for example, in an information processing unit that uses a plurality of system environments by switching, without being limited to a portable notebook PC.

Regarding the present embodiment, the following notes will be disclosed.

(Note 1)

A first configuration of an information processing unit of the present invention is an information processing unit that displays icons selected when predetermined processing is designated on a screen of a display unit, including: a display control unit that causes an icon display area, in which a plurality of the icons related to each other are grouped, to be displayed on the screen; and an operation unit that receives various operations by a user, wherein, when the operation unit inputs a command for expanding or contracting the icon display area in a one-dimensional direction, the display control unit causes the icon display area displayed on the screen to be expanded or contracted in the one-dimensional direction.

According to the above configuration, a number of icons can be displayed in one icon display area, and the squeeze of a display area of the first display unit caused by the increase in number of icons can be reduced. More specifically, a number of display areas other than the icon display area can be kept in the first display unit, and a number of pieces of information can be displayed.

(Note 2)

A second configuration of the information processing unit of the present invention is an information processing unit provided with a first display unit that displays various pieces of information, including: a band-shaped second display unit independent from the first display unit; a display control unit that causes an icon display area, in which a plurality of icons related to each other are grouped, to be displayed on a screen of the second display area; and an operation unit that receives various operations by a user, wherein, when the operation unit inputs a command for expanding or contracting the icon display area in a one-dimensional direction, the display control unit causes the icon display area displayed on the screen of the second display unit to be expanded or contracted in the one-dimensional direction.

According to the above configuration, the operability can be enhanced without squeezing the display area of the first display unit. Furthermore, the display unit can be set to be smaller than the display unit capable of displaying two or more dimensional directions, so that the information processing unit is not required to be enlarged remarkably.

(Note 3)

In the information processing unit of the present invention, a plurality of the icons can have a hierarchical structure.

According to the above configuration, a number of icons can be displayed in one icon display area, and the squeeze of a display area caused by the increase in number of icons can be reduced. Furthermore, since hierarchically arranged icons can be accessed directly, the operability can be enhanced.

(Note 4)

In the information processing unit of the present invention, when the plurality of the icons have a hierarchical structure, the display control unit can cause a predetermined mark to be displayed on an icon in an upper layer.

According to the above configuration, the user can grasp the icons having hierarchy easily.

(Note 5)

In the information processing unit of the present invention, when all the plurality of the icons cannot be displayed, the display control unit causes only a part of the plurality of the icons to be displayed and enables the icon display area to be displayed by scrolling.

According to the above configuration, the state can be shifted so that icons which have not been displayed originally can be displayed.

(Note 6)

In the information processing unit of the present invention, when the icon display area is contracted, the display control unit causes sizes of the icons displayed in the icon display area to be reduced.

According to the above configuration, even if the icon display area is reduced in size, the icons included in the icon display area can be displayed all or as many as possible.

(Note 7)

In the information processing unit of the present invention, the display control unit can cause variable setting information to be displayed on the icons.

According to the above configuration, the current setting states such as a volume and a brightness can be checked easily without being bothered to open a volume display screen and a brightness display screen. Furthermore, by clicking on the icon displaying the setting state, a screen capable of changing the setting can be displayed.

(Note 8)

In the information processing unit of the present invention, the display control unit can cause icons capable of changing the setting contents of the setting information to be displayed.

According to the above configuration, the setting contents such as a volume and a brightness can be changed easily without being bothered to open a volume change screen and a brightness change screen.

(Note 9)

In the information processing unit of the present invention, when the operation unit operates an arbitrary icon, the display control unit can cause another icon related to the operated icon to be displayed.

According to the above configuration, another related icon is displayed immediately to save the labor and time for searching for another icon, which can enhance the operability.

(Note 10)

In the information processing unit of the present invention, when the operation unit causes arbitrary application software to be activated, the display control unit can cause an icon related to the application software to be displayed.

According to the above configuration, a function that is highly frequently used in application software can be activated with an icon in the icon display area. Therefore, the function that is highly frequently used can be activated with less operation, which can enhance the operability.

(Note 11)

In the information processing unit of the present invention, an icon displayed in the icon display area can be changed arbitrarily.

(Note 12)

In the information processing unit of the present invention, the second display unit can be placed in the vicinity of the first display unit.

According to the above configuration, when the first display unit and the second display unit are displayed, interlocked with each other, the sense of integration with the contents displayed on both the display units can be enhanced, which can enhance the visibility.

(Note 13)

In the information processing unit of the present invention, the second display unit can have a transparent touch panel that is placed on the display screen and outputs a coordinate of an operated position of the display screen.

According to the above configuration, an intuitive operation can be realized, which can enhance the operability.

(Note 14)

In the information processing unit of the present invention, the second display unit can be placed flush with the surface of the housing of the information processing unit, on which the operation surface is placed.

According to the above configuration, a small movement of a line of sight among the first display unit, the second display unit, and the operation unit suffices, so that the display contents of the second display unit can be identified visually with ease. Furthermore, in the case of the second operation unit provided with a touch panel the movement amount of a finger from the operation unit can be reduced, which can enhance the operability.

(Note 15)

In the information processing unit of the present invention, the display control unit can cause the second display unit to display a plurality of icon display areas selectively.

According to the above configuration, a small second display unit capable of performing a display in a one-dimensional direction can display a number of pieces of information.

(Note 16)

In the information processing unit of the present invention, when a predetermined position is operated in the touch panel, the display control unit can cause a plurality of the icon display areas to be displayed by switching.

(Note 17)

In the information processing unit of the present invention, when a predetermined operation is performed in the operation unit, the display control unit can cause a plurality of the icon display areas to be displayed by switching.

(Note 18)

In the information processing unit of the present invention, when the operation unit operates an arbitrary icon continuously for a predetermined period of time, the display control unit can cause the arbitrary icon to be capable of being dragged onto another icon.

(Note 19)

In the information processing unit of the present invention, when the operation unit moves an icon associated with data from the second display unit to the first display unit, the display control unit can cause the first display unit to display an image based on the data associated with the icon.

### Embodiment 5

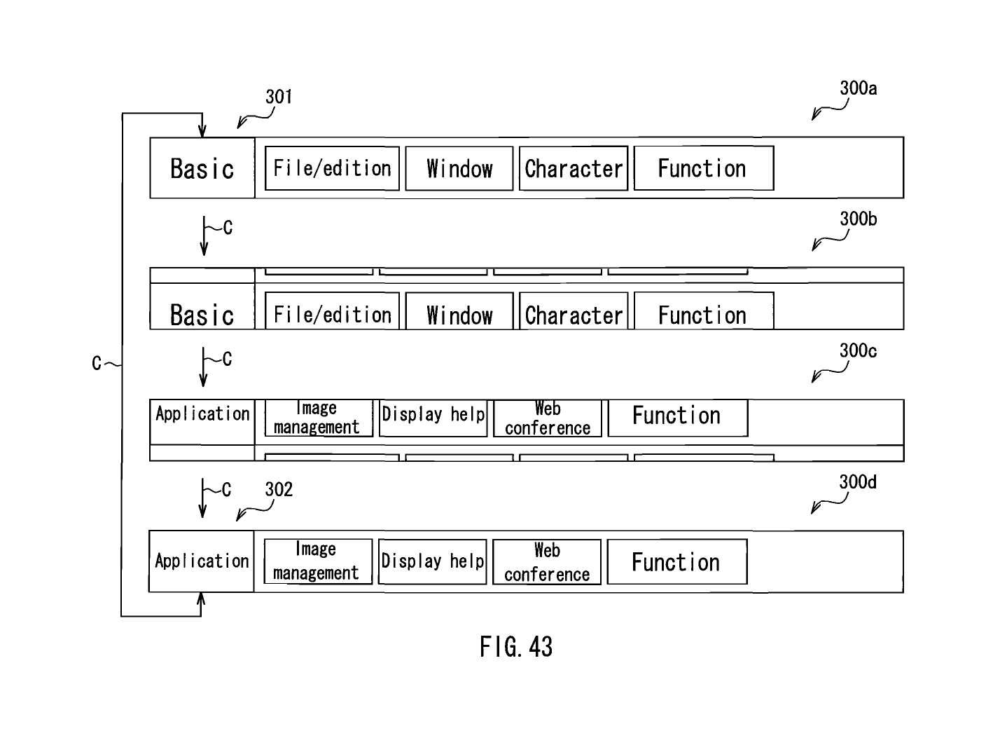

FIG. 43 is a schematic view showing the shift of a display form of a menu bar 300. The shift of the display form shown in FIG. 43 shows a flow in which the display is switched from a basic menu (display form 300a) to an application menu (display form 300d). The display form of the menu bar 300 shown in FIG. 43 is the same as that of the menu bar 300 shown in FIG. 18.

First, when the user slides the first region 50a of the operation region 50 (see FIG. 3) in a direction indicated by the arrow A (see FIG. 3) while a basic menu is being displayed in the menu bar 300 (display form 300a), the display contents of the basic menu are slid in the direction indicated by the arrow C. Specifically, the display of the menu bar 300 is shifted successively in the following order: a display form 300a, a display form 300b, and a display form 300c, thereby reaching a display form 300d.

Although not shown, the shift of the display form from an application menu to a customized menu and the shift of the display form from a customized menu to a basic menu also are similar to those shown in FIG. 43.

Furthermore, in the present embodiment, the configuration is described in which the display form is shifted in the direction indicated by the arrow C. However, when the user slides the first region 50a (see FIG. 3) of the operation region 50 in the direction indicated by the arrow B (see FIG. 3), the display form can be slid to be displayed in the direction opposite to the direction indicated by the arrow C.

According to the present embodiment, a menu displayed in the menu bar 300 is displayed by sliding when the display of the menu bar 300 is switched, whereby the basic menu, the application menu, and the customized menu can be switched in a narrow display area on the display 4. Thus, the narrowing of the operation region (display area other than the menu bar 300) on the display 4 due to the display of the menu bar 300 can be suppressed.

Furthermore, the sliding direction of the operation region 50 is matched with the shift direction of the display form of the menu, whereby a direct sense of operation can be obtained.

The display form of the menu bar 300 according to the present embodiment is applicable to the menu bar or the task bar shown in Embodiments 1-4.

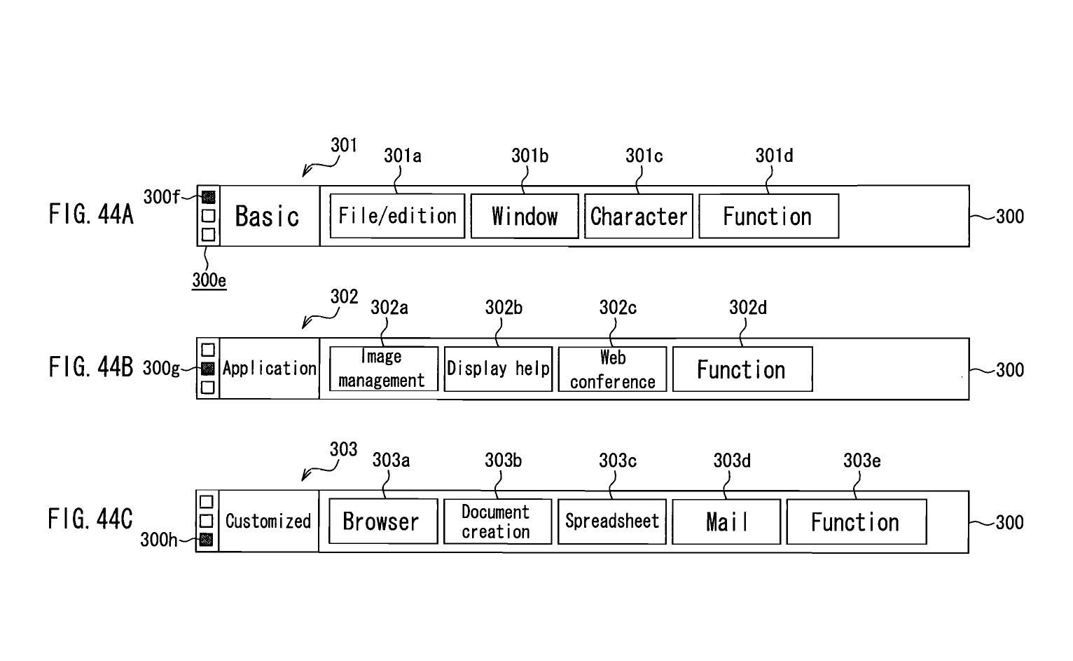

Furthermore, in order to grasp easily which of the basic menu, the application menu, and the customized menu is being displayed in the menu bar 300, an indicator can be displayed in the menu bar 300. FIG. 44 shows a state in which an indicator 300e is displayed at an end of the menu bar 300. The indicator 303e includes marks 300f to 300h whose number corresponds to the number of menus that can be displayed in the menu bar 300. As shown in FIG. 44A, when the basic menu 301 is displayed in the menu bar 300, the mark 300f is displayed in a color different from that of the other marks. As shown in FIG. 44B, when the application menu 302 is displayed in the menu bar 300, the mark 300g is displayed in a color different from that of the other marks. As shown in FIG. 44C, when the customized menu 303 is displayed in the menu bar 300, the mark 300h is displayed in a color different from that of the other marks. The number and display order of the menus capable of being displayed in the menu bar 300 can be grasped by displaying the indicator 300e.

### Embodiment 6

The information processing unit of the present invention can perform a display prompting the user to make a selection.

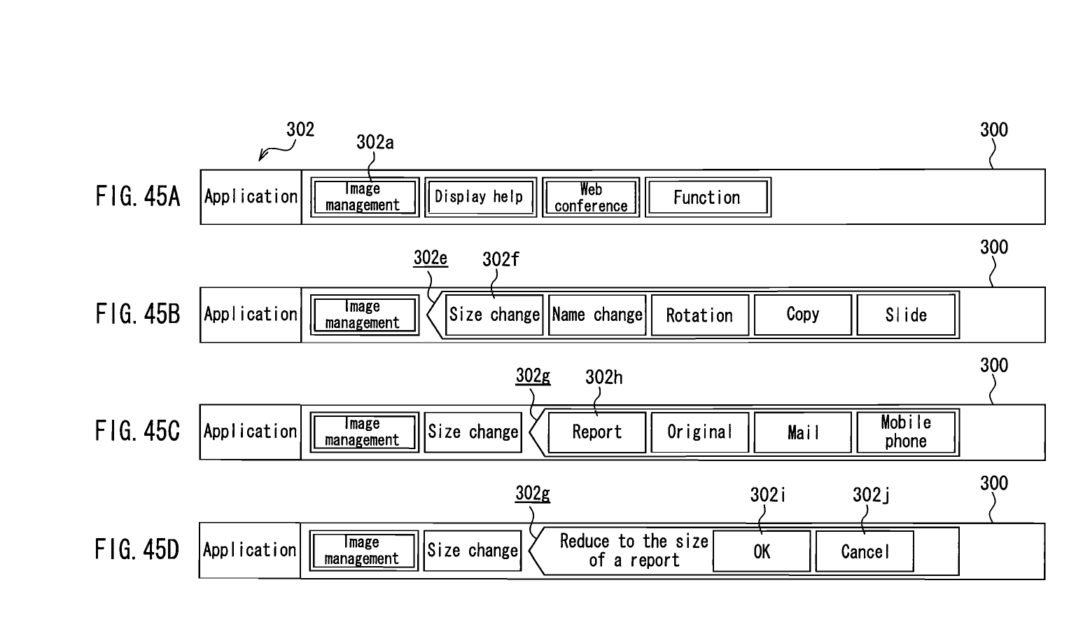

FIG. 45 shows the shift of a display form of the menu bar 300 up to a time when a display prompting the user to make a selection is performed. The menu bar 300 shown in FIG. 45 displays an application menu (that is the same as the application menu shown in FIG. 18 or the like) 302 as an example.

First, as shown in FIG. 45A, when the user selects, for example, an image management icon 302a while the application menu 302 is being displayed in the menu bar 300, a sub-menu 302e is displayed as shown in FIG. 45B. The sub-menu 302e is displayed adjacent to the image management icon 302a on the right side in the figure. The sub-menu 302e includes, for example, icons capable of designating the management, edition, and the like of image files saved in the HDD 14 (see FIG. 2). The sub-menu 302e includes a size change icon 302f capable of changing the size of an image, a name change icon capable of changing a file name of an image file, and the like.

Next, as shown in FIG. 45B, when the user selects, for example, the size change icon 302f while the sub-menu 302e is being displayed in the menu bar 300, a sub-menu 302g is displayed as shown in FIG. 45C. The sub-menu 302g is displayed adjacent to the size change icon 302f on the right side in the figure. The sub-menu 302g includes, for example, icons capable of designating the change in size of images of image files saved in the HDD 14. The sub-menu 302g of the present embodiment includes a report icon 302h capable of designating the change in size of an image to the one suitable for being attached to or inserted in a report, an original icon through which the user is capable of designating the size of an image arbitrarily, and a mail icon capable of designating the change in size of an image to the one suitable only for being attached to electronic mail.

Next, as shown in FIG. 45C, when the user selects, for example, the report icon 302h while the sub-menu 302g is being displayed in the menu bar 300, a message saying “Reduce to the size of a report”, an OK icon 302i, and a cancel icon 302j are displayed in the sub-menu 302g as shown in FIG. 45D. The display contents of the sub-menu 302g shown in FIG. 45D are such that the user is prompted to select whether to change the size an image to a report size. In FIG. 45D, when the user selects an OK icon, the processing of reducing the size of the image is performed. In FIG. 45D, when the user selects the cancel icon, the processing of reducing the size of an image is not performed, and the sub-menu 302g returns to the display shown in FIG. 45C.

According to the present embodiment, the display (sub-menu 302g) prompting the user to make a selection is displayed in the menu bar 300, as shown in FIG. 45D, whereby the narrowing of the operation region (display area other than the menu bar 300) on the display 4 can be suppressed. More specifically, when the sub-menu 302g shown in FIG. 45D is displayed in the display area other than the menu bar 300, the operation region on the display 4 may be narrowed until the user selects and operates the OK icon 302i or the cancel icon 302j. In the present embodiment, the display prompting the user to make a selection is performed in the menu bar 300, whereby the narrowing of the operation region on the display 4 can be suppressed.

Furthermore, according to the configuration in which the sub-menu 302g shown in FIG. 45D is displayed in a display area other than the menu bar 300, in the case where document data or the like, which is being operated, is displayed on the display 4, the display prompting the user to make a selection may overlap document data which is being operated and the like. Thus, the document data which is being operated becomes difficult to be identified visually, which may cause trouble in the operation. In the present embodiment, the display prompting the user to make a selection is displayed in the menu bar 300. Thus, even if document data or the like, which is being operated, is being displayed on the display 4, the display prompting the user to make a selection does not overlap the document data or the like, which is being operated, preventing trouble during the operation.

The present invention can be used widely in an information processing unit using a plurality of system environments by switching, for example, without being limited to a portable notebook PC.

What is claimed is:

1. An information processing unit that displays icons selected when predetermined processing is designated on a screen of a display unit, comprising:
a display control unit that causes an icon display area, in which a plurality of the icons related to each other are grouped, to be displayed and
an operation unit that receives various operations by a user,
wherein, when the operation unit inputs a command for expanding or contracting the icon display area in a one-dimensional direction which is the same as an arrangement direction of the plurality of the icons in the icon display area, the display control unit causes the icon display area to be expanded or contracted in the one-dimensional direction.

2. The information processing unit according to claim 1, comprising a second housing provided with the display unit and a first housing via a rotation shaft that opens or closes the second housing rotatably,
wherein the operation unit is placed in a vicinity of the rotation shaft in the first housing.

3. The information processing unit according to claim 1, wherein the operation unit receives respective operations at positions corresponding to the plurality of the icons displayed in the icon display area.

4. The information processing unit according to claim 1, wherein the operation unit includes a designation portion, which designates a display or a non-display of the icon display area on the screen, in at least one end portion of the arrangement direction of the plurality of the icons.

5. The information processing unit according to claim 1, wherein, when one of the grouped plurality of the icons is selected, the display control unit causes the plurality of the icons related to the one icon to be expanded and displayed adjacent to the one icon in the icon display area.

6. The information processing unit according to claim 5, comprising the grouped plurality of the icons in plural kinds, wherein the display control unit selects and displays a group to be displayed in the icon display area.

7. The information processing unit according to claim 1, wherein the plurality of the icons are a profile switching unit that specifies an operation environment in which the user operates the operation unit and displays a profile in accordance with the operation environment on the display unit.

8. The information processing unit according to claim 1, further comprising a second housing provided with a display device that displays a visual signal, a first housing provided with a signal input portion for inputting a signal to be displayed on the display device, and a rotation shaft that axially supports the second housing with respect to the first housing so as to open or close the second housing freely,
wherein the profile switching unit is a plurality of icons corresponding to a plurality of the profiles, and in a vicinity of the rotation shaft in the display device, the information processing unit includes an icon display area that displays the plurality of the icons in a row, and a contact operation portion that corresponds to positions of the plurality of the icons displayed on the icon display area and is placed between the single input portion in the second housing and the rotation shaft.

9. The information processing unit according to claim 1, wherein the plurality of the icons have a hierarchical structure.

10. The information processing unit according to claim 9, wherein, when the plurality of the icons have a hierarchical structure, the display control unit causes a predetermined mark to be displayed on an icon in an upper layer.

11. The information processing unit according to claim 1, wherein, when only a part of the plurality of the icons is capable of being displayed, the display control unit enables the icon display area to be displayed by scrolling.

12. The information processing unit according to claim 1, wherein, when the icon display area is contracted, the display control unit causes sizes of the icons displayed in the icon display area to be reduced.

13. The information processing unit according to claim 1, wherein the display control unit causes variable setting information to be displayed on the icons.

14. The information processing unit according to claim 13, wherein the display control unit causes icons capable of changing setting contents of the setting information to be displayed.

15. The information processing unit according to claim 1, wherein, when the operation unit operates an arbitrary icon, the display control unit causes another icon related to the operated icon to be displayed.

16. The information processing unit according to claim 1, wherein, when arbitrary application software is operated so as to be activated by the operation unit, the display control unit causes an icon related to the application software to be displayed.

17. The information processing unit according to claim 1, wherein the icons displayed in the icon display area are capable of being changed arbitrarily.

18. The information processing unit according to claim 1, wherein, when the operation unit operates an arbitrary icon continuously for a predetermined period of time, the display control unit causes the arbitrary icon to be capable of being dragged onto another icon.

19. The information processing unit according to claim 2, wherein the icon display area is displayed on a second display unit independent from the display unit, and the second display unit is placed so as to overlap the operation unit.
